(19) United States
(12) Patent Application Publication
(10) Pub. No.: US 2025/0104166 A1
(43) Pub. Date: Mar. 27, 2025

(54) INFORMATION PROCESSING SYSTEM, INFORMATION PROCESSING METHOD, AND COMPUTER READABLE MEDIUM

(71) Applicant: Mitsubishi Electric Corporation, Tokyo (JP)

(72) Inventors: Shuhei KAWAGUCHI, Tokyo (JP); Takaomi SATO, Tokyo (JP); Kotone SENJU, Tokyo (JP); Mio MOTODANI, Tokyo (JP); Junya UJIIE, Tokyo (JP)

(73) Assignee: Mitsubishi Electric Corporation, Tokyo (JP)

(21) Appl. No.: 18/975,618

(22) Filed: Dec. 10, 2024

Related U.S. Application Data
(63) Continuation of application No. PCT/JP2022/030035, filed on Aug. 5, 2022.

(51) Int. Cl. G06Q 50/06; G06Q 10/0631

(52) U.S. Cl. CPC G06Q 50/06; G06Q 10/06315

(57) ABSTRACT

An information processing system (500) determines whether correction is required for a production plan of a production facility (1) that performs production by receiving electric power supply from a power generation facility (5) in which an amount of power generation fluctuates in accordance with a state transition of an external environment. Also, when correction of the production plan is required, the information processing system (500) generates a proposal for correction of the production plan; generates a power accumulation plan, an electrical discharge plan, and an acquisition plan based on the generated proposal for correction of the production plan and a power generation plan of the power generation facility (5) based on a prediction of the state transition of the external environment, the power accumulation plan being a plan about power accumulation of an excess amount of electric power when the amount of power generation exceeds a demanded amount of electric power, the electrical discharge plan being a plan about electrical discharge of the accumulated excess amount of electric power to the production facility (1), and the acquisition plan being a plan about acquisition of a shortfall of the amount of electric power from a power supply facility other than the power generation facility (5) when a total amount of electric power of the amount of power generation and the accumulated amount of electric power is insufficient for the demanded amount of electric power; and determines whether the production plan is corrected by following the proposal for correction of the production plan based on the power accumulation plan, the electrical discharge plan, and the acquisition plan.

### CROSS REFERENCE TO RELATED APPLICATION

This application is a Continuation of PCT International Application No. PCT/JP2022/030035, filed on Aug. 5, 2022, which is hereby expressly incorporated by reference into the present application.

### TECHNICAL FIELD

The present invention relates to correction of a production plan.

### BACKGROUND ART

In Japan, China, Europe and America, and so forth, automation in a production facility is being promoted to make manufacturing more efficient. On the other hand, legal regulations regarding emission of environmental load substances such as carbon dioxide have become strict in recent years.

At present, to address the legal regulations, introduction of a renewable energy supply facility as a power supply facility that supplies electric power to the production facility has started to be considered. Examples of the renewable energy supply facility are photovoltaic power generation (hereinafter also referred to as PV (Photovoltaic) power generation) and an EV equipped with V2X (Vehicle-to-everything).

In these situations, it is anticipated that a ratio of the amount of power supply from the renewable energy supply facility in a demanded amount of electric power, which is the amount of power consumption of production facilities and utility facilities, increases. Utility facilities are facilities that supply resources required for production to production facilities.

In this manner, since it is anticipated that the ratio of the amount of power supply from the renewable energy supply facility in the demanded amount of electric power increases, a balance is demanded between operation of the production facilities and the utility facilities and operation of the renewable energy supply facility. By achieving the balance in operation, it is possible to reduce the amount of emission of carbon dioxide while maintaining production efficiency. With this, it is possible to comply with the legal regulations.

In Patent Literature 1, a method of optimizing an electric power price by adjusting a production plan is disclosed.

More specifically, in the technology of Patent Literature 1, based on a predetermined price plan, production is performed in a night time zone with a low electric power unit price, thereby optimizing the electric power price.

### CITATION LIST

### Patent Literature

Patent Literature 1: JP 2014-81774

### SUMMARY OF INVENTION

### Technical Problem

In a power generation facility such as a renewable energy supply facility, the amount of power generation fluctuates in accordance with a state transition of the external environment. For example, in photovoltaic power generation, the amount of power generation fluctuates in accordance with the amount of insolation. When this power generation facility is used as an electric power supply source, it is required to generate a production plan that can efficiently utilize fluctuations in the amount of power generation.

In Patent Literature 1, when this power generation facility is used as an electric power supply source, there is a problem in which it is impossible to generate a production plan that can efficiently utilize fluctuations in the amount of power generation.

A main object of the present disclosure is to solve the problem as described above. Specifically, an object of the present disclosure is to acquire a production plan that can efficiently utilize fluctuations in the amount of power generation when a power generation facility in which the amount of power generation fluctuates in accordance with a state transition of the external environment is used as a power supply source.

### Solution to Problem

An information processing system according to the present disclosure includes:
a determining unit to determine whether correction is required for a production plan of a production facility that performs production by receiving electric power supply from a power generation facility in which an amount of power generation fluctuates in accordance with a state transition of an external environment; and
a correcting unit to generate a proposal for correction of the production plan when it is determined by the determining unit that correction of the production plan is required; to generate a power accumulation plan, an electrical discharge plan, and an acquisition plan based on the generated proposal for correction of the production plan and a power generation plan of the power generation facility based on a prediction of the state transition of the external environment, the power accumulation plan being a plan about power accumulation of an excess amount of electric power when the amount of power generation at the power generation facility exceeds a demanded amount of electric power, which is an amount of electric power for production at the production facility, the electrical discharge plan being a plan about electrical discharge of the accumulated excess amount of electric power to the production facility, and the acquisition plan being a plan about acquisition of a shortfall of the amount of electric power from a power supply facility other than the power generation facility when a total amount of electric power of the amount of power generation of the power generation facility and the accumulated amount of electric power is insufficient for the demanded amount of electric power; and to determine whether the production plan is corrected by following the proposal for correction of the production plan based on the power accumulation plan, the electrical discharge plan, and the acquisition plan that are generated.

### Advantageous Effects of Invention

According to the present disclosure, it is possible to acquire a production plan that can efficiently utilize fluctuations in the amount of power generation when a power generation facility in which the amount of power generation fluctuates in accordance with a state transition of the external environment is used as a power supply source.

### BRIEF DESCRIPTION OF DRAWINGS

FIG. 1 is a diagram depicting an example of structure of a production plan optimization system according to Embodiment 1.

FIG. 2 is a diagram depicting an example of hardware structure of a production plan generation device according to Embodiment 1.

FIG. 3 is a diagram depicting an example of functional structure of the production plan generation device according to Embodiment 1.

FIG. 4 is a diagram depicting an example of hardware structure of a supply facility operation plan generation device according to Embodiment 1.

FIG. 5 is a diagram depicting an example of functional structure of the supply facility operation plan generation device according to Embodiment 1.

FIG. 6 is a diagram depicting an example of hardware structure of an optimization device according to Embodiment 1.

FIG. 7 is a diagram depicting an example of functional structure of the optimization device according to Embodiment 1.

FIG. 8 is a diagram depicting an example of process information according to Embodiment 1.

FIG. 9 is a diagram depicting an example of a sequence of a production process according to Embodiment 1.

FIG. 10 is a diagram depicting an example of productivity information according to Embodiment 1.

FIG. 11 is a diagram depicting an example of process operation information according to Embodiment 1.

FIG. 12 is a diagram depicting an example of facility operation information according to Embodiment 1.

FIG. 13 is a diagram depicting an example of production plan information according to Embodiment 1.

FIG. 14 is a diagram depicting an example of calculation time information according to Embodiment 1.

FIG. 15 is a diagram depicting an example of calculation unit time information according to Embodiment 1.

FIG. 16 is a diagram depicting an example of production resource information according to Embodiment 1.

FIG. 17 is a diagram depicting an example of production resource information according to Embodiment 1.

FIG. 18 is a diagram depicting an example of production resource information according to Embodiment 1.

FIG. 19 is a diagram depicting an example of production resource information according to Embodiment 1.

FIG. 20 is a diagram depicting an example of environmental load substance information according to Embodiment 1.

FIG. 21 is a diagram depicting an example of production facility operation plan information according to Embodiment 1.

FIG. 22 is a diagram depicting utility facility operation schedule information according to Embodiment 1.

FIG. 23 is a diagram depicting an example of utility resource information according to Embodiment 1.

FIG. 24 is a diagram depicting utility facility operation plan information according to Embodiment 1.

FIG. 25 is a diagram depicting an example of consumption resource information and environmental load information according to Embodiment 1.

FIG. 26 is a diagram depicting an example of structure of a renewable energy supply facility according to Embodiment 1.

FIG. 27 is a diagram depicting an example of maximum power information according to Embodiment 1.

FIG. 28 is a diagram depicting an example of PV facility information according to Embodiment 1.

FIG. 29 is a diagram depicting an example of accumulator battery information in Embodiment 1.

FIG. 30 is a diagram depicting an example of weather forecast information according to Embodiment 1.

FIG. 31 is a diagram depicting an example of PV power generation plan information according to Embodiment 1.

FIG. 32 is a diagram depicting an example of EV operation plan information according to Embodiment 1.

FIG. 33 is a diagram depicting an example of demand-side power consumption amount information according to Embodiment 1.

FIG. 34 is a diagram depicting an example of EV charge/discharge amount information according to Embodiment 1.

FIG. 35 is a diagram depicting an example of supply facility operation plan information according to Embodiment 1.

FIG. 36 is a diagram depicting an example of electric power unit price information according to Embodiment 1.

FIG. 37 is a diagram depicting an example of supply/demand power purchase cost information according to Embodiment 1.

FIG. 38 is a diagram depicting an example of labor unit cost information according to Embodiment 1.

FIG. 39 is a diagram depicting an example of information about the number of workers according to Embodiment 1.

FIG. 40 is a diagram depicting an example of CO2 emission unit cost information according to Embodiment 1.

FIG. 41 is a diagram depicting an example of production cost information according to Embodiment 1.

FIG. 42 is a diagram depicting an example of production evaluation index information according to Embodiment 1.

FIG. 43 is a diagram depicting an example of target value information according to Embodiment 1.

FIG. 44 is a flowchart depicting an example of operation according to Embodiment 1.

FIG. 45 is a flowchart depicting the example of operation according to Embodiment 1.

FIG. 46 is a diagram depicting an example of production plan information under a sequential scheme.

FIG. 47 is a diagram depicting an example of production plan information under a synchronous scheme according to Embodiment 1.

FIG. 48 is a diagram depicting an example of production facility operation plan information under the sequential scheme.

FIG. 49 is a diagram depicting an example of consumption resource information and environmental load information under the sequential scheme.

FIG. 50 is a diagram depicting an example of production facility operation plan information under the synchronous scheme according to Embodiment 1.

FIG. 51 is a diagram depicting an example of consumption resource information and environmental load information under synchronous scheme according to Embodiment 1.

FIG. 52 is a diagram depicting an example of demand-side power consumption amount information under the sequential scheme.

FIG. 53 is a diagram depicting an example of demand-side power consumption amount information under the synchronous scheme according to Embodiment 1.

FIG. 54 is a diagram depicting an example of supply facility operation plan information under the sequential scheme.

FIG. 55 is a diagram depicting an example of supply facility operation plan information under the synchronous scheme according to Embodiment 1.

FIG. 56 is a diagram depicting an example of supply/demand power purchase cost information under the sequential scheme.

FIG. 57 is a diagram depicting an example of supply/demand power purchase cost information under the synchronous scheme according to Embodiment 1.

FIG. 58 is a diagram depicting an example of production cost information under the sequential scheme.

FIG. 59 is a diagram depicting an example of production cost information under the synchronous scheme according to Embodiment 1.

FIG. 60 is a diagram depicting an example of production evaluation index information under the sequential scheme.

FIG. 61 is a diagram depicting an example of production evaluation index information under the synchronous scheme according to Embodiment 1.

FIG. 62 is a diagram depicting an example of functional structure of an optimization device according to Embodiment 2.

FIG. 63 is a flowchart depicting an example of operation according to Embodiment 2.

FIG. 64 is a flowchart depicting an example of operation according to Embodiment 2.

FIG. 65 is a diagram depicting an example of production plan correction proposal information according to Embodiment 1.

### DESCRIPTION OF EMBODIMENTS

Embodiments are described below by using the drawings. In the description of the embodiments below and the drawings, components with the same reference character indicate the same portion or correspond to each other.

### Embodiment 1

### ***Description of System Structure***

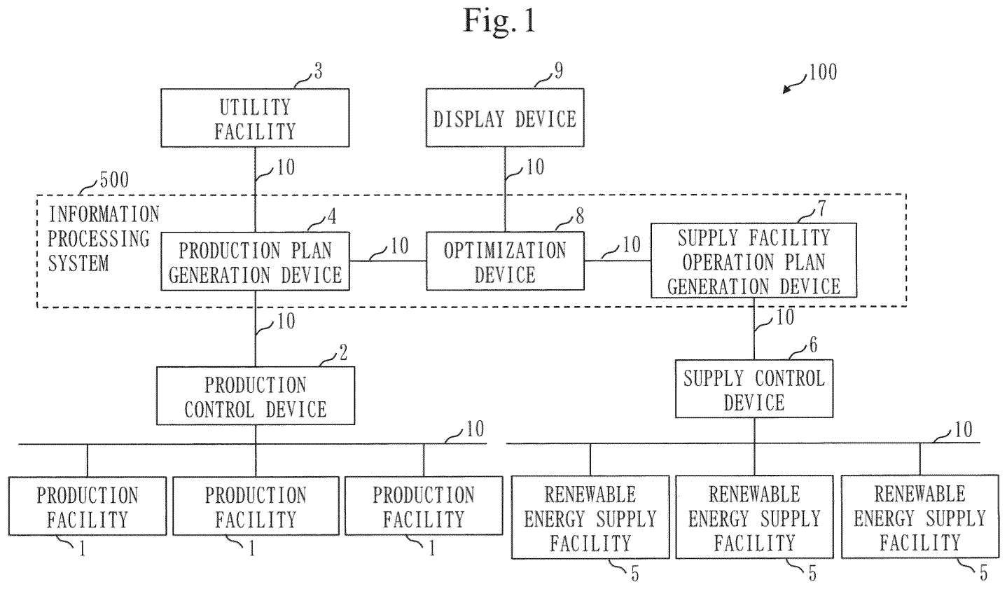

FIG. 1 depicts one example of a production plan optimization system 100 according to Embodiment 1.

As depicted in FIG. 1, the production plan optimization system 100 includes production facilities 1, a production control device 2, a utility facility 3, a production plan generation device 4, renewable energy supply facilities 5, a supply control device 6, a supply facility operation plan generation device 7, an optimization device 8, a display device 9, and a network 10.

In the present embodiment, an example is described in which the production plan optimization system 100 includes three production facilities 1. However, the number of production facilities 1 is any.

Also, in the present embodiment, an example is described in which the production plan optimization system 100 includes one utility facility 3. However, the number of utility facilities 3 is any.

Also, in the present embodiment, an example is described in which the production plan optimization system 100 includes three renewable energy supply facilities 5. However, the number of renewable energy supply facilities 5 is any.

Note that the production plan generation device 4, the supply facility operation plan generation device 7, and the optimization device 8 correspond to an information processing system 500. Also, operation to be performed at the production plan generation device 4, the supply facility operation plan generation device 7, and the optimization device 8 corresponds to an information processing method. Furthermore, a program achieving the operation of the production plan generation device 4, the supply facility operation plan generation device 7, and the optimization device 8 corresponds to an information processing program.

The production facilities 1 are used for production of articles. The production facilities 1 produce articles by receiving electric power supply from the renewable energy supply facilities 5.

The production facilities 1 include, for example, an injection molding machine or an extrusion molding machine that processes raw materials of the articles. Also, the production facilities 1 may include a processing device such as a lathe and a grinder. Furthermore, the production facilities 1 may include an assembling device for assembling articles by fastening the articles with components such as screws and nuts. Also, the production facilities 1 may include an inspection device such as a magnetic particle inspection device, a radiographic inspection device, and a penetrant inspection device.

The production control device 2 controls the production facilities 1 by following an article production plan and administrates production of articles.

The production control device 2 is, for example, a programmable logic controller (PLC) or the like.

The utility facility 3 supplies a resource necessary for production to the production facilities 1.

The resource to be supplied by the utility facility 3 to the production facilities 1 is, for example, cold water, hot water, compressed air, electric power, or the like.

Although not depicted, the production facilities 1 and the utility facility 3 are connected via a supply path for supplying a resource such as a water supply pipe, an air supply pipe, a wireway, or the like. Note that the utility facility 3 is a facility that is uncontrollable by the production control device 2. Also, an administrator for administrating the production facilities 1 may be different from an administrator for administrating the utility facility 3. Also, the utility facility 3 supplies the resource only to the production facility 1 controlled by the production control device 2. The utility facility 3 does not supply the resource to the production facility 1 not controlled by the production control device 2.

The production plan generation device 4 generates a production plan for the production facilities 1.

Also, when an instruction for correcting the production plan is issued by the optimization device 8, the production plan generation device 4 generates a proposal for correction of the production plan. Then, based on the proposal for correction of the production plan, the production plan generation device 4 generates a new production plan.

The renewable energy supply facilities 5 each include a renewable energy power generation device. The renewable energy supply facility 5 supplies electric power generated by the renewable energy power generation device to the production facilities 1.

The renewable energy supply facilities 5 are power generation facilities where the amount of power generation fluctuates in accordance with the state transition of the external environment. “The state transition of the external environment” refers to that the state of the environment where energy as a source of conversion to electrical energy is supplied to the power generation facilities changes with a lapse of time. In the present embodiment, the renewable energy supply facilities 5 are assumed to each include a photovoltaic power generation device (PV) as a renewable energy power generation device. In the present embodiment, in an environment radiated with optical energy (sunlight) as a source of conversion to electrical energy, the amount of radiation of optical energy (sunlight) changes with time, which corresponds to “the state transition of the external environment”. That is, in the present embodiment, a change in the amount of solar radiation with a lapse of time corresponds to “the state transition of the external environment”. As well known, in the photovoltaic power generation device, a change in the amount of solar radiation changes the amount of power generation.

Also, each renewable energy supply facility 5 may include, in place of a photovoltaic power generation device, another renewable energy power generation device such as a geothermal power generation device or a biomass power generation device. Also when the renewable energy supply facility 5 includes another renewable energy power generation device such as a geothermal power generation device or a biomass power generation device, the renewable energy supply facility 5 corresponds to a power generation facility in which the amount of power generation fluctuates in accordance with a state transition of an external environment.

Also, the renewable energy supply facility 5 includes an electric shuttle vehicle (EV) for shuttling employees and an accumulator device.

Also, as described above, since the amount of power generation of the renewable energy supply facility 5 fluctuates, the amount of power generation may be insufficient for the amount of electric power demanded by the production facilities 1 and the utility facility 3. In the present embodiment, to address the insufficiency of the amount of power generation, in addition to the renewable energy supply facilities 5, an auxiliary power supply facility not depicted in FIG. 1 is present.

When the amount of power generation is insufficient, the renewable energy supply facility 5 acquires a shortfall of the amount of electric power (purchases power) from the auxiliary power supply facility.

Based on the production plan generated at the production plan generation device 4, the supply facility operation plan generation device 7 generates a supply facility operation plan, which is an operation plan for the renewable energy supply facilities 5. The supply facility operation plan is a power supply plan of the renewable energy supply facilities 5.

Also, when an instruction for correcting the production plan is issued by the optimization device 8, the supply facility operation plan generation device 7 generates a proposal for correction of the supply facility operation plan based on the proposal for correction of the production plan by the production plan generation device 4.

The supply control device 6 controls the renewable energy supply facilities 5 by following the supply facility operation plan.

The supply control device 6 is, for example, a PLC or the like.

The optimization device 8 determines whether a correction of the production plan generated at the production plan generation device 4 is required.

When determining that a correction of the production plan is not required, the optimization device 8 approves the production plan. Then, based on the production plan approved by the optimization device 8, the production facilities 1 are controlled. Also, with the supply facility operation plan based on the production plan approved by the optimization device 8, the renewable energy supply facilities 5 are controlled.

On the other hand, when determining that a correction of the production plan is required, the optimization device 8 issues an instruction for generation of a proposal for correction of the production plan to the production plan generation device 4. Following the instruction from the optimization device 8, the production plan generation device 4 generates a plurality of proposals for correction of the production plan.

The optimization device 8 selects any proposal for correction from among the plurality of proposals for correction of the production plan.

Then, with the production plan following the proposal for correction selected by the optimization device 8, the production facilities 1 are controlled. Also, with the supply facility operation plan based on the proposal for correction selected by the optimization device 8, the renewable energy supply facilities 5 are controlled.

The display device 9 generates a display screen reflecting the production plan approved by the optimization device 8, and displays the generated display screen. The display device 9 includes a monitor such as a liquid-crystal display or organic EL (Electroluminescence) display. The display device 9 displays the generated display screen on the monitor.

Note that while an example is described in the present embodiment in which the display device 9 and the optimization device 8 are separated, the display device 9 may be integrated with the optimization device 8. That is, the optimization device 8 may have a display function.

The network 10 connects components included in the production plan optimization system 100.

Specifically, the network 10 connects the production facilities 1 and the production control device 2 together. Also, the network 10 connects the production control device 2 and the production plan generation device 4 together. Also, the network 10 connects the utility facility 3 and the production plan generation device 4 together. Also, the network 10 connects the production plan generation device 4 and the optimization device 8 together. Also, the network 10 connects the optimization device 8 and the supply facility operation plan generation device 7 together. Also, the network 10 connects the optimization device 8 and the display device 9 together. Also, the network 10 connects the supply facility operation plan generation device 7 and the supply control device 6 together. Also, the network 10 connects the supply control device 6 and the renewable energy supply facilities 5 together.

The network 10 is a field network such as, for example, CC-Link (Control & Communication Link, registered trademark). Also, the network 10 may be a general network such as Ethernet (registered trademark) or a dedicated input/output line.

Note that an example is described in the present embodiment in which the components included in the production plan optimization system 100 are all connected via the same network 10. However, each component may be connected via a different network.

### ***General Outlines***

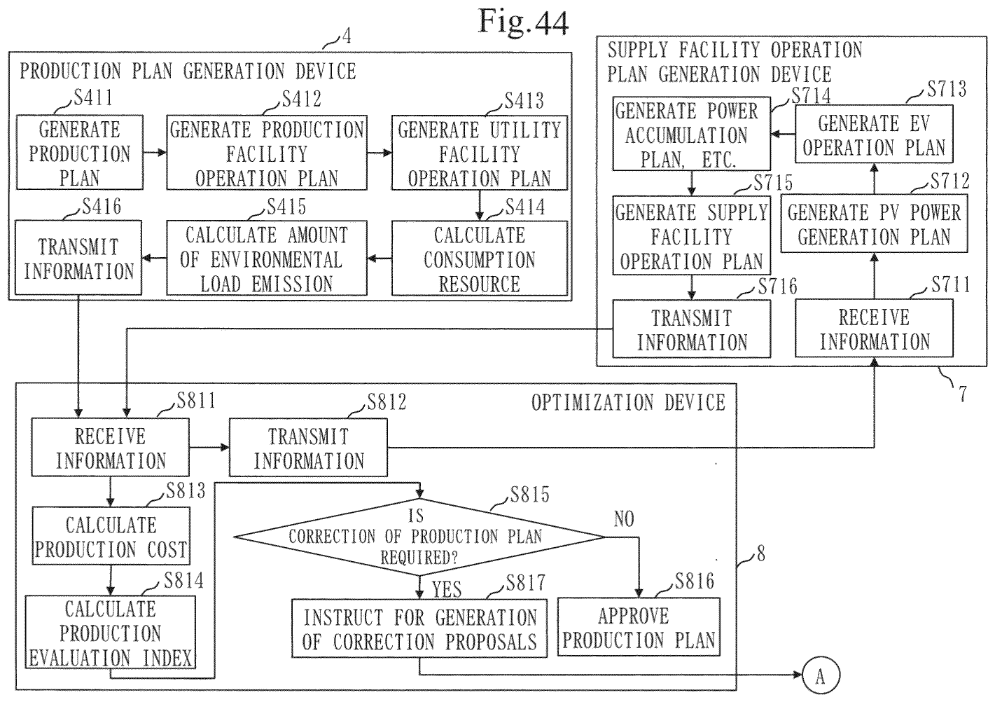

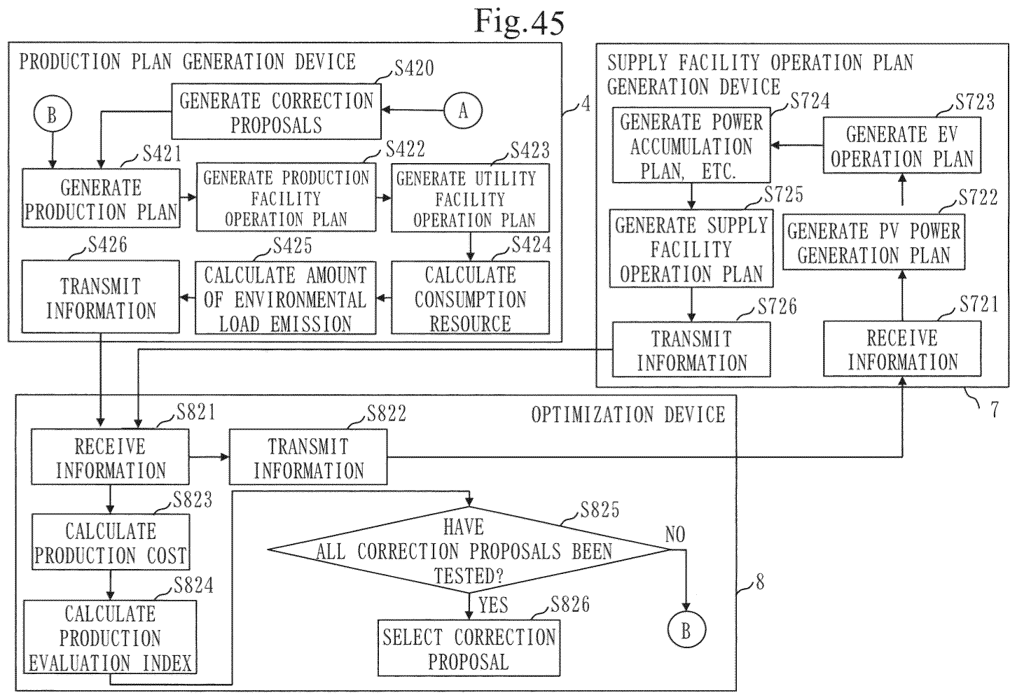

Here, prior to description of details of the production plan generation device 4, the supply facility operation plan generation device 7, and the optimization device 8 depicted in FIG. 1, general outlines of operation of the production plan generation device 4, the supply facility operation plan generation device 7, and the optimization device 8 are described with reference to FIG. 44 and FIG. 45.

First, the production plan generation device 4 generates a production plan (step S411). In the production plan, general outlines of production at the production facility 1 are defined.

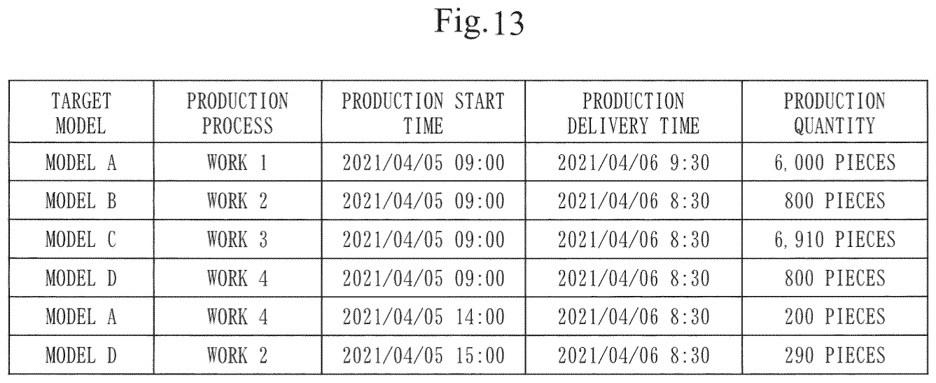

Information in which the production plan is indicated is referred to as production plan information. FIG. 13 depicts an example of production plan information. Details of FIG. 13 are described further below.

Next, based on the production plan, the production plan generation device 4 generates a production facility operation plan for each unit time (step S412).

The unit time is a time for administrating production at the production facilities 1. The unit time is also referred to as a calculation unit time. The unit time is, as depicted in FIG. 15, for example, 3,600 seconds (=1 hour).

The production facility operation plan is an operation plan for the production facilities 1, and a plan in which the production plan is detailed. In the production facility operation plan, an article (model) as a production target, production quantity, operation at the production facilities 1, and so forth are defined for each unit time.

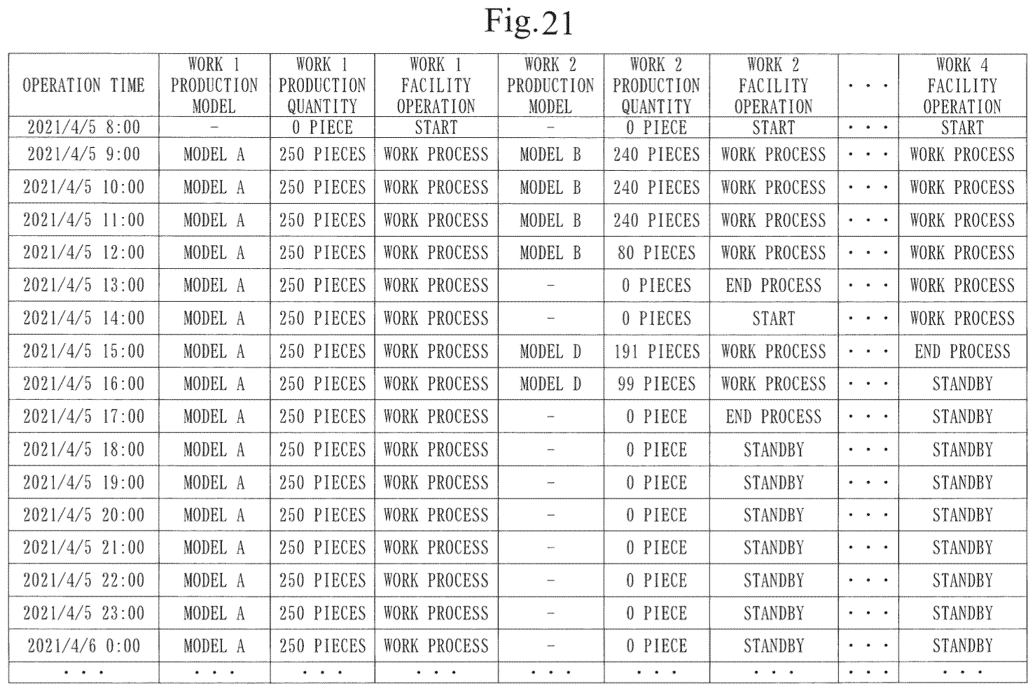

Information in which the production facility operation plan is indicated is referred to as production facility operation plan information. FIG. 21 depicts an example of production facility operation plan information. Details of FIG. 21 are described further below.

Also, based on the production facility operation plan, the production plan generation device 4 generates a utility facility operation plan for each unit time (step S413).

The utility facility operation plan is an operation plan for the utility facility 3. In the utility facility operation plan, an amount of supply of a resource supplied from the utility facility 3, operation to be performed at the utility facility 3, and so forth are defined for each unit time.

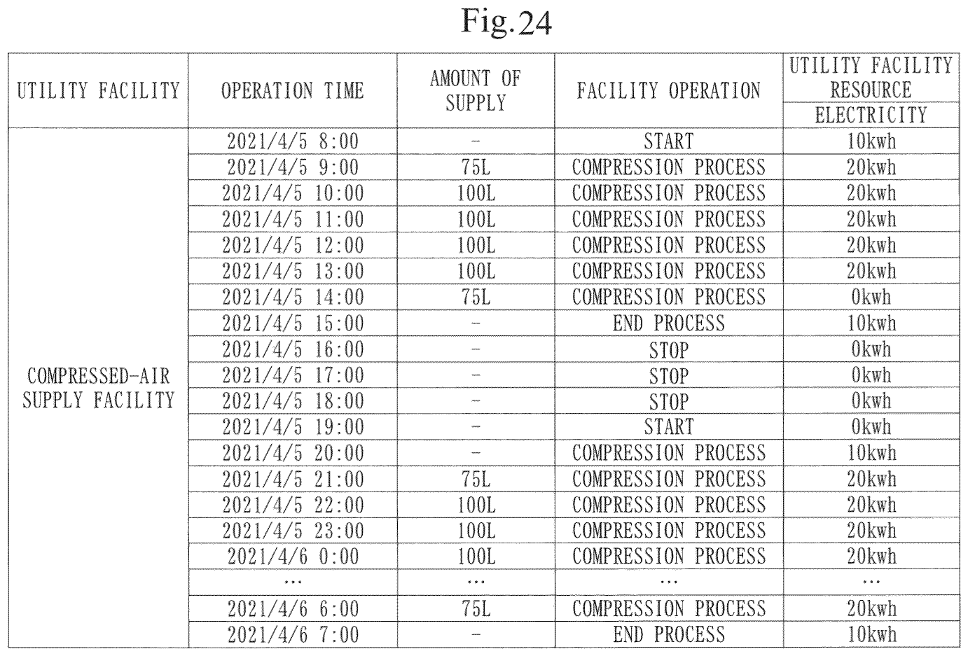

Information in which the utility facility operation plan is indicated is referred to as utility facility operation plan information. FIG. 24 depicts an example of utility facility operation plan information. Details of FIG. 24 are described further below.

Also, based on the production facility operation plan and the utility facility operation plan, the production plan generation device 4 calculates a total of consumption resources to be consumed at the production facilities 1 and the utility facility 3 (step S414).

Also, based on the production facility operation plan and the utility facility operation plan, the production plan generation device 4 calculates a total amount of environmental load emission at the production facilities 1 and the utility facility 3 (step S415).

Information in which the total of consumption resources calculated by the production plan generation device 4 is indicated is referred to as consumption resource information. Also, information in which the total amount of environmental load emission calculated by the production plan generation device 4 is indicated is referred to as environmental load information.

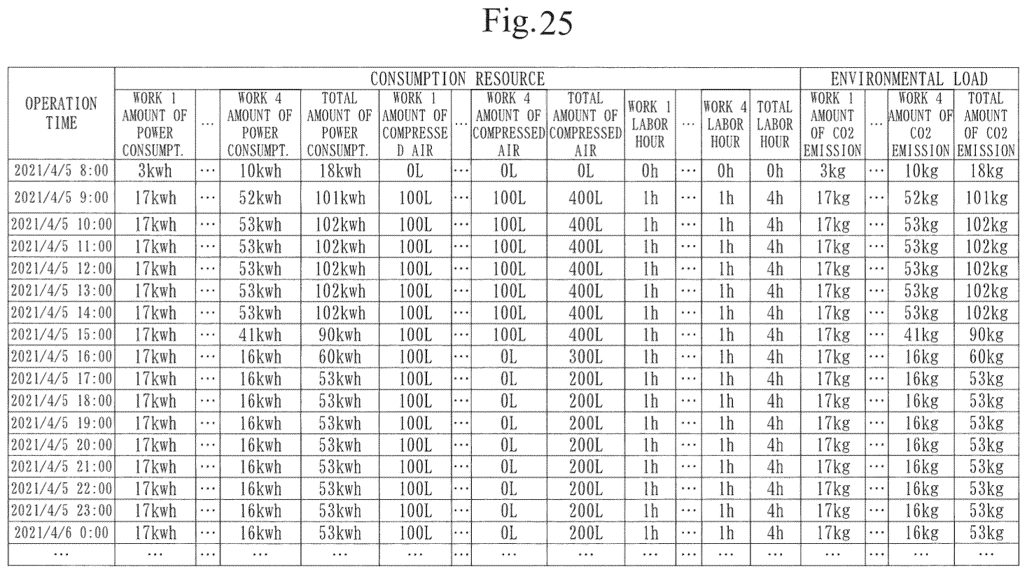

FIG. 25 depicts an example of consumption resource information and environmental load information. Details of FIG. 25 are described further below.

Then, the production plan generation device 4 transmits the production facility operation plan information, the utility facility operation plan information, the consumption resource information, and the environmental load information to the optimization device 8 (step S416).

The optimization device 8 receives the production facility operation plan information, the utility facility operation plan information, the consumption resource information, and the environmental load information from the production plan generation device 4 (step S811).

Then, the optimization device 8 transmits the production facility operation plan information, the utility facility operation plan information, and the consumption resource information to the supply facility operation plan generation device 7 (step S812).

The supply facility operation plan generation device 7 receives, from the optimization device 8, the production facility operation plan information, the utility facility operation plan information, and the consumption resource information (step S711).

Next, the supply facility operation plan generation device 7 generates a PV power generation plan based on weather forecast information (step S712). The PV power generation plan is a power generation plan of the photovoltaic power generation device (PV) included in each renewable energy supply facility 5.

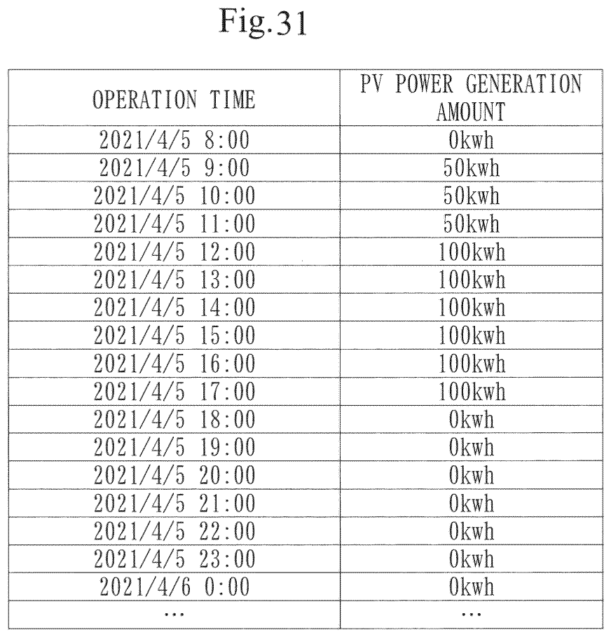

Information in which the PV power generation plan generated by the supply facility operation plan generation device 7 is indicated is referred to as PV power generation plan information. FIG. 31 depicts an example of PV power generation plan information. Details of FIG. 31 are described further below.

Also, based on the production facility operation plan information and the utility facility operation plan information, the supply facility operation plan generation device 7 generates an EV operation plan (step S713). The EV operation plan is an operation plan for EV. The EV is used to shuttle employees working at the production facilities 1 and the utility facility 3.

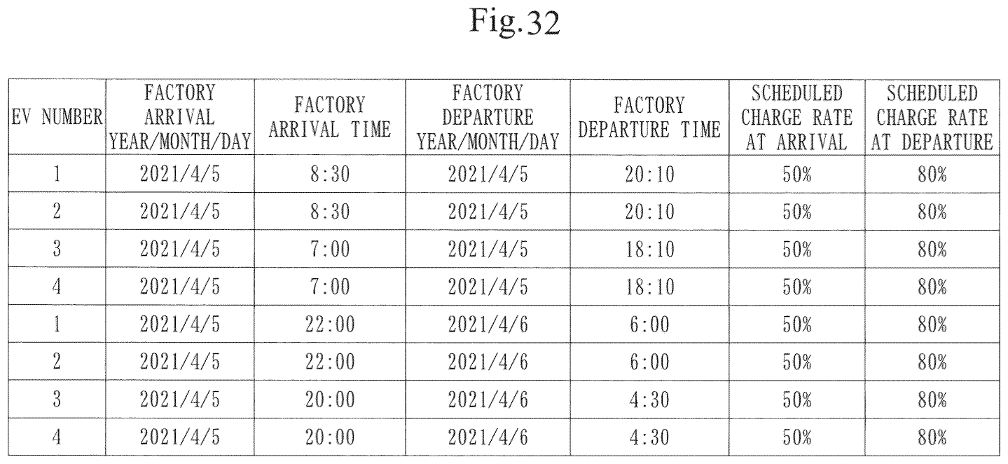

Information in which the EV operation plan is indicated is referred to as EV operation plan information. FIG. 32 depicts an example of EV operation plan information. Details of FIG. 32 are described further below.

Also, based on the consumption resource information, the PV power generation plan, and the EV operation plan, the supply facility operation plan generation device 7 generates a power accumulation plan, an electrical discharge plan, and an acquisition plan (step S714).

The power accumulation plan is a plan about power accumulation of an excess amount of electric power to an accumulation battery and/or EV when the PV power generation amount exceeds a demanded amount of electric power (amount of electric power required at the production facilities 1 and the utility facility 3).

The electrical discharge plan is a plan about electrical discharge of the accumulated excess of the amount of electric power to the production facilities 1.

The acquisition plan is a plan about acquisition of a shortfall of the amount of electric power (power purchase) from the auxiliary power supply facility when the total amount of electric power of the PV power generation amount and the accumulated amount of electric power is insufficient for the demanded amount of electric power.

Also, based on the consumption resource information, the PV power generation plan, the power accumulation plan, the electrical discharge plan, and the acquisition plan, the supply facility operation plan generation device 7 generates a supply facility operation plan (step S715).

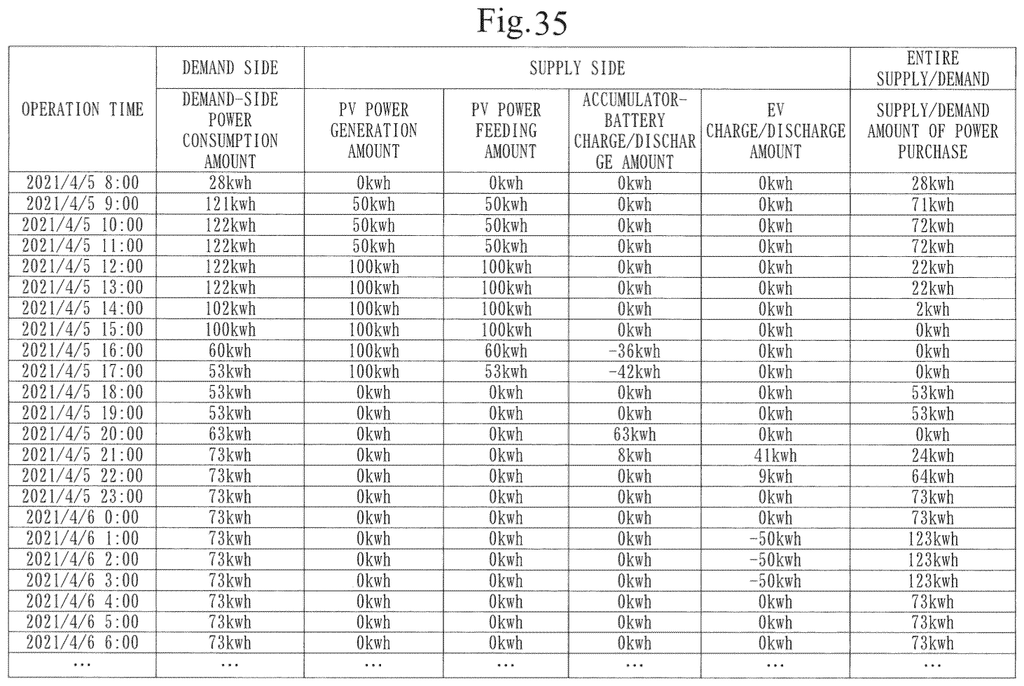

Information in which the supply facility operation plan is indicated is referred to as supply facility operation plan information. FIG. 35 depicts an example of supply facility operation plan information.

In the supply facility operation plan information, the demand-side power consumption amount is based on the consumption resource information (FIG. 25). Also, the PV power generation amount is based on the PV power generation plan. The accumulator-battery charge/discharge amount and the EV charge/discharge amount are based on the power accumulation plan and the electrical discharge plan. The supply/demand amount of power purchase is based on the acquisition plan. Details of FIG. 35 are described further below.

Next, the supply facility operation plan generation device 7 transmits the supply facility operation plan information to the optimization device 8 (step S716).

The optimization device 8 receives the supply facility operation plan information from the supply facility operation plan generation device 7 (step S811).

Then, the optimization device 8 calculates production cost based on the production facility operation plan information, the utility facility operation plan information, the consumption resource information, the environmental load information, and the supply facility operation plan information (step S813).

The production cost is a cost required for production following the production plan. The production cost includes a labor cost and an environmental load cost, as well as a power purchase cost (power acquisition cost), which is a cost required for acquiring the amount of electric power from the auxiliary power supply facility, and so forth.

Next, the optimization device 8 calculates a production evaluation index, which is an index value of a production cost (step S814).

Next, the optimization device 8 determines whether correction of the production plan is required (step S815).

Specifically, the optimization device 8 determines whether the production evaluation index matches a target value.

When the production evaluation index matches the target value, the optimization device 8 determines that correction of the production plan is not required. When determining that correction of the production facility operation plan is not required, the optimization device 8 approves the production plan generated by the production plan generation device 4 (step S816). When the optimization device 8 approves the production plan, the production facilities 1 are controlled with the production facility operation plan generated by the production plan generation device 4. Also, the renewable energy supply facility 5 is controlled with the supply facility operation plan generated by the supply facility operation plan generation device 7.

On the other hand, when the production evaluation index does not match the target value, the optimization device 8 determines that correction of the production plan is required.

When determining that correction of the production plan is required, the optimization device 8 transmits a correction proposal generation instruction (step S817). The correction proposal generation instruction is a command for making an instruction for generating a proposal for correction of the production plan to the production plan generation device 4.

The optimization device 8 causes the production plan generation device 4 to generate a proposal for correction of the production plan with a round-robin scheme so as to fit the correction proposal generation instruction.

Note that the optimization device 8 may use the production cost in place of the production evaluation index to determine whether correction of the production plan is required. That is, the optimization device 8 may determine whether the production cost matches the target value regarding the production cost. In this case, the optimization device 8 can omit calculation of the production evaluation index (step 814).

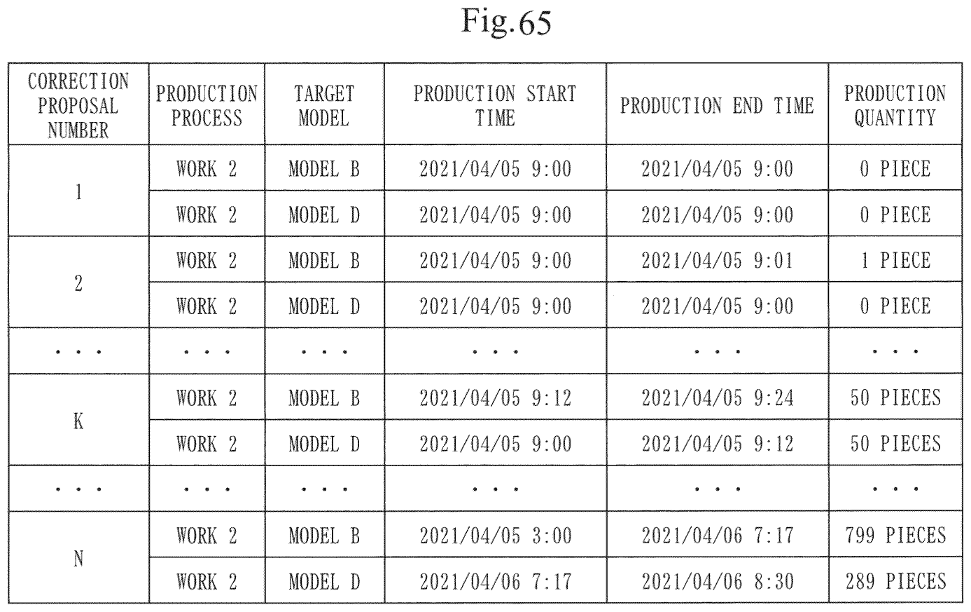

As depicted in FIG. 45, when receiving the correction proposal generation instruction from the optimization device 8, the production plan generation device 4 generates a plurality of proposals for correction of the production plan with the round-robin scheme (step S420). Here, it is assumed that N (N≥2) correction proposals are generated. FIG. 65 depicts an example of production plan correction proposal information in which N proposals for correction of the production plan are indicated. Details of FIG. 65 are described further below.

Subsequently, for each correction proposal, the processes from step S421 to step S825 are performed. That is, the processes from step S421 to step S825 are repeated N times.

Specifically, the production plan generation device 4 generates an i-th new production plan based on an i-th (i is any from 0 to N) correction proposal (step S421).

Information in which the new production plan is indicated is referred to as new production plan information.

The new production plan information is different from the production plan information depicted in FIG. 13 only in numerical values, and the format is identical to the production plan information depicted in FIG. 13.

Furthermore, the production plan generation device 4 generates an i-th new production facility operation plan based on the i-th new production plan (step S422).

Information in which the new production facility operation plan is indicated is referred to as new production facility operation plan information.

The new production facility operation plan information is different from the production facility operation plan information depicted in FIG. 21 only in numerical values, and the format is identical to the production facility operation plan information depicted in FIG. 21.

Also, the production plan generation device 4 generates an i-th new utility facility operation plan based on the i-th new production facility operation plan (step S423).

Information in which the new utility facility operation plan is indicated is referred to as new utility facility operation plan information.

The new utility facility operation plan information is different from the utility facility operation plan information depicted in FIG. 24 only in numerical values, and the format is identical to the utility facility operation plan information depicted in FIG. 24.

Also, the production plan generation device 4 calculates an i-th new total of consumption resources to be consumed at the production facilities 1 and the utility facility 3 based on the i-th new production facility operation plan and the i-th new utility facility operation plan (step S424).

Information in which the new total of resources to be consumed at the production facilities 1 and the utility facility 3 is indicated is referred to as new consumption resource information.

The new consumption resource information is different from the consumption resource information depicted in FIG. 25 only in numerical values, and the format is identical to the consumption resource information depicted in FIG. 25.

Also, the production plan generation device 4 calculates an i-th new total of amounts of environmental load emission at the production facilities 1 and the utility facility 3 based on the i-th new production facility operation plan and the i-th new utility facility operation plan (step S425).

Information in which the new total of amounts of environmental load emission at the production facilities 1 and the utility facility 3 is indicated is referred to as new environmental load information.

The new environmental load information is different from the environmental load information depicted in FIG. 25 only in numerical values, and the format is identical to the environmental load information depicted in FIG. 25.

Then, the production plan generation device 4 transmits the i-th new production facility operation plan information, the i-th new utility facility operation plan information, the i-th new consumption resource information, and the i-th new environmental load information to the optimization device 8 (step S426).

The optimization device 8 receives, from the production plan generation device 4, the i-th new production facility operation plan information, the i-th new utility facility operation plan information, the i-th new consumption resource information, and the i-th new environmental load information (step S821).

Then, the optimization device 8 transmits the i-th new production facility operation plan information, the i-th new utility facility operation plan information, and the i-th new consumption resource information to the supply facility operation plan generation device 7 (step S822).

The supply facility operation plan generation device 7 receives, from the optimization device 8, the i-th new production facility operation plan information, the i-th new utility facility operation plan information, and the i-th new consumption resource information (step S721).

Next, the supply facility operation plan generation device 7 generates an i-th new PV power generation plan based on the weather forecast information (step S722). Note that step S722 may be omitted. In this case, at step S724 described further below, the supply facility operation plan generation device 7 uses the PV power generation plan immediately previously generated.

Also, the supply facility operation plan generation device 7 generates an i-th new EV operation plan based on the i-th new production facility operation plan information and the i-th new utility facility operation plan information (step S723).

Also, the supply facility operation plan generation device 7 generates an i-th new power accumulation plan, an i-th new electrical discharge plan, and an i-th new acquisition plan based on the i-th new consumption resource information, the i-th new PV power generation plan, and the i-th new EV operation plan (step S724).

Also, the supply facility operation plan generation device 7 generates an i-th new supply facility operation plan based on the i-th new consumption resource information, the i-th new PV power generation plan, the i-th new power accumulation plan, the i-th new electrical discharge plan, and the i-th new acquisition plan (step S725).

Information in which the new supply facility operation plan is indicated is referred to as new supply facility operation plan information.

The new supply facility operation plan information is different from the supply facility operation plan information depicted in FIG. 35 only in numerical values, and the format is identical to the supply facility operation plan information depicted in FIG. 35.

Next, the supply facility operation plan generation device 7 transmits the i-th new supply facility operation plan information to the optimization device 8 (step S726).

The optimization device 8 receives the i-th new supply facility operation plan information from the supply facility operation plan generation device 7 (step S821).

Then, the optimization device 8 calculates an i-th new production cost based on the i-th new production facility operation plan information, the i-th new utility facility operation plan information, the i-th new consumption resource information, the i-th new environmental load information, and the i-th new supply facility operation plan information (step S823).

Next, the optimization device 8 calculates an i-th new production evaluation index, which is an index value of the i-th new production cost (step S824).

Next, the optimization device 8 determines whether all proposals for correction of the production plan have been tested (step S825). That is, the optimization device 8 determines whether a production evaluation index has been calculated for every N correction proposal.

If not all correction proposals have been tested, the processes at step S421 onward are repeated for an (i+1)-th correction proposal.

On the other hand, if all correction proposals have been tested, the optimization device 8 selects a proposal for correction of the production plan with a minimum production evaluation index (step S826).

Thereafter, the production facilities 1 are controlled with a new production plan corresponding to the correction proposal selected by the optimization device 8. Also, the renewable energy supply facilities 5 are controlled with a new supply facility operation plan corresponding to the new production plan.

Note that the optimization device 8 may use the production cost in place of the production evaluation index to select a correction proposal. That is, the optimization device 8 may select a proposal for correction of the production plan with minimum production cost. In this case, the optimization device 8 can omit calculation of a production evaluation index (step S824).

In this manner, in the present embodiment, when it is determined by the optimization device 8 that correction of the production plan is required, a proposal for correction of the production plan is generated by the production plan generation device 4. Then, by using the production plan based on the generated correction proposal and the PV power generation plan generated based on the weather forecast, the supply facility operation plan generation device 7 generates a new power accumulation plan, a new electrical discharge plan, and a new acquisition plan. Furthermore, the supply facility operation plan generation device 7 generates a new supply facility operation plan by reflecting the new power accumulation plan, the new electrical discharge plan, and the new acquisition plan. Furthermore, the optimization device 8 calculates a production evaluation index by using the new supply facility operation plan, and selects any correction proposal from among the plurality of correction proposals based on the production evaluation index. Note that the optimization device 8 selecting any correction proposal from among the plurality of correction proposals is synonymous with the optimization device 8 determining for each correction proposal whether to correct the production plan by following the correction proposal.

Also, an example is described herein in which the optimization device 8 selects a correction proposal with a minimum production evaluation index from among the plurality of correction proposals generated with the round-robin scheme.

In place of this, the production plan generation device 4 may generate one correction proposal at a time and the optimization device 8 may determine whether the production evaluation index based on the correction proposal matches the target value every time a correction proposal is generated by the production plan generation device 4. That is, the optimization device 8 may perform step S815 after step S824 to determine whether the new production evaluation index matches the target value. In this case, when the new production evaluation index matches the target value, the optimization device 8 selects its corresponding correction proposal. On the other hand, when the new production evaluation index does not match the target value, the optimization device 8 performs step S817, and issues an instruction for generation of a further proposal for correction of the production plan to the production plan generation device 4.

In the round-robin scheme, a correction proposal to be reflected on the production plan cannot be selected until all correction proposals are generated and production evaluation indexes for all correction proposals are calculated. On the other hand, in this scheme, a correction proposal to be reflected on the production plan can be selected early.

### ***Details of Production Plan Generation Device 4***

Next, details of the production plan generation device 4 are described.

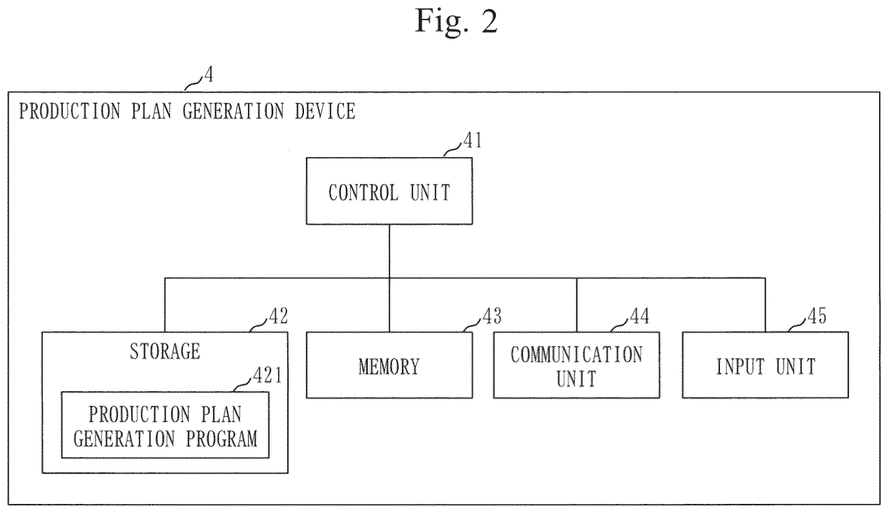

FIG. 2 depicts an example of hardware structure of the production plan generation device 4 according to Embodiment 1.

As depicted in FIG. 2, the production plan generation device 4 includes a control unit 41, a storage 42, a memory 43, a communication unit 44, and an input unit 45. Note that the production plan generation device 4 also includes a power supply, not depicted, serving as a motive power source.

The control unit 41 controls the production plan generation device 4.

The control unit 41 may be a processor such as CPU (Central Processing Unit). Also, the control unit 41 may be an integrated circuit such as FPGA (Field Programmable Gate Array), LSI (Large Scale Integration), or ASIC (Application Specific Integrated Circuit). Also, the control unit 41 may be a combination of a processor and an integrated circuit.

Note that the control unit 41, which is a superordinate concept of a processor and an integrated circuit, can be said as “processing circuitry”.

In the present embodiment, an example is described in which the control unit 41 is a processor that executes a program. That is, the control unit 41 executes a production plan generation program 421 stored in the storage 42. Details of the production plan generation program 421 are described further below.

The control unit 41 controls the storage 42, the memory 43, the communication unit 44, and the input unit 45, and executes the production plan generation program 421 to generate a production plan.

The storage 42 has stored therein various programs to be executed by the control unit 41, data to be referred to when the control unit 41 executes various programs, data generated as a result of execution of each program by the control unit 41, and so forth.

The storage 42 has stored therein, for example, the production plan generation program 421.

The storage 42 is, for example, a non-volatile memory such as flash memory, ROM (Read Only Memory), hard disk, solid-state drive, or memory card reader/writer.

The memory 43 is a storage device to be directly accessed by the control unit 41 when performing a process of the program. Various programs and data stored in the storage 42 are copied to and temporarily stored in the memory 43.

The memory 43 is, for example, a volatile memory such as RAM (Random Access Memory).

Note that the control unit 41 executes the program by temporarily storing, in the memory 43, the program normally stored in the storage 42 and reading the program from the memory 43.

The communication unit 44 includes a receiver that receives data and a transmitter that transmits data.

The communication unit 44 performs communication with an external device by using the receiver and the transmitter.

The input unit 45 accepts an input from a user. The input unit 45 is, for example, a keyboard, mouse, touchpad, or touch panel having a display function.

Next, an example of functional structure of the production plan generation device 4 according to the present embodiment is described.

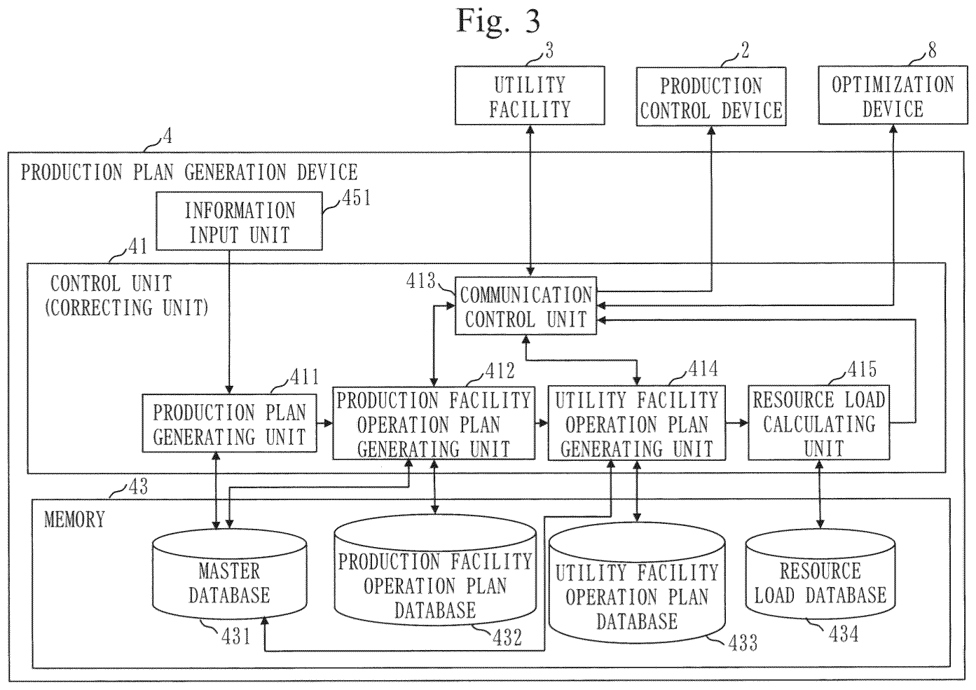

FIG. 3 depicts the example of functional structure of the production plan generation device 4.

In FIG. 3, for example, by using the input unit 45, an information input unit 451 receives an input of production plan necessary information based on order data from a user of the production plan generation device 4.

In the order data, order details (order) from a customer is indicated. More specifically, in the order data, how many lots (number of production lots) and pieces (production quantity) of which articles (models) are to be produced by when (production delivery time) are specified.

In the production plan necessary information, information necessary for generating a production plan on which the order indicated in the order data is reflected is defined.

Also, when generation of a proposal for correction of the production plan is required, by using the input unit 45, the information input unit 451 receives an input of production start time interval information from the user of the production plan generation device 4. Details of production start time interval information will be described further below.

Here, the production plan necessary information is described.

In the production plan necessary information, information about a model, production delivery time, number of production lots, and production quantity which are specified by the order data is included. Furthermore, in the production plan necessary information, information about earliest producible time, production start time, and producible line is included. The earliest producible time is the earliest time when production of an article specified by the order data can start within a period by the production delivery time. The production start time is a time when production of the article starts. The producible line is a production line capable of production of the article. For example, when production of an article X is possible on both of a production line Y and a production line Z, the producible lines of the article X are the production line Y and the production line Z.

Parameters as change targets (hereinafter, change parameter) in an instructing unit 815 which will be described further below are those three as follows.

The first is the production quantity of each model for each production line.

The second is a production sequence. When production of two or more models are planned on the same production line within the delivery time, the instructing unit 815 can change the production sequence among the models.

And, the third is the production start time. When the production completion time (total production time) for all models scheduled to be produced comes earlier than the delivery time, the instructing unit 815 can change the production start time.

In the present embodiment, these three parameters are handled as discrete values. Note that the production quantity and the production start time may be handled as continuous values.

The control unit 41 executes the production plan generation program 421 depicted in FIG. 2.

FIG. 3 schematically depicts a state in which the control unit 41 is executing the production plan generation program 421.

In the production plan generation program 421, programs achieving the functions of a production plan generating unit 411, a production facility operation plan generating unit 412, a communication control unit 413, a utility facility operation plan generating unit 414, and a resource load calculating unit 415 are included.

In the following, for simplification of description, executing, by the control unit 41, the programs achieving the functions of the production plan generating unit 411, the production facility operation plan generating unit 412, the communication control unit 413, the utility facility operation plan generating unit 414, and the resource load calculating unit 415 is described as operation by the production plan generating unit 411, the production facility operation plan generating unit 412, the communication control unit 413, the utility facility operation plan generating unit 414, and the resource load calculating unit 415.

Note that the production plan generating unit 411, the production facility operation plan generating unit 412, the communication control unit 413, the utility facility operation plan generating unit 414, and the resource load calculating unit 415 to be executed by the control unit 41 each correspond to a “correcting unit”. Also, the process to be performed by the production plan generating unit 411, the production facility operation plan generating unit 412, the communication control unit 413, the utility facility operation plan generating unit 414, and the resource load calculating unit 415 corresponds to “correcting process”.

The production plan generating unit 411 performs step S411 of FIG. 44 and step S420 and step S421 of FIG. 45.

Specifically, the production plan generating unit 411 generates a production plan based on the production plan necessary information and production facility information.

The production facility information is stored in advance in a master database 431. Details of the production facility information will be described further below.

The production plan generating unit 411 acquires the production facility information from the master database 431. Then, the production plan generating unit 411 generates a production plan based on the order data acquired from the information input unit 451 and the production facility information acquired from the master database 431.

The production plan generating unit 411 outputs production plan information indicating the production plan to the production facility operation plan generating unit 412. Also, the production plan generating unit 411 causes the production plan information to be stored in the master database 431. As described above, the production plan information is information exemplarily depicted in FIG. 13.

Also, when receiving a correction proposal generation instruction from the optimization device 8 via the communication control unit 413, the production plan generating unit 411 generates a plurality of proposals for correction of the production plan with the round-robin scheme based on the correction proposal generation instruction. In the correction proposal generation instruction, a change parameter to be reflected on the correction proposal is indicated. The production plan generating unit 411 generates a correction proposal based on the change parameter indicated in the correction proposal generation instruction. For example, in the correction proposal generation instruction, “production quantity” is indicated as a change parameter to be reflected on the correction proposal. When “production quantity” is indicated in the correction proposal generation instruction, the production plan generating unit 411 generates a plurality of correction proposals for changing the production quantity of any article.

The production plan generating unit 411 sets a correction proposal number i to each correction proposal. Here, it is assumed that the production plan generating unit 411 generates N correction proposals. In this case, the correction proposal number i takes any from 0 to N. In the following, representations such as an i-th correction proposal, i-th production plan information, i-th production facility information, and so forth may be used. It is assumed that the correction proposal number i is set to each of the i-th correction proposal, the i-th production plan information, and the i-th production facility information.

The production plan generating unit 411 generates an i-th production plan for each correction proposal with reference to the production plan necessary information and the production facility information. The production plan generating unit 411 outputs the i-th production plan information in which the i-th production plan is indicated to the production facility operation plan generating unit 412. Also, the production plan generating unit 411 causes the i-th new production plan information to be stored in the master database 431.

The production facility operation plan generating unit 412 performs step S412 of FIG. 44 and step S422 of FIG. 45.

Specifically, the production facility operation plan generating unit 412 generates an i-th production facility operation plan for each unit time based on the i-th production plan information and the i-th production facility information generated by the production plan generating unit 411.

The production facility operation plan generating unit 412 outputs i-th production facility operation plan information in which the i-th production facility operation plan is indicated to the utility facility operation plan generating unit 414. Also, the production facility operation plan generating unit 412 causes the i-th production facility operation plan information to be stored in a production facility operation plan database 432. As described above, the production facility operation plan information is information exemplarily depicted in FIG. 21.

Also, when the i-th production plan information is generated by the production plan generating unit 411, the production facility operation plan generating unit 412 generates an i-th production facility operation plan based on the i-th production plan information and the i-th production facility information.

The production facility operation plan generating unit 412 outputs i-th production facility operation plan information in which the i-th production facility operation plan is indicated to the utility facility operation plan generating unit 414. Also, the production facility operation plan generating unit 412 causes the i-th production facility operation plan information to be stored in the production facility operation plan database 432.

The utility facility operation plan generating unit 414 performs step S413 of FIG. 44 and step S423 of FIG. 45.

Specifically, the utility facility operation plan generating unit 414 generates an i-th utility facility operation plan for each unit time based on the i-th production facility operation plan information and utility facility information. The utility facility operation plan is an operation plan of the utility facility 3.

The utility facility information is stored in advance in the master database 431. Details of the utility facility information will be described further below.

The utility facility operation plan generating unit 414 acquires the utility facility information from the master database 431, and then generates an i-th utility facility operation plan based on the i-th production facility operation plan information acquired from the production facility operation plan generating unit 412 and the utility facility information acquired from the master database 431.

The utility facility operation plan generating unit 414 outputs the i-th production facility operation plan information and i-th utility facility operation plan information indicating the i-th utility facility operation plan to the resource load calculating unit 415. Also, the utility facility operation plan generating unit 414 causes the i-th utility facility operation plan information to be stored in a utility facility operation plan database 433. As described above, the utility facility operation plan information is information exemplarily depicted in FIG. 24.

Also, when an i-th production facility operation plan information is generated by the production facility operation plan generating unit 412, the utility facility operation plan generating unit 414 generates an i-th utility facility operation plan based on the i-th production facility operation plan information and utility facility information.

The utility facility operation plan generating unit 414 outputs the i-th production facility operation plan information and the i-th utility facility operation plan information in which the i-th utility facility operation plan is indicated to the resource load calculating unit 415. Also, the production facility operation plan generating unit 412 causes the i-th utility facility operation plan information to be stored in the utility facility operation plan database 433.

The resource load calculating unit 415 performs step S415 and step S416 of FIG. 44 and step S425 and step S426 of FIG. 45.

Specifically, the resource load calculating unit 415 calculates a total of resources to be consumed at the production facilities 1 and the utility facility 3 based on the i-th production facility operation plan information and the i-th utility facility operation plan information. Then, the resource load calculating unit 415 causes i-th consumption resource information indicating the calculated total of resources to be stored in a resource load database 434.

Also, the resource load calculating unit 415 calculates a total amount of environmental load emission at the production facilities 1 and the utility facility 3 based on the i-th production facility operation plan information and the i-th utility facility operation plan information. Then, the resource load calculating unit 415 causes i-th environmental load information indicating the total amount of environmental load emission to be stored in the resource load database 434.

As described above, the consumption resource information and the environmental load information are information exemplarily depicted in FIG. 25.

Furthermore, when the i-th utility facility operation plan information is generated by the utility facility operation plan generating unit 414, the resource load calculating unit 415 generates i-th consumption resource information and i-th environmental load information based on the i-th production facility operation plan information and the i-th utility facility operation plan information. Then, the resource load calculating unit 415 causes the i-th consumption resource information and the i-th environmental load information to be stored in the resource load database 434.

The communication control unit 413 performs communication with the production control device 2, the utility facility 3, and the optimization device 8 by using the communication unit 44.

Specifically, the communication control unit 413 reads the production facility operation plan information from the production facility operation plan database 432 via the production facility operation plan generating unit 412. Then, the communication control unit 413 transmits the read production facility operation plan information to the production control device 2 and the optimization device 8.

Also, the communication control unit 413 reads the utility facility operation plan information from the utility facility operation plan database 433 via the utility facility operation plan generating unit 414. Then, the communication control unit 413 transmits the read utility facility operation plan information to the utility facility 3 and the optimization device 8.

Also, the communication control unit 413 reads the consumption resource information and the environmental load information from the resource load database 434 via the resource load calculating unit 415. Then, the communication control unit 413 transmits the read consumption resource information and environmental load information to the optimization device 8.

Also, the communication control unit 413 receives a correction proposal generation instruction from the optimization device 8.

When receiving a correction proposal generation instruction from the optimization device 8, the communication control unit 413 outputs the correction proposal generation instruction to the production plan generating unit 411.

Also, when receiving a correction proposal generation instruction from the optimization device 8, the communication control unit 413 transmits the i-th production facility operation plan information, the i-th utility facility operation plan information, the i-th consumption resource information, and the i-th environmental load information to the optimization device 8.

### ***Details of Supply Facility Operation Plan Generation Device 7***

Next, details of the supply facility operation plan generation device 7 are described.

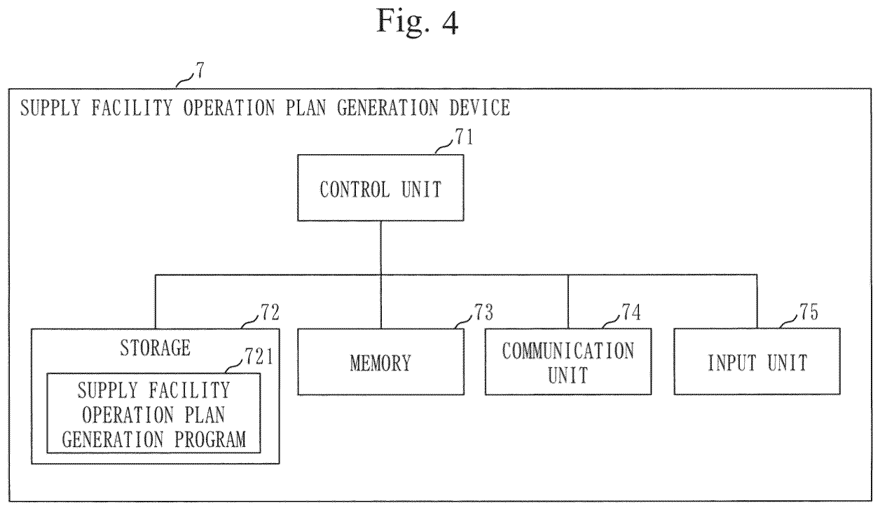

FIG. 4 depicts an example of hardware structure of the supply facility operation plan generation device 7 according to Embodiment 1.

As depicted in FIG. 4, the supply facility operation plan generation device 7 includes a control unit 71, a storage 72, a memory 73, a communication unit 74, and an input unit 75. Note that the supply facility operation plan generation device 7 also includes a power supply, not depicted, serving as a motive power source.

The control unit 71 controls the supply facility operation plan generation device 7.

The control unit 71 may be a processor such as CPU. Also, the control unit 71 may be an integrated circuit such as FPGA, LSI, or ASIC. Also, the control unit 71 may be a combination of a processor and an integrated circuit.

Note that the control unit 71, which is a superordinate concept of a processor and an integrated circuit, can be said as “processing circuitry”.

In the present embodiment, an example is described in which the control unit 71 is a processor that executes a program. That is, the control unit 71 executes a supply facility operation plan generation program 721 stored in the storage 72. Details of the supply facility operation plan generation program 721 are described further below.

The control unit 71 controls the storage 72, the memory 73, the communication unit 74, and the input unit 75, and executes the supply facility operation plan generation program 721 to generate a supply facility operation plan.

The storage 72 has stored therein various programs to be executed by the control unit 71, data to be referred to when the control unit 71 executes various programs, data generated as a result of execution of each program by the control unit 71, and so forth.

The storage 72 has stored therein, for example, the supply facility operation plan generation program 721.

The storage 72 is, for example, a non-volatile memory such as flash memory, ROM, hard disk, solid-state drive, or memory card reader/writer.

The memory 73 is a storage device to be directly accessed by the control unit 71 when performing a process of the program. Various programs and data stored in the storage 72 are copied to and temporarily stored in the memory 73.

The memory 73 is, for example, a volatile memory such as RAM.

Note that the control unit 71 executes the program by temporarily storing, in the memory 73, the program normally stored in the storage 72 and reading the program from the memory 73.

The communication unit 74 includes a receiver that receives data and a transmitter that transmits data.

The communication unit 74 performs communication with an external device by using the receiver and the transmitter.

The input unit 75 accepts an input from a user. The input unit 75 is, for example, a keyboard, mouse, touchpad, or touch panel having a display function.

Next, an example of functional structure of the supply facility operation plan generation device 7 according to the present embodiment is described.

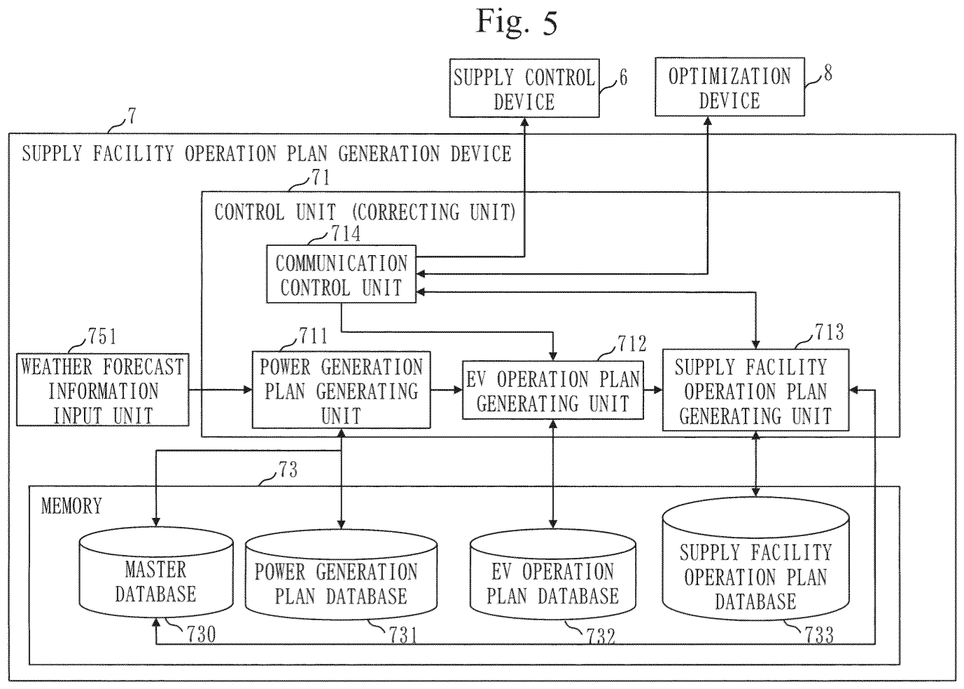

FIG. 5 depicts the example of functional structure of the supply facility operation plan generation device 7.

In FIG. 5, for example, by using the input unit 75, a weather forecast information input unit 751 receives an input of weather forecast information from a user of the supply facility operation plan generation device 7.

In the weather forecast information, a weather forecast in an area where the production facilities 1 are located is indicated. The weather forecast information is, for example, time-series data in which a weather forecast per hour is indicated.

The control unit 71 executes the supply facility operation plan generation program 721 depicted in FIG. 4.

FIG. 5 schematically depicts a state in which the control unit 71 is executing the supply facility operation plan generation program 721.

In the supply facility operation plan generation program 721, programs achieving the functions of a power generation plan generating unit 711, an EV operation plan generating unit 712, a supply facility operation plan generating unit 713, and a communication control unit 714 are included.

In the following, for simplification of description, executing, by the control unit 71, the programs achieving the functions of the power generation plan generating unit 711, the EV operation plan generating unit 712, the supply facility operation plan generating unit 713, and the communication control unit 714 is described as operation by the power generation plan generating unit 711, the EV operation plan generating unit 712, the supply facility operation plan generating unit 713, and the communication control unit 714.

Note that the power generation plan generating unit 711, the EV operation plan generating unit 712, the supply facility operation plan generating unit 713, and the communication control unit 714 to be executed by the control unit 71 each correspond to a “correcting unit”. Also, the process to be performed by the power generation plan generating unit 711, the EV operation plan generating unit 712, the supply facility operation plan generating unit 713, and the communication control unit 714 corresponds to “correcting process”.

The power generation plan generating unit 711 performs step S712 of FIG. 44 and step S722 of FIG. 45.

Specifically, the power generation plan generating unit 711 generates a PV power generation plan for each unit time based on the weather forecast information and renewable energy supply facility information. That is, the power generation plan generating unit 711 predicts, for example, a PV power generation amount in the upcoming week. The PV power generation amount is an amount of power generation by a photovoltaic power generation device (PV) included in the renewable energy supply facility 5. In the renewable energy supply facility information, power generation capability of the renewable energy supply facility 5 or the like is indicated. The renewable energy supply facility information is stored in advance in a master database 730. Details of the renewable energy supply facility information will be described further below.

The power generation plan generating unit 711 outputs PV power generation plan information in which the generated PV power generation plan is indicated to the EV operation plan generating unit 712.

Also, the power generation plan generating unit 711 causes the PV power generation plan information to be stored in a power generation plan database 731. As described above, the PV power generation plan information is information exemplarily depicted in FIG. 31.

Furthermore, when the i-th production facility operation plan information, the i-th utility facility operation plan information, and the i-th consumption resource information are received by the communication control unit 714, the power generation plan generating unit 711 generates an i-th proposal for correction of the PV power generation plan. Then, the power generation operation plan generating unit 711 outputs the i-th PV power generation plan information corresponding to the i-th proposal for correction of the PV power generation plan to the EV operation plan generating unit 712.

Also, the power generation plan generating unit 711 causes the i-th PV power generation plan information to be stored in the power generation plan database 731. Note that, as described above, the power generation plan generating unit 711 may omit generation of a proposal for correction of the i-th PV power generation plan.

The EV operation plan generating unit 712 performs step S713 of FIG. 44 and step S723 of FIG. 45.

Specifically, the EV operation plan generating unit 712 generates an EV operation plan. The EV operation plan is, for example, an operation plan of EV for the upcoming week. The EV is used to shuttle employees working at the production facilities 1.

The EV operation plan generating unit 712 generates an EV operation plan based on the production facility operation plan information and the utility facility operation plan information acquired from the optimization device 8 via the communication control unit 714.

The EV operation plan generating unit 712 outputs the PV power generation plan information and EV operation plan information in which the EV operation plan is indicated to the supply facility operation plan generating unit 713.

Also, the EV operation plan generating unit 712 causes the EV operation plan information to be stored in an EV operation plan database 732. As described above, the EV operation plan information is information exemplarily depicted in FIG. 32.

Furthermore, when the i-th production facility operation plan information, the i-th utility facility operation plan information, and the i-th consumption resource information are received by the communication control unit 714, the EV operation plan generating unit 712 generates an i-th proposal for correction of the EV operation plan. Then, the EV operation plan generating unit 712 outputs i-th EV operation plan information corresponding to the i-th proposal for correction of the EV operation plan to the supply facility operation plan generating unit 713. Also, the EV operation plan generating unit 712 causes the i-th EV operation plan information to be stored in the EV operation plan database 732.

The supply facility operation plan generating unit 713 performs step S715 of FIG. 44 and step S725 of FIG. 45.

Specifically, the supply facility operation plan generating unit 713 generates a supply facility operation plan based on the PV power generation plan information, the EV operation plan information, and the production facility operation plan information, the utility facility operation plan information, and the consumption resource information acquired from the optimization device 8 via the communication control unit 714.

The supply facility operation plan generating unit 713 causes supply facility operation plan information in which the supply facility operation plan is indicated to be stored in a supply facility operation plan database 733. As described above, the supply facility operation plan information is information exemplarily depicted in FIG. 35.

Furthermore, when the i-th new production facility operation plan information, the i-th utility facility operation plan information, and the i-th consumption resource information are received by the communication control unit 714, the supply facility operation plan generating unit 713 generates an i-th proposal for correction of the supply facility operation plan. Then, the supply facility operation plan generating unit 713 causes i-th supply facility operation plan information corresponding to the i-th proposal for correction of the supply facility operation plan to be stored in the supply facility operation plan database 733.

The communication control unit 714 performs communication between the supply control device 6 and the optimization device 8 by using the communication unit 74.

Specifically, the communication control unit 714 receives the production facility operation plan information, the utility facility operation plan information, and the consumption resource information from the optimization device 8. Then, the communication control unit 714 outputs the received production facility operation plan information and utility facility operation plan information to the EV operation plan generating unit 712. Also, the communication control unit 714 outputs the received production facility operation plan information, utility facility operation plan information, and consumption resource information to the supply facility operation plan generating unit 713.

Also, the communication control unit 714 reads the supply facility operation plan information from the supply facility operation plan database 733 via the supply facility operation plan generating unit 713. Then, the communication control unit 714 transmits the read supply facility operation plan information to the supply control device 6 and the optimization device 8.

Also, the communication control unit 714 receives i-th production facility operation plan information, i-th utility facility operation plan information, and i-th consumption resource information from the optimization device 8. The communication control unit 714 outputs the received i-th production facility operation plan information and i-th utility facility operation plan information to the EV operation plan generating unit 712. Also, the communication control unit 714 outputs the i-th production facility operation plan information, the i-th utility facility operation plan information, and the i-th consumption resource information to the supply facility operation plan generating unit 713.

Also, the communication control unit 714 reads i-th supply facility operation plan information from the supply facility operation plan database 733 via the supply facility operation plan generating unit 713. Then, the communication control unit 714 transmits the read i-th supply facility operation plan information to the optimization device 8.

### ***Details of Optimization Device 8***

Next, details of the optimization device 8 are described.

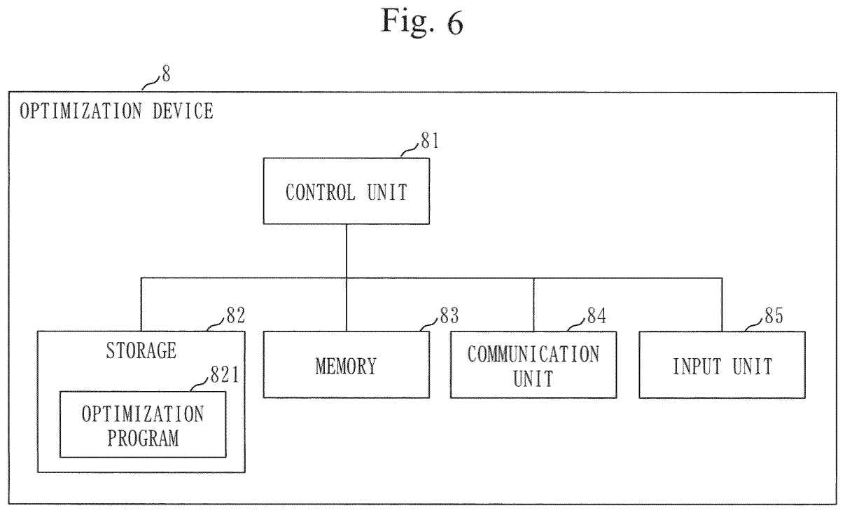

FIG. 6 depicts an example of hardware structure of the optimization device 8 according to Embodiment 1.

As depicted in FIG. 6, the optimization device 8 includes a control unit 81, a storage 82, a memory 83, a communication unit 84, and an input unit 85. Note that the optimization device 8 also includes a power supply, not depicted, serving as a motive power source.

The control unit 81 controls the optimization device 8.

The control unit 81 may be a processor such as CPU. Also, the control unit 81 may be an integrated circuit such as FPGA, LSI, or ASIC. Also, the control unit 81 may be a combination of a processor and an integrated circuit.

Note that the control unit 81, which is a superordinate concept of a processor and an integrated circuit, can be said as “processing circuitry”.

In the present embodiment, an example is described in which the control unit 81 is a processor that executes a program. That is, the control unit 81 executes an optimization program 821 stored in the storage 82. Details of the optimization program 821 are described further below.

The control unit 81 controls the storage 82, the memory 83, the communication unit 84 and the input unit 85, and executes the optimization program 821.

The storage 82 has stored therein various programs to be executed by the control unit 81, data to be referred to when the control unit 81 executes various programs, data generated as a result of execution of each program by the control unit 81, and so forth.

The storage 82 has stored therein, for example, the optimization program 821.

The storage 82 is, for example, a non-volatile memory such as flash memory, ROM, hard disk, solid-state drive, or memory card reader/writer.

The memory 83 is a storage device to be directly accessed by the control unit 81 when performing a process of the program. Various programs and data stored in the storage 82 are copied to and temporarily stored in the memory 83.

The memory 83 is, for example, a volatile memory such as RAM.

Note that the control unit 81 executes the program by temporarily storing, in the memory 83, the program normally stored in the storage 82 and reading the program from the memory 83.

The communication unit 84 includes a receiver that receives data and a transmitter that transmits data.

The communication unit 84 performs communication with an external device by using the receiver and the transmitter.

The input unit 85 accepts an input from a user. The input unit 85 is, for example, a keyboard, mouse, touchpad, or touch panel having a display function.

Next, an example of functional structure of the optimization device 8 according to the present embodiment is described.

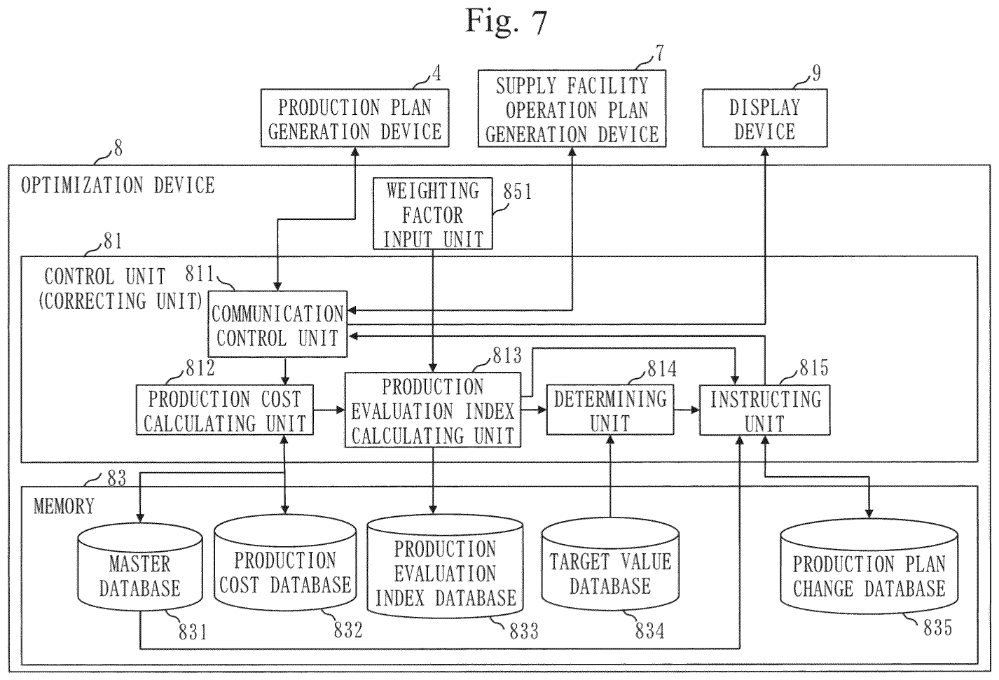

FIG. 7 depicts an example of functional structure of the optimization device 8.

In FIG. 7, for example, by using the input unit 85, a weighting factor input unit 851 receives an input of a weighting factor from a user of the optimization device 8.

The weighting factor is used for calculation of a production evaluation index.

The control unit 81 executes the optimization program 821 depicted in FIG. 6.

FIG. 7 schematically depicts a state in which the control unit 81 is executing the optimization program 821.

In the optimization program 821, programs achieving the functions of a communication control unit 811, a production cost calculating unit 812, a production evaluation index calculating unit 813, a determining unit 814, and the instructing unit 815 are included.

In the following, for simplification of description, executing, by the control unit 81, the programs achieving the functions of the communication control unit 811, the production cost calculating unit 812, the production evaluation index calculating unit 813, the determining unit 814, and the instructing unit 815 is described as operation by the communication control unit 811, the production cost calculating unit 812, the production evaluation index calculating unit 813, the determining unit 814, and the instructing unit 815.

Note that the process to be performed by the determining unit 814 corresponds to “determining process”.

Also, the communication control unit 811, the production cost calculating unit 812, the production evaluation index calculating unit 813, and the instructing unit 815 to be executed by the control unit 81 each correspond to a “correcting unit”. Also, the process to be performed by the communication control unit 811, the production cost calculating unit 812, the production evaluation index calculating unit 813, and the instructing unit 815 corresponds to “correcting process”.

The production cost calculating unit 812 performs step S813 of FIG. 44 and step S823 of FIG. 45.

Specifically, the production cost calculating unit 812 calculates a production cost based on the production facility operation plan information, the utility facility operation plan information, the consumption resource information, the environmental load information, and the supply facility operation plan information.

The production cost calculating unit 812 calculates a production cost for each of expense items such as a power purchase cost, a labor cost, an environmental load cost, and so forth.

The production cost calculating unit 812 outputs production cost information in which the production cost is indicated for each expense item to the production evaluation index calculating unit 813.

Also, the production cost calculating unit 812 causes the production cost information to be stored in a production cost database 832. Also, the production cost calculating unit 812 causes the production facility operation plan information, the utility facility operation plan information, the consumption resource information, the environmental load information, and the supply facility operation plan information to be stored in a master database 831.

The production evaluation index calculating unit 813 performs step S814 of FIG. 44 and step S824 of FIG. 45.

Specifically, the production evaluation index calculating unit 813 calculates a production evaluation index, which is an index value of the production cost.

The production evaluation index calculating unit 813 acquires the weighting factor from the weighting factor input unit 851. Then, for each expense item of the production cost, the production evaluation index calculating unit 813 multiplies the amount of cost by its corresponding weighting factor. Then, the production evaluation index calculating unit 813 sums multiplication values for each expense item to acquire a production evaluation index.

The production evaluation index calculating unit 813 outputs production evaluation index information in which the production evaluation index is indicated to the determining unit 814.

Also, the production evaluation index calculating unit 813 causes the production evaluation index information to be stored in a production evaluation index database 833.

The determining unit 814 performs step S815 of FIG. 44 and step S825 of FIG. 45.

That is, the determining unit 814 determines whether the production evaluation index indicated in the production evaluation index information matches a target value.

The determining unit 814 acquires target value information in which the target value is indicated from a target value database 834.

Then, the determining unit 814 determines whether the production evaluation index indicated in the production evaluation index information matches the target value indicated in the target value information.

The determining unit 814 outputs determination result information indicating the production evaluation index information and the determination result to the instructing unit 815.

The instructing unit 815 performs step S816 or step S817 of FIG. 44 and step S826 of FIG. 45.

Specifically, when the production evaluation index matches the target value as a result of determination at the determining unit 814, the instructing unit 815 determines that correction of the production plan is not required. When determining that correction of the production plan is not required, the instructing unit 815 approves the production plan generated by the production plan generation device 4.

When approving the production plan, the instructing unit 815 reads the production facility operation plan information from the master database 831. Then, the instructing unit 815 outputs the read production facility operation plan information to the communication control unit 811.

On the other hand, when the production evaluation index does not match the target value, the instructing unit 815 determines that correction of the production plan is required.

Then, when determining that correction of the production plan is required, the instructing unit 815 outputs a correction proposal generation instruction to the communication control unit 811 to cause the production plan generation device 4 to generate a proposal for correction of the production plan.

The correction proposal generation instruction includes a change parameter to be reflected on the correction proposal.

The communication control unit 811 receives the production facility operation plan information, the utility facility operation plan information, the consumption resource information, and the environmental load information from the production plan generation device 4. The communication control unit 811 outputs the received production facility operation plan information, utility facility operation plan information, consumption resource information, and environmental load information to the production cost calculating unit 812.

Also, the communication control unit 811 transmits the production facility operation plan information, the utility facility operation plan information, and the consumption resource information to the supply facility operation plan generation device 7.

Also, the communication control unit 811 receives the supply facility operation plan information from the supply facility operation plan generation device 7. The communication control unit 811 outputs the received supply facility operation plan information to the production cost calculating unit 812.

Also, when it is determined by the instructing unit 815 that correction of the production plan is not required, the communication control unit 811 transmits the production facility operation plan information to the display device 9.

Also, the communication control unit 811 transmits a correction proposal generation instruction from the instructing unit 815 to the production plan generation device 4.

Furthermore, the communication control unit 811 receives i-th production facility operation plan information, i-th utility facility operation plan information, i-th consumption resource information, and i-th environmental load information from the production plan generation device 4.

The communication control unit 811 outputs the received i-th production facility operation plan information, i-th utility facility operation plan information, i-th consumption resource information, and i-th environmental load information to the production cost calculating unit 812.

Also, the communication control unit 811 transmits the i-th production facility operation plan information, the i-th utility facility operation plan information, and the i-th consumption resource information to the supply facility operation plan generation device 7.

Also, the communication control unit 811 receives i-th supply facility operation plan information from the supply facility operation plan generation device 7. The communication control unit 811 outputs the received i-th supply facility operation plan information to the production cost calculating unit 812.

When the i-th production facility operation plan information, the i-th utility facility operation plan information, the i-th consumption resource information, and the i-th environmental load information are received by the communication control unit 811, the production cost calculating unit 812 calculates an i-th production cost based on the i-th production facility operation plan information, the i-th utility facility operation plan information, the i-th consumption resource information, and the i-th environmental load information.

Then, the production cost calculating unit 812 outputs i-th production cost information in which the i-th production cost is indicated to the production evaluation index calculating unit 813.

Also, the production cost calculating unit 812 causes the i-th production cost information to be stored in the production cost database 832.

Also, the production cost calculating unit 812 causes the i-th production facility operation plan information, the i-th utility facility operation plan information, the i-th consumption resource information, the i-th environmental load information, and the i-th supply facility operation plan information to be stored in the master database 831.

Then, the production evaluation index calculating unit 813 calculates an i-th production evaluation index, which is an index value of the i-th production cost.

Furthermore, the production evaluation index calculating unit 813 outputs i-th production evaluation index information in which the i-th production evaluation index is indicated to the instructing unit 815.

Also, the production evaluation index calculating unit 813 causes the i-th production evaluation index information to be stored in the production evaluation index database 833.

Also, when acquiring i-th production evaluation index information from the production evaluation index calculating unit 813, the instructing unit 815 causes the acquired i-th production evaluation index information to be stored in a production plan change database 835.

Also, the instructing unit 815 determines whether all proposals for correction of the production plan have been tested, every time it acquires i-th production evaluation index information. That is, the instructing unit 815 determines whether N pieces of new production evaluation index information for N correction proposals have been acquired. Specifically, the instructing unit 815 determines whether a value i, which is a correction proposal number, matches N. Note that it is assumed that the instructing unit 815 has been notified by the production plan generating unit 411 that the total number of correction proposals is N.

If not all correction proposals have been tested, the instructing unit 815 waits for acquisition of new production evaluation index information for the next correction proposal.

On the other hand, if all correction proposals have been tested, the instructing unit 815 selects production evaluation index information with a minimum production evaluation index.

Then, the instructing unit 815 reads production facility operation plan information in which the same correction proposal number as that of the selected production evaluation index information is set from the master database 831. Then, the instructing unit 815 outputs the read production facility operation plan information to the communication control unit 811.

The communication control unit 811 transmits the production facility operation plan information acquired from the instructing unit 815 to the display device 9.

### ***Description of Specific Example of Information and Operation***

Next, an operation example is described by using a specific example of information for use in the present embodiment.

Note that it is assumed in the following description that the utility facility 3 is a compressed-air supply facility and water reuse facility.

The compressed-air supply facility supplies compressed air as a resource to the production facilities 1.

Also, the water reuse facility supplies water as a resource to the production facilities 1. Furthermore, for reuse, the water reuse facility purifies water once used.

### ***Description of Specific Example of Information for Use in Production Plan Generation Device 4 and Operation of Production Plan Generation Device 4***

First, information for use in the production plan generation device 4 is described.

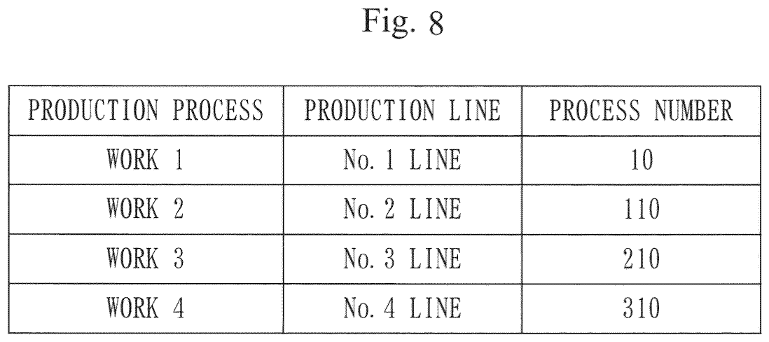

FIG. 8 to FIG. 12 and FIG. 14 to FIG. 20 depict examples of production facility information.

In the production facility information, process information, productivity information, process operation information, facility operation information, calculation time information, calculation unit time information, production resource information, and environmental load information are included.

The process information indicates a production process of producing articles.

The productivity information indicates production time per article in each production process.

The process operation information indicates facility operation included in each production process.

The facility operation information indicates time required for facility operation.

The calculation time information indicates operable time of each production facility 1 for use in calculation.

The calculation unit time information indicates calculation unit time.

The production resource information indicates a resource to be consumed in each production process.

The environmental load information indicates an environmental load substance emitted from each production process and a resource to be consumed to reduce the environmental load substance.

Note that it is assumed that the production facility information is acquired from the production facilities 1 and stored in the master database 431 before the production facility operation plan generating unit 412 generates a production facility operation plan. In place of this, when the production facility operation plan generating unit 412 generates a production facility operation plan, the production facility operation plan generating unit 412 may acquire the production facility information from the production facilities 1 by using the communication control unit 413.

FIG. 8 depicts an example of process information.

The process information of FIG. 8 is master data of the production process for models A, B, C, and D. Each of the models A, B, C, and D is an article.

As depicted in FIG. 8, the process information is configured of production process, production line, and process number.

In the item of production process, a process for production (production process) is indicated.

In the item of production line, a production line to which each production process belongs is indicated.

In the item of process number, a sequence of the process is indicated. A production process with a small value of the process number is an upstream process, and a process with a large value of the process number is a downstream process. Here, work indicates a work process of working on a material to make a component. In FIG. 8, for simplification of description, only a work process is indicated in the item of production process. In the item of production process, in addition to the work process, an assembling process, an inspection process, and so forth may be included. The assembling process is a process of assembling components as an article. The inspection process is a process of inspecting whether the quality of a produced article satisfies criteria.

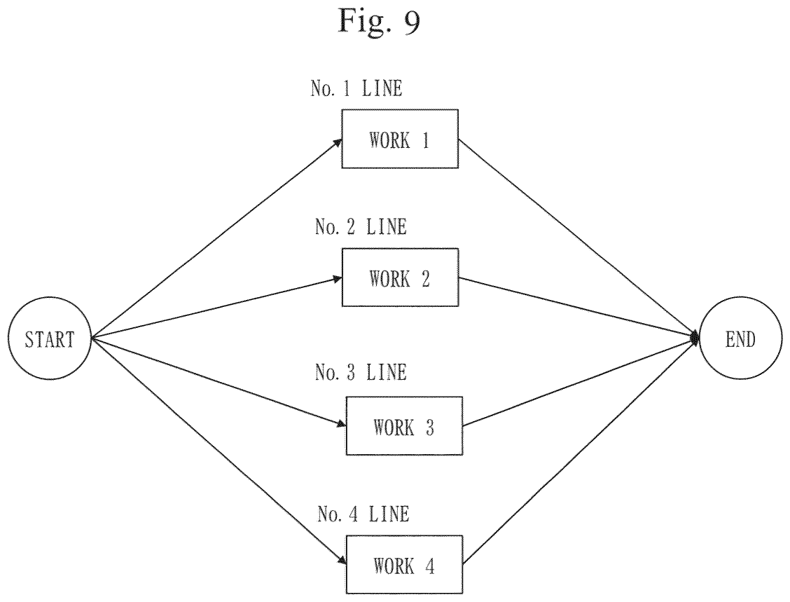

FIG. 9 depicts a sequence of a production process.

FIG. 9 indicates master data of the production process of the models A, B, C, and D as a flow. The production process of the models A, B, C, and D starts and goes through work processes on four different lines and then ends.

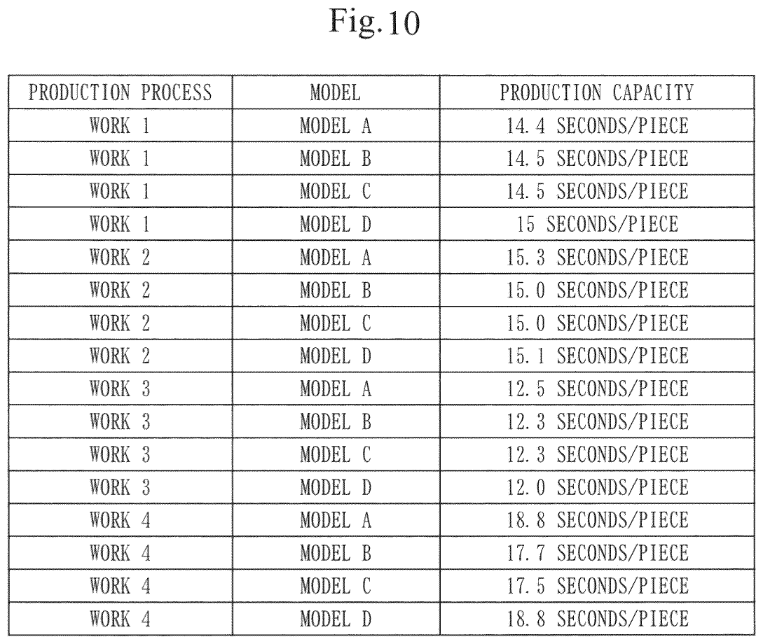

FIG. 10 depicts an example of productivity information.

As depicted in FIG. 10, the productivity information is configured of production process, model, and production capacity.

In the item of production process, each production process indicated in the item of production process of FIG. 8 is indicated. In the item of model, an article to be produced is indicated. In the item of production capacity, processing time required per article in each production process is indicated.

In the example of FIG. 10, a work 1 process for the model A has a production capacity of 14.4 seconds/piece. A work 2 process for the model A has a production capacity of 15.3 seconds/piece. A work 3 process for the model A has a production capacity of 12.5 seconds/piece. A work 4 process for the model A has a production capacity of 18.8 seconds/piece.

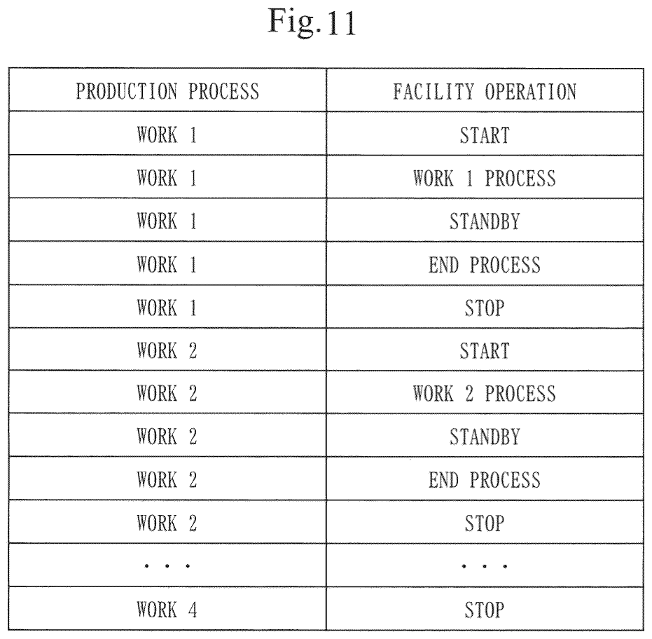

FIG. 11 depicts an example of process operation information.

As depicted in FIG. 11, the process operation information is configured of production process and facility operation.

In the item of production process, each production process indicated in the item of production process of FIG. 8 is indicated. In the item of facility operation, the operation of each production facility 1 is indicated.

In the facility operation, start is an operation for starting the production facility 1. Work process is an operation of the production facility 1 to work on an article. Assembling process is an operation of the production facility 1 to assemble an article. Inspection process is an operation of the production facility 1 to inspect an article. Standby is an operation for causing the production facility 1 to become in a standby state. End process is an operation to be performed by the production facility 1 to end the process of the production process. Stop is an operation for causing the production facility 1 to stop.

Note that depiction is partially omitted in FIG. 11 for a reason in graphical representation.

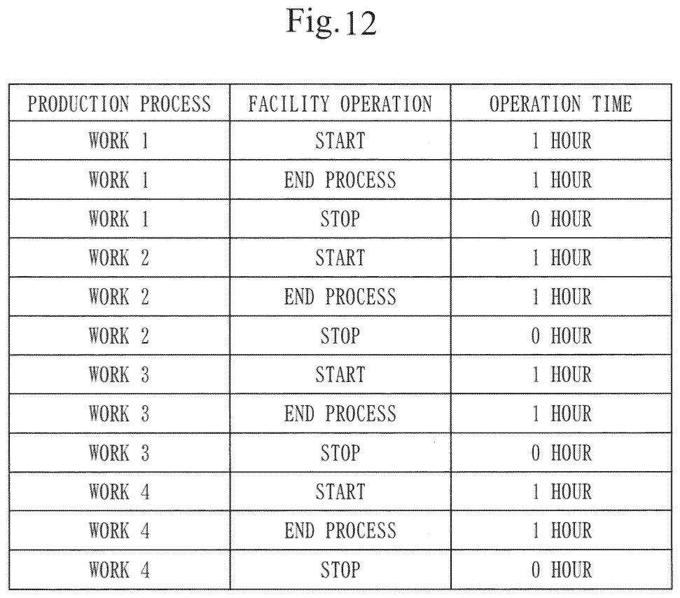

FIG. 12 depicts an example of facility operation information.

As depicted in FIG. 12, the facility operation information is configured of production process, facility operation, and operation time.

In the item of production process, each production process indicated in the item of production process of FIG. 8 is indicated. In the item of facility operation, the facility operation indicated in the item of facility operation of FIG. 11 is indicated. In the item of operation time, time required for each facility operation is indicated.

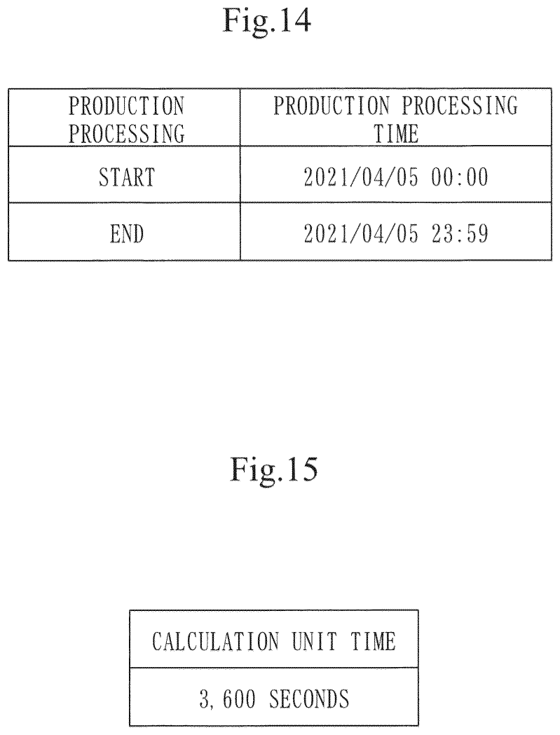

FIG. 14 depicts an example of calculation time information.

As depicted in FIG. 14, the calculation time information is configured of production processing and production processing time.

In the item of production processing, start or end of the production process is indicated. In the item of production processing time, a start time or end time of the production process is indicated.

FIG. 15 depicts an example of calculation unit time information.

As depicted in FIG. 15, the calculation unit time information is configured of an item of calculation unit time.

In the item of calculation unit time, a unit time for the production facility operation plan generating unit 412 to calculate a process state of the production process in the production facility 1 is indicated. The production facility operation plan generating unit 412 generates a production facility operation plan for each calculation unit time.

The production facility operation plan generating unit 412 generates a production facility operation plan for each 3,600 seconds, as depicted in FIG. 15. Note that the calculation unit time may be any time other than 3,600 seconds. For example, the calculation unit time may be 7,200 seconds, 10,800 seconds, or the like.

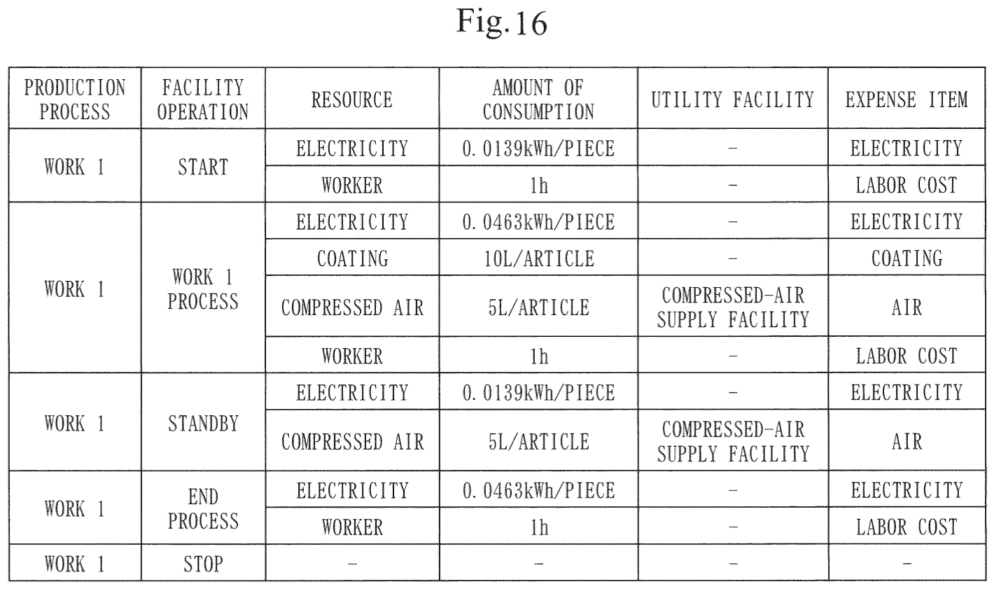

FIG. 16 to FIG. 19 each depicts an example of production resource information in each production process.

FIG. 16 depicts an example of production resource information in work 1 process.

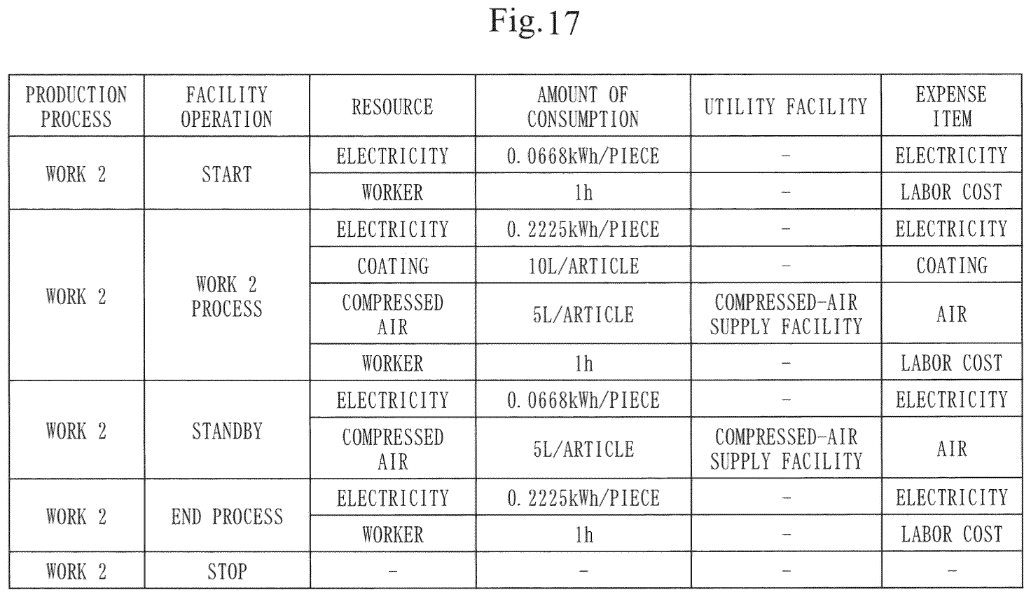

FIG. 17 depicts an example of production resource information in work 2 process.

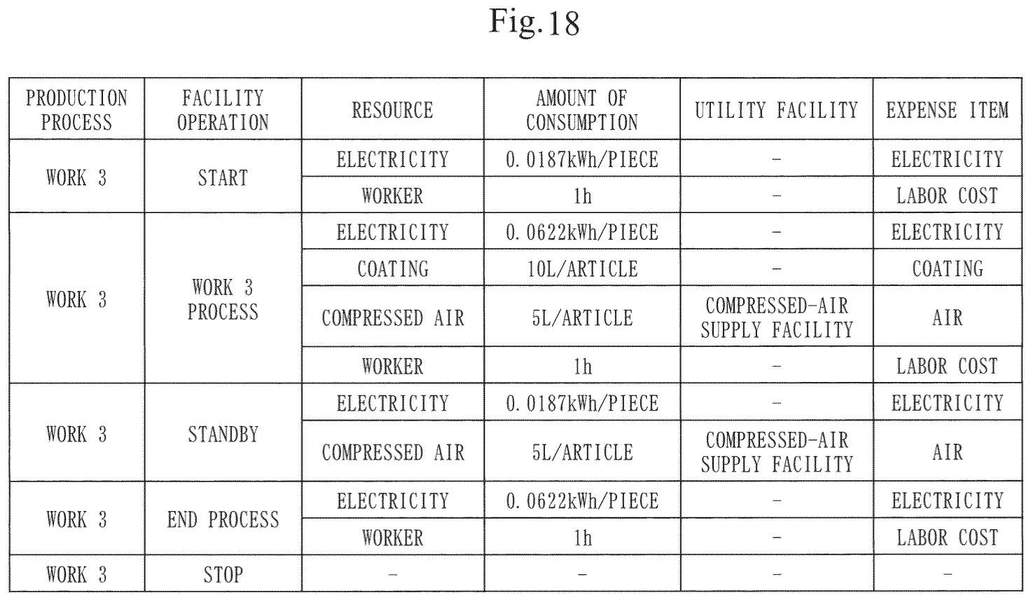

FIG. 18 depicts an example of production resource information in work 3 process.

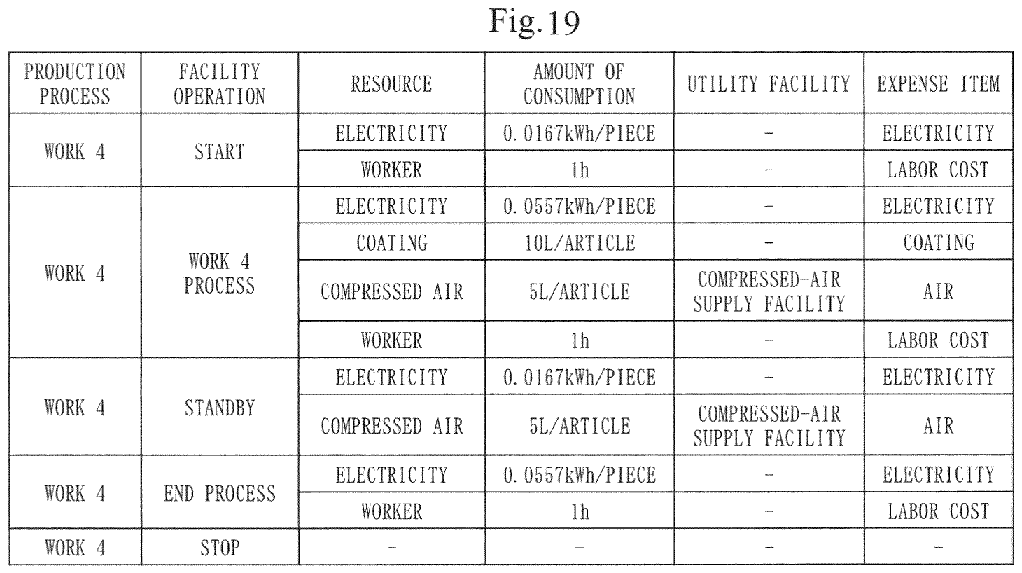

FIG. 19 depicts an example of production resource information in work 4 process.

As depicted in FIG. 16 to FIG. 19, the production resource information is configured of production process, facility operation, resource, amount of consumption, utility facility, and expense item.

In the item of production process, each production process indicated in the item of production process of FIG. 8 is indicated. In the item of facility operation, the facility operation indicated in the item of facility operation of FIG. 12 is indicated. In the item of resource, a resource for use in the facility operation indicated in the item of facility operation is indicated. In the item of amount of consumption, the amount of consumption of a resource is indicated. In the item of utility facility, the utility facility 3 as a resource supply source is indicated. In the item of expense item, a name in resource cost administration is indicated.

For example, in FIG. 16, for start of the work 1, electricity and worker are used as resources. And, the amount of consumption of electricity is 0.0139 kWh/piece. Also, the amount of consumption of worker is 1 h. And, the expense item of electricity is electricity, and the expense item of worker is labor cost.

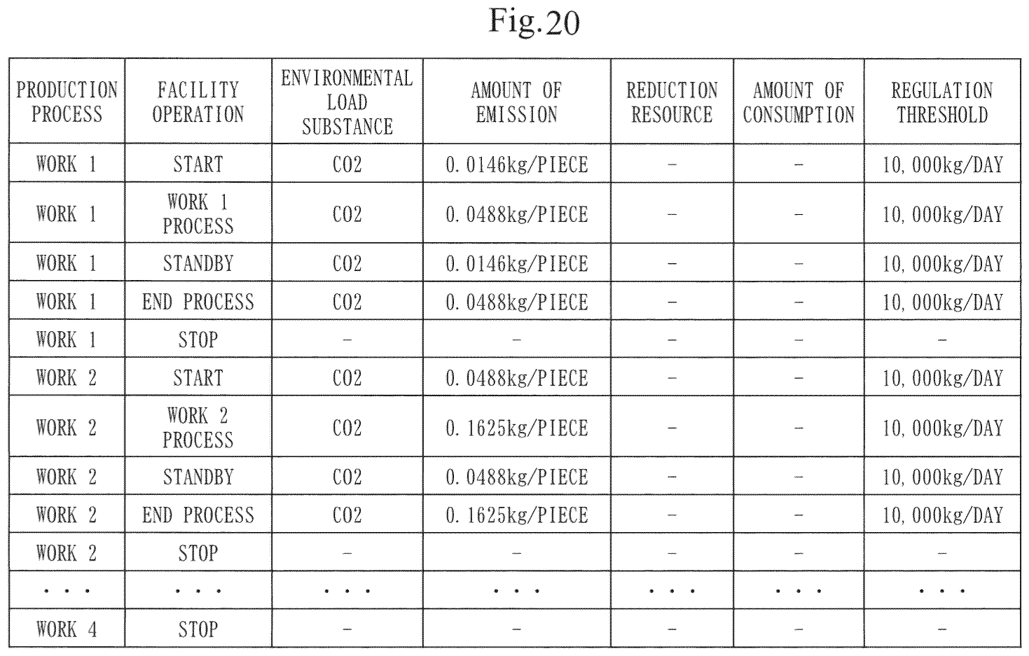

FIG. 20 depicts an example of environmental load information at each production process.

FIG. 20 depicts an example of the environmental load information in work 1 to work 4 processes. Note that depiction is partially omitted in FIG. 20 for a reason in graphical representation.

As depicted in FIG. 20, the environmental load information is configured of production process, facility operation, environmental load substance, amount of emission, reduction resource, amount of consumption, and regulation threshold.

In the item of production process, each production process indicated in the item of production process of FIG. 8 is indicated. In the item of facility operation, the facility operation indicated in the item of facility operation of FIG. 12 is indicated. In the item of environmental load substance, a substance as a cause of environmental load is indicated. In the item of amount of emission, the amount of emission of the environmental load substance is indicated. In the item of reduction resource, a reduction resource for use to reduce emission of the environmental load substance is indicated. In the item of amount of consumption, the amount of consumption of the reduction resource is indicated. In the item of regulation threshold, a regulation upper limit of the amount of emission of the environmental load substance is indicated.

FIG. 13 depicts an example of production plan information to be generated by the production plan generating unit 411.

As depicted in FIG. 13, the production plan information is configured of target model, production process, production start time, production delivery time, and production quantity.

In the item of target model, a model to be produced is indicated. In the item of production process, each production process indicated in the item of production process of FIG. 8 is indicated. In the item of production start time, time when each production process starts is indicated. In the item of production delivery time, completion limit time of production of a target model article is indicated. In the item of production quantity, the production quantity of the target model is indicated.

The production plan generating unit 411 generates production plan information based on order data and production facility information (FIG. 8 to FIG. 12, FIG. 14 to FIG. 20).

FIG. 21 depicts an example of production facility operation plan information to be generated by the production facility operation plan generating unit 412.

Depiction is partially omitted in FIG. 21 for a reason in graphical representation.

The production facility operation plan information of FIG. 21 is configured of operation time, production model in each work process, production quantity, and facility operation.

In the item of operation time, time for each unit time depicted in FIG. 15 is indicated.

In the item of production model, a model name of a model to be produced at the production facility 1 in a unit time starting from the operation time indicated in the same row is indicated.

In the item of production quantity, production quantity of the model to be produced at the production facility 1 in the unit time starting from the operation time indicated in the same row is indicated.

In the item of facility operation, operation to be performed by the production facility 1 in the unit time starting from the operation time indicated in the same row is indicated.

The production facility operation plan generating unit 412 generates the production facility operation plan information depicted in FIG. 21 based on the production plan information (FIG. 13) and the production facility information (FIG. 8 to FIG. 12, FIG. 14 to FIG. 20).

Specifically, for each production process indicated in the process information of FIG. 8, the production facility operation plan generating unit 412 generates the production facility operation plan information of FIG. 21 based on the facility operation information of FIG. 12, the productivity information of FIG. 10, the process operation information of FIG. 11, and the production plan information of FIG. 13.

Here, an example is described in which the production facility operation plan generating unit 412 generates the production facility operation plan information of FIG. 21 for “work 1” of FIG. 8.

Note that it is assumed in the present embodiment that time taken for transportation of a produced article between production processes is included in the time of production processing in each production process. It is also assumed that transportation of a produced article between production processes is performed at every hour. Furthermore, it is assumed that the produced article produced at each production process is transported to the next production process.

The production facility operation plan generating unit 412 acquires, from the process operation information of FIG. 11, “start”, “work 1 process”, “standby”, “end process”, and “stop”, as facility operation for “work 1”.

For “work 1”, from the facility operation information of FIG. 12, the production facility operation plan generating unit 412 acquires “1 hour” as start operation time, acquires “1 hour” as end process operation time, and acquires “0 hour” as a stop operation time.

Also, for “work 1”, from the productivity information of FIG. 10, the production facility operation plan generating unit 412 acquires “article A” as an article and “14.4 seconds/piece” as production capacity.

Also, for “model A” and “work 1”, from the production plan information of FIG. 13, the production facility operation plan generating unit 412 acquires “2021/04/05 09:00” as production start time and “6,000 pieces” as production quantity.

Then, since “1 hour” is required as start operation time and the production start time is “2021/04/05 09:00” for “work 1”, the production facility operation plan generating unit 412 decides that start of “work 1” starts at “2021/04/05 08:00”. Also, since the production quantity of “article A” is “6,000 pieces” and the production capacity of “article A” is “14.4 seconds/piece”, the production facility operation plan generating unit 412 determines that 24 hours are required for “work 1 process” of “work 1” (6,000 pieces×14.4 seconds=3,600 seconds=24 hours). Thus, the production facility operation plan generating unit 412 determines that work process for 250 pieces (6,000 pieces: 24 hours=250 pieces) is performed per hour. Also, the production facility operation plan generating unit 412 determines that “work 1” is completed at “2021/04/06 9:00”, which is after 24 hours from “2021/04/05 09:00”. With this, it is revealed that each “work 1 production quantity” from “2021/04/05 09:00” to “2021/04/06 08:00” in FIG. 21 is “250 pieces”. Note that “2021/04/06 09:00”, which is completion time of “work 1”, is within a range of “2021/04/06 09:30”, which is “production delivery time” in the production plan information of FIG. 13.

The production facility operation plan generating unit 412 determines that “end process” of “work 1” starts at “2021/04/06 09:00”.

Furthermore, since “1 hour” is required as operation time of end process for “work 1”, the production facility operation plan generating unit 412 determines that “stop” of “work 1” is performed at “2021/04/06 10:00”.

The production facility operation plan generating unit 412 performs similar process also for “work 2”, “work 3”, and “work 4”.

The production facility operation plan generating unit 412 sets the values acquired from the above-described procedure in the production facility operation plan information of FIG. 21.

With the above-described procedure, the production facility operation plan generating unit 412 generates the production facility operation plan information of FIG. 21.

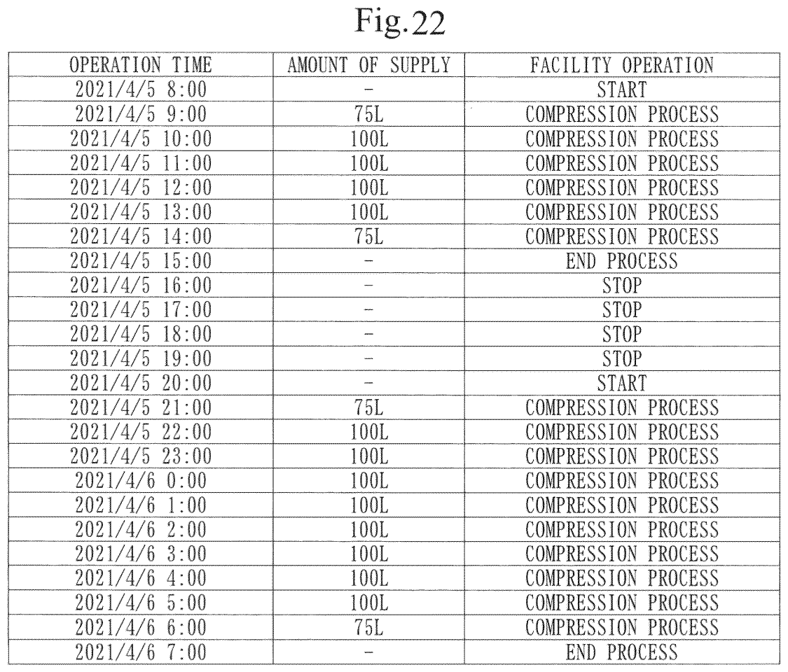

Next, utility facility information is described by using FIG. 22 to FIG. 24.

The utility facility information is configured of utility facility operation schedule information and utility resource information.

The utility facility operation schedule information indicates an operation schedule of the utility facility 3.

The utility resource information indicates a resource to be consumed at the utility facility 3.

Note that it is assumed that the utility facility information (utility facility operation schedule information, supply resource information) is acquired from the utility facility 3 and stored in the master database 431 before the resource load calculating unit 415 generates a utility facility operation plan. In place of this, when the resource load calculating unit 415 generates a utility facility operation plan, the utility facility operation plan generating unit 414 may acquire the utility facility information from the utility facility 3 by using the communication control unit 413.

FIG. 22 depicts an example of utility facility operation schedule information.

More specifically, FIG. 22 depicts an example of utility facility operation schedule information of a compressed-air supply facility.

As depicted in FIG. 22, the utility facility operation schedule information is configured of operation time, amount of supply, and facility operation.

In the item of operation time, the same time as that of the item of operation time of FIG. 21 is indicated.

In the item of amount of supply, the amount of compressed air to be supplied from the utility facility 3 to the production facility 1 in a unit time starting from the operation time indicated in the same row is indicated.

In the item of facility operation, operation to be performed by the utility facility 3 in the unit time starting from the operation time indicated in the same row is indicated.

“Compression process” indicated in the item of facility operation is an operation for compressing air for supply to the production facility 1.

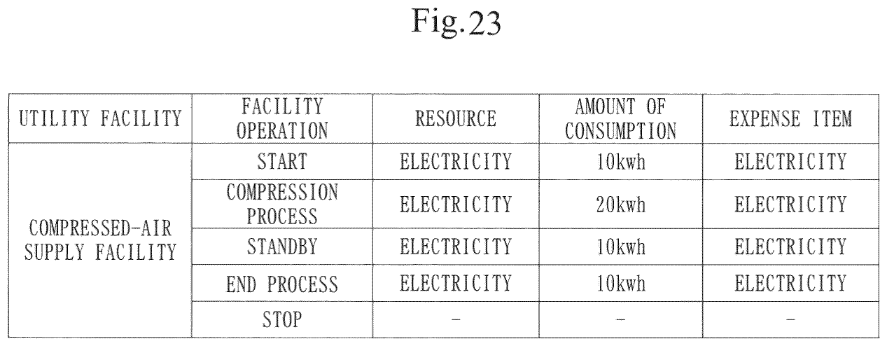

FIG. 23 depicts an example of utility resource information.

More specifically, FIG. 23 depicts an example of utility resource information of the compressed-air supply facility.

As depicted in FIG. 23, utility resource information is configured of utility facility, facility operation, resource, amount of consumption, and expense item.

In the item of utility facility, the name of the utility facility 3 is indicated.

In the item of facility operation, the facility operation indicated in the section of facility operation of FIG. 22 is indicated.

In the item of resource, a resource to be consumed at the utility facility 3 when the facility operation is performed is indicated.

In the item of amount of consumption, the amount of resource to be consumed at the utility facility 3 when the facility operation is performed is indicated.

In the item of expense item, the name in resource cost administration is indicated.

Here, compressed air is not described as a resource because compressed air is a resource that does not incur cost, that is, has no expense item, and it is therefore not required to consider the amount of consumption.

FIG. 24 depicts an example of utility facility operation plan information to be generated by the utility facility operation plan generating unit 414.

More specifically, FIG. 24 depicts an example of utility facility operation plan information of the compressed-air supply facility.

As depicted in FIG. 24, the utility facility operation plan information is configured of utility facility, operation time, amount of supply, facility operation, and utility facility resource.

In the item of utility facility, the utility facility indicated in the item of utility facility of FIG. 23 is indicated.

In the item of operation time, the operation time indicated in the item of operation time of FIG. 22 is indicated.

In the item of amount of supply, the amount of supply indicated in the item of amount of supply of FIG. 22 is indicated.

In the item of facility operation, the facility operation indicated in the item of facility operation of FIG. 22 is indicated.

In the item of utility facility resource, the resource indicated in the item of resource and the amount of consumption indicated in the item of amount of consumption of FIG. 23 are indicated.

FIG. 25 depicts an example of consumption resource information and

environmental load information to be generated by the resource load calculating unit 415.

In FIG. 25, the consumption resource information and the environmental load information are unified. Unlike FIG. 25, each of the consumption resource information and the environmental load information may be a different piece of information.

In FIG. 25, values indicated in the item of operation time and the item of consumption resource correspond to the consumption resource information. Also, values in the item of operation time and the item of environmental load correspond to the environmental load information.

Note that depiction is partially omitted in FIG. 25 for a reason in graphical representation.

In FIG. 25, in the item of operation time, the same time as that in the item of operation time of FIG. 21 is indicated.

In the item of consumption resource, a resource amount to be consumed in each work process and a total resource amount in all work processes are indicated. Specifically, the item of consumption resource is configured of amount of power consumption in each work process, a total value of amounts of power consumption, amount of compressed air in each work process, a total value of amounts of compressed air, labor hour in each work process, and a total value of labor hours.

In the item of environmental load, an amount of environmental load emission in each work process and a total value of amounts of environmental load emission are indicated. Specifically, the item of environmental load is configured of an amount of CO2 emission in each work process and a total amount of CO2 emission.

Also, based on the production resource information of FIG. 16 to FIG. 19 and the environmental load information of FIG. 20, the resource load calculating unit 415 generates the consumption resource information (item of consumption resource) and the environmental load information (item of environmental load) of FIG. 25.

Also here, an example is described in which the resource load calculating unit 415 generates the consumption resource information and the environmental load information of FIG. 25 for “work 1” of FIG. 8.

For “work 1”, from the production resource information of FIG. 16, the resource load calculating unit 415 acquires, for each facility operation, the value described in the item of resource, the value described in the item of amount of consumption, and the value described in the item of expense item.

Then, by using the values acquired from the production resource information of FIG. 16, the resource load calculating unit 415 generates values of the consumption resource information (item of consumption resource) of FIG. 25.

Here, a procedure of deriving a value of “work 1 amount of power consumption” of FIG. 25 is described.

For each operation time of the production facility operation plan information of FIG. 21, the resource load calculating unit 415 extracts the value of “work 1 facility operation” of FIG. 21.

Also, in “facility operation” of FIG. 16, the resource load calculating unit 415 extracts the row in which a value corresponding to the extracted value is described.

Furthermore, the resource load calculating unit 415 extracts the value of “amount of consumption” for “electricity” described in the extracted row.

Next, the resource load calculating unit 415 multiplies the extracted value of “amount of consumption” by the value of “work 1 production quantity” of FIG. 21.

Furthermore, the resource load calculating unit 415 extracts the value of “utility facility resource” at the same operation time as that of the utility facility operation plan information of FIG. 24.

Then, the resource load calculating unit 415 sets an addition value of the multiplication value and the extracted value of “utility facility resource” in “work 1 amount of power consumption” at the same operation time in FIG. 25.

For example, for “2021/04/05 09:00” in FIG. 21, the resource load calculating unit 415 multiplies the value (“0.0463”) of “amount of consumption” of “electricity” of “work 1 process” of “work 1” in FIG. 16 by the value (“250”) of “work 1 production quantity” in FIG. 21. Also, the resource load calculating unit 415 adds the value (“20 kwh”) of “utility facility resource” of “2021/04/05 09:00” in FIG. 24 to the multiplication value. Then, the resource load calculating unit 415 sets the addition value in “work 1 amount of power consumption” of “2021/04/05 09:00” in FIG. 25.

The resource load calculating unit 415 performs similar process also for “work 2”, “work 3”, and “work 4”.

Then, for each operation time, the resource load calculating unit 415 sums amounts of power consumption of “work 1”, “work 2”, “work 3”, and “work 4”. Furthermore, the resource load calculating unit 415 sets the total value in the item of “total amount of power consumption” of FIG. 25.

The resource load calculating unit 415 performs similar operation also on the amount of compressed air and the labor hour.

Furthermore, for “work 1”, the resource load calculating unit 415 acquires, for each facility operation, the value in the item of “environmental load substance”, the value in the item of “amount of emission”, the value in the item of “reduction resource”, and the value in the item of “amount of consumption” from the environmental load information of FIG. 20.

Also, by using the values acquired from the environmental load information of FIG. 20, the resource load calculating unit 415 generates a value of the environmental load information (item of environmental load) of FIG. 25.

Here, a procedure of deriving a value of “work 1 amount of CO2 emission” of FIG. 25 is described.

For each operation time of the production facility operation plan information of FIG. 21, the resource load calculating unit 415 extracts the value of “work 1 facility operation” of FIG. 21.

Also, in “facility operation” of FIG. 20, the resource load calculating unit 415 extracts the row in which a value corresponding to the extracted value is described.

Furthermore, the resource load calculating unit 415 extracts the value of “amount of emission” described in the extracted row.

Next, the resource load calculating unit 415 multiplies the extracted value of “amount of emission” by the value of “work 1 production quantity” of FIG. 21.

Then, the resource load calculating unit 415 sets the multiplication value in “work 1 amount of CO2 emission” at the same operation time in FIG. 25.

For example, for “2021/04/05 09:00” in FIG. 21, the value (“0.0488”) of “amount of emission” of “work 1 process” of “work 1” in FIG. 20 is multiplied by the value (“250”) of “work 1 production quantity” in FIG. 21. Then, the resource load calculating unit 415 sets the multiplication value in “work 1 amount of CO2 emission” of “2021/04/05 09:00” in FIG. 25.

The resource load calculating unit 415 performs similar process also for “work 2”, “work 3”, and “work 4”.

Then, for each operation time, the resource load calculating unit 415 sums amounts of CO2 emission of “work 1”, “work 2”, “work 3”, and “work 4”. Furthermore, the resource load calculating unit 415 sets the total value in the item of “total amount of CO2 emission” of FIG. 25.

### ***Description of Specific Example of Information for Use in Supply Facility Operation Plan Generation Device 7 and Operation of Supply Facility Operation Plan Generation Device 7***

Next, information for use in the supply facility operation plan generation device 7 is described.

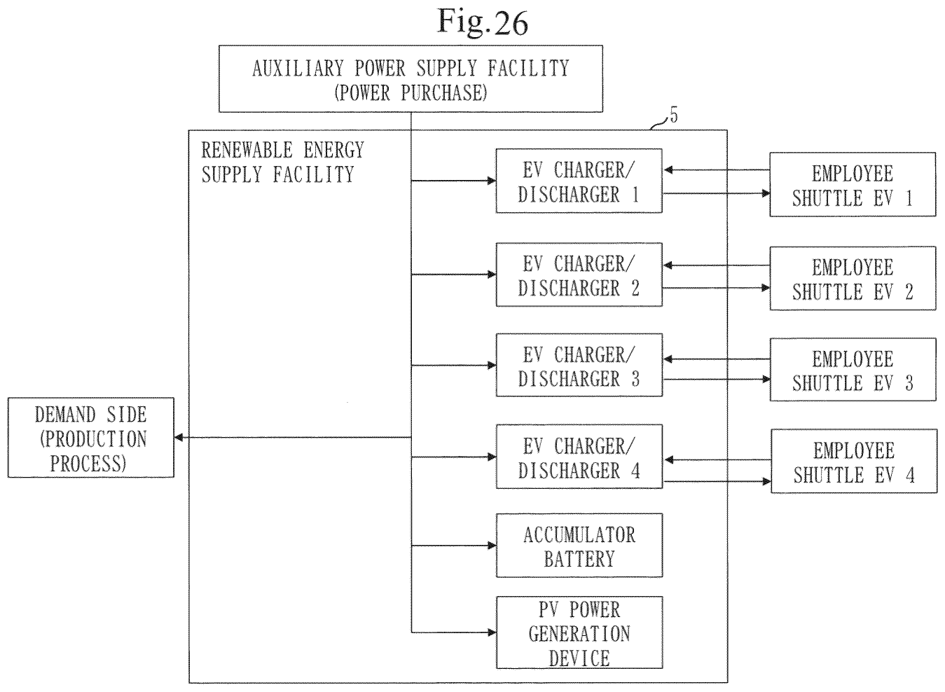

In the present embodiment, it is assumed that the renewable energy supply facility 5 has a structure depicted in FIG. 26.

As depicted in FIG. 26, in the renewable energy supply facility 5, four employee shuttle EVs are present. Also, four EV chargers/dischargers are present. Also, one accumulator battery is present. Also, one PV power generation device is present.

The renewable energy supply facility 5 supplies electric power acquired by power generated by itself to the employee shuttle EVs, the production facilities 1, and the utility facility 3.

Also, in a unit time in which the amount of power supply is insufficient, the renewable energy supply facility 5 supplies electric power (purchased power) purchased from a power company, which is an auxiliary power supply facility, to the employee shuttle EVs, the production facilities 1, and the utility facility 3.

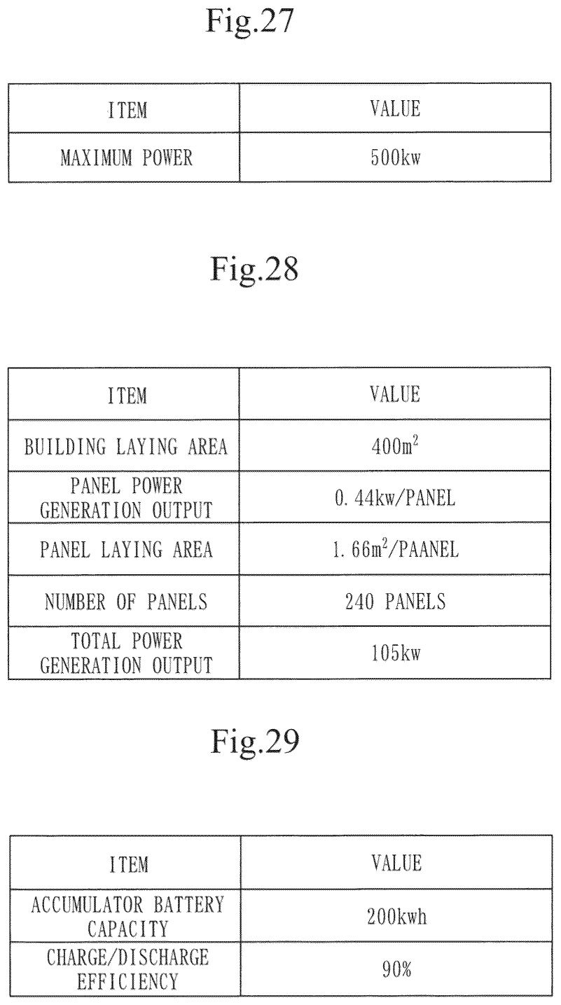

FIG. 27 to FIG. 29 each depict an example of renewable energy supply facility information.

The renewable energy supply facility information is configured of maximum power information, PV facility information, and accumulator battery information.

It is assumed that the renewable energy supply facility information (maximum power information, PV facility information, accumulator battery information) is acquired from the renewable energy supply facility 5 and stored in the master database 730 before the power generation plan generating unit 711 generates a power generation plan. In place of this, when the power generation plan generating unit 711 generates a power generation plan, the power generation plan generating unit 711 may acquire the renewable energy supply facility information from the renewable energy supply facility 5 by using the communication control unit 714.

FIG. 27 depicts an example of maximum power information.

The maximum power information indicates maximum power that can be supplied by the renewable energy supply facility 5. In the present embodiment, the maximum power of the renewable energy supply facility 5 is 500 kw.

FIG. 28 depicts an example of PV facility information.

As depicted in FIG. 28, the PV facility information is configured of building laying area, panel power generation output, panel laying area, number of panels, and total power generation output.

FIG. 29 depicts an example of accumulator battery information.

As depicted in FIG. 29, the accumulator battery information is configured of accumulator battery capacity and charge/discharge efficiency.

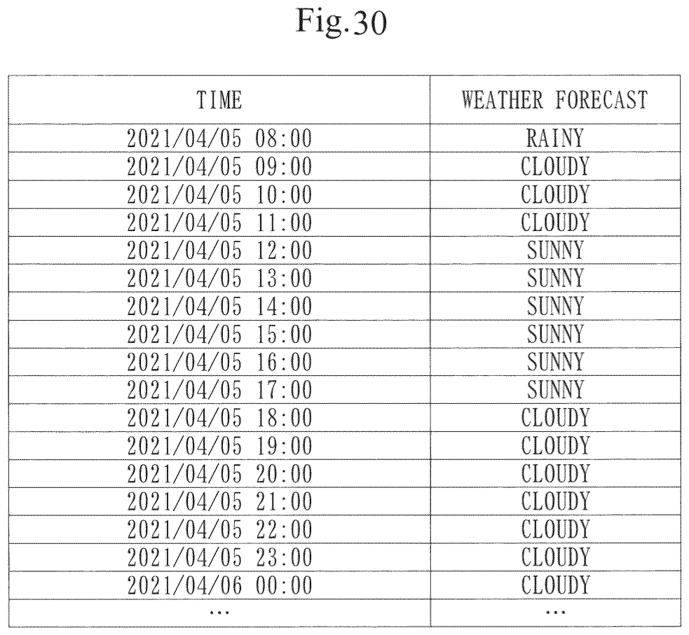

FIG. 30 depicts an example of weather forecast information.

The weather forecast information input unit 751 depicted in FIG. 5 inputs weather forecast information.

As depicted in FIG. 30, the weather forecast information is configured of time corresponding to the unit time and weather forecast at each time.

FIG. 31 depicts an example of PV power generation plan information.

In the PV power generation plan information, a PV power generation plan generated by the power generation plan generating unit 711 is indicated.

The PV power generation plan information is configured of, as depicted in FIG. 31, operation time and PV power generation amount.

By using the weather forecast information (FIG. 30) and the PV facility information (FIG. 28), the power generation plan generating unit 711 predicts a PV power generation amount for each unit time to generate a PV power generation plan.

In the item of operation time, the same time as that of the item of operation time of FIG. 21 is indicated.

In the item of PV power generation amount, the PV power generation amount predicted by the power generation plan generating unit 711 is indicated.

FIG. 32 depicts an example of EV operation plan information.

In the EV operation plan information, an EV operation plan generated by the EV operation plan generating unit 712 is indicated. The EV operation plan generating unit 712 generates an EV operation plan based on the production facility operation plan information (FIG. 21) and the utility facility operation plan information (FIG. 24).

As depicted in FIG. 32, the EV operation plan information is configured of EV number, factory arrival year/month/day, factory arrival time, factory departure year/month/day, factory departure time, scheduled charge rate at arrival, and scheduled charge rate at departure.

Note that charge rate [%] of “scheduled charge rate at arrival” and “scheduled charge rate at departure” is calculated with expression 1.

charge rate [%]=EV remaining capacity [kwh]÷EV maximum capacity [kwh] Expression 1:

Also, in “factory”, factories in both of the production facilities 1 and the utility facility 3 are included.

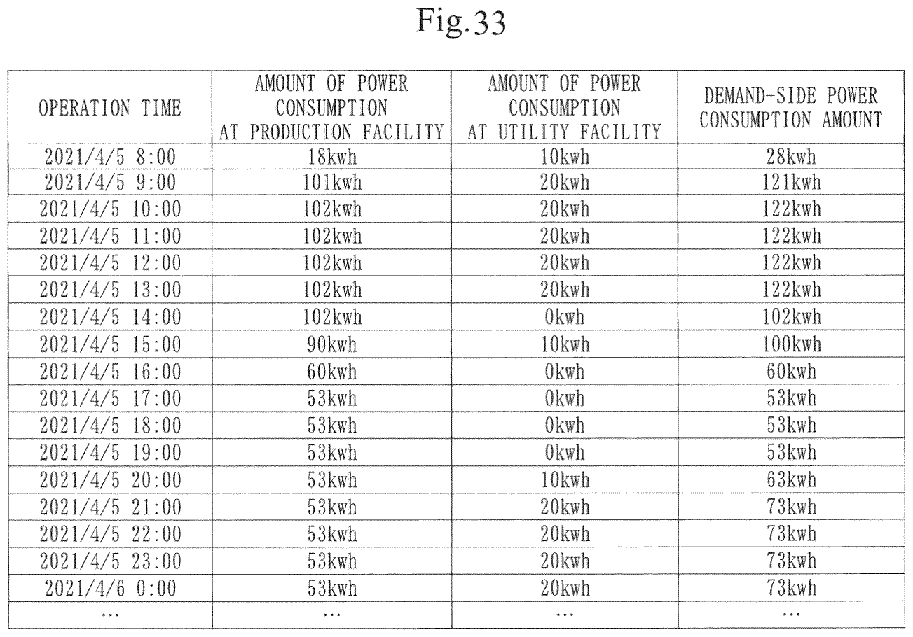

FIG. 33 depicts an example of demand-side power consumption amount information.

As depicted in FIG. 33, the demand-side power consumption amount information is configured of operation time, amount of power consumption at production facility, amount of power consumption at utility facility, and demand-side power consumption amount.

In the item of operation time, the same time as that of the item of operation time of FIG. 21 is indicated.

In the item of amount of power consumption at production facility, the amount of power consumption in the production facility 1 is indicated.

In the item of amount of power consumption at utility facility, the amount of power consumption in the utility facility 3 is indicated.

In the item of demand-side power consumption amount, a total value of the amount of power consumption at production facility and the amount of power consumption at utility facility is indicated.

The supply facility operation plan generating unit 713 uses the value of “amount of power consumption” of the consumption resource information (FIG. 25) as “amount of power consumption at production facility” of FIG. 33. Also, the supply facility operation plan generating unit 713 uses the value of “utility facility resource” of the utility facility operation plan information (FIG. 24) as “amount of power consumption at utility facility” of FIG. 33.

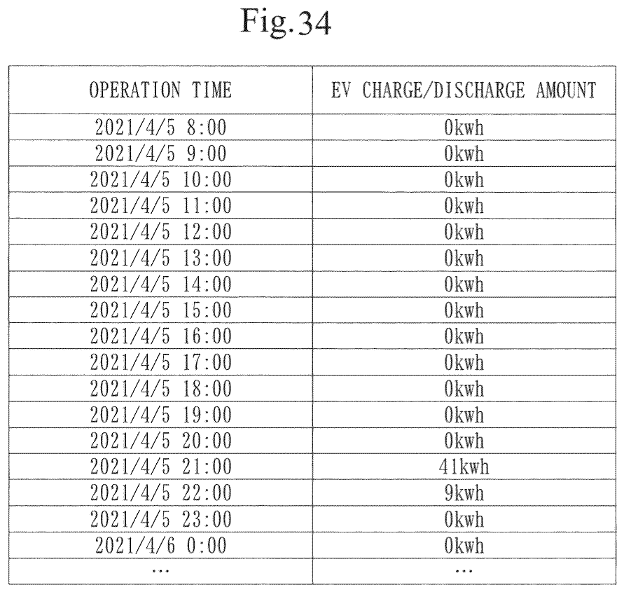

FIG. 34 depicts an example of EV charge/discharge amount information.

As depicted in FIG. 34, the EV charge/discharge amount information is configured of operation time and EV charge/discharge amount.

In the item of EV charge/discharge amount, the total of charge/discharge amounts of the four EVs is indicated. A plus EV charge/discharge amount represents discharging. On the other hand, a minus EV charge/discharge amount represents charging.

The supply facility operation plan generating unit 713 generates EV charge/discharge amount information based on the EV operation plan information (FIG. 32).

FIG. 35 depicts an example of supply facility operation plan information.

As depicted in FIG. 35, the supply facility operation plan information is configured of operation time, demand-side power consumption amount, PV power generation amount, PV power feeding amount, accumulator-battery charge/discharge amount, EV charge/discharge amount, and supply/demand amount of power purchase. In the item of operation time, the same time as that of the item of operation time of FIG. 21 is indicated.

The supply facility operation plan generating unit 713 generates supply facility operation plan information with the following procedure.

As a value of “demand-side power consumption amount”, the supply facility operation plan generating unit 713 uses a value of “demand-side power consumption amount” of the demand-side power consumption amount information (FIG. 33).

Also, as a value of “PV power generation amount”, the supply facility operation plan generating unit 713 uses a value of “PV power generation amount” of the PV power generation plan information (FIG. 31).

Also, the supply facility operation plan generating unit 713 decides a value of “PV power feeding amount” with the following procedure.

When “demand-side power consumption amount≥PV power generation amount”, the supply facility operation plan generating unit 713 uses a value of “PV power generation amount” as a value of “PV power feeding amount”.

On the other hand, when “demand-side power consumption amount<PV power generation amount”, the supply facility operation plan generating unit 713 uses a value of “demand-side power consumption amount” as a value of “PV power feeding amount”.

Also, the supply facility operation plan generating unit 713 decides a value of “accumulator-battery charge/discharge amount” with the following procedure.

When “demand-side power consumption amount<PV power generation amount”, the supply facility operation plan generating unit 713 calculates a value of “accumulator-battery charge/discharge amount” with expression 2.

On the other hand, when “demand-side power consumption amount≥PV power generation amount”, if “(accumulator battery remaining amount×charge/discharge efficiency)≥(demand-side power consumption amount−PV power generation amount)”, the supply facility operation plan generating unit 713 calculates a value of “accumulator-battery charge/discharge amount” with expression 3. On the other hand, if “(accumulator battery remaining amount×charge/discharge efficiency)<(demand-side power consumption amount−PV power generation amount)”, the supply facility operation plan generating unit 713 calculates a value of “accumulator-battery charge/discharge amount” with expression 4.

Note that “charge/discharge efficiency” is indicated in accumulator battery information (FIG. 29).

accumulator-battery charge/discharge amount=(demand-side power consumption amount−PV power generation amount)×charge/discharge efficiency Expression 2:

accumulator-battery charge/discharge amount=(demand-side power consumption amount−PV power generation amount) Expression 3:

accumulator-battery charge/discharge amount=accumulator battery remaining amount×charge/discharge efficiency Expression 4:

Also, as a value of “EV charge/discharge amount”, the supply facility operation plan generating unit 713 uses a value of “EV charge/discharge amount” of the EV charge/discharge amount information (FIG. 34).

Also, the supply facility operation plan generating unit 713 calculates a value of “supply/demand amount of power purchase” with expression 5.

supply/demand amount of power purchase=demand-side power consumption amount−PV power feeding amount−accumulator-battery discharge amount−EV charge/discharge amount Expression 5:

Transitions of the amount of power for each unit time indicated in the items of “accumulator-battery charge/discharge amount” and “EV charge/discharge amount” depicted in FIG. 35 correspond to the power accumulation plan and the electrical discharge plan.

Also, transitions of the amount of power for each unit time indicated in the item of “supply/demand amount of power purchase” correspond to the acquisition plan.

### ***Description of Specific Example of Information for Use in Optimization Device 8 and Operation of Optimization Device 8***

Next, information for use in the optimization device 8 is described.

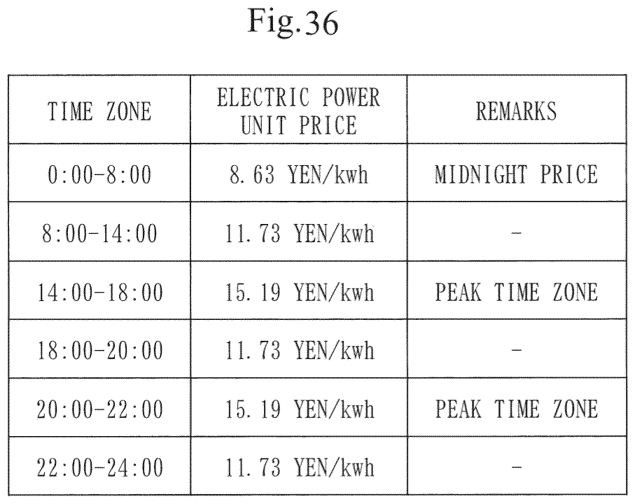

FIG. 36 depicts an example of electric power unit price information.

As depicted in FIG. 36, the electric power unit price information is configured of time zone, electric power unit price, and remarks.

In FIG. 36, an example is depicted in which 24 hours are divided into six time zones. The electric power unit price indicates a unit price when electric power is purchased from the auxiliary power supply facility in each time zone.

The electric power unit price information is stored in the master database 831.

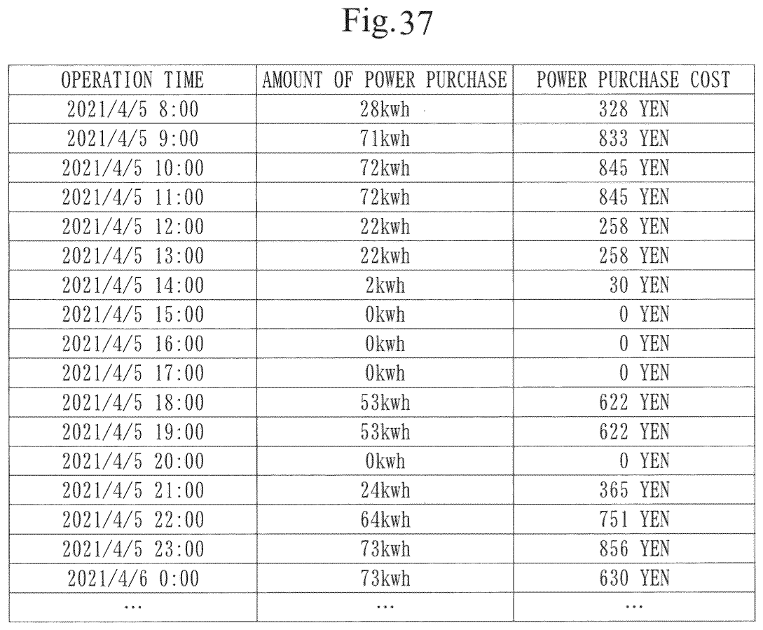

FIG. 37 depicts an example of supply/demand power purchase cost information.

As depicted in FIG. 37, the supply/demand power purchase cost information is configured of operation time, amount of power purchase, and power purchase cost.

In the item of operation time, the same time as that of the item of operation time of FIG. 21 is indicated.

In the item of amount of power purchase, the value in the item of the supply/demand amount of power purchase of the supply facility operation plan information (FIG. 35) is indicated.

The production cost calculating unit 812 multiplies the value of the amount of power purchase by the value of the electric power unit price of the electric power unit price information (FIG. 36) to acquire a value of power purchase cost.

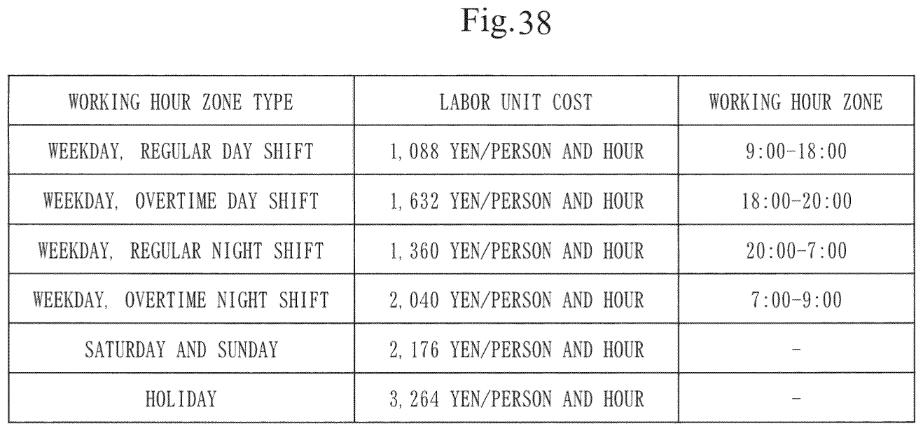

FIG. 38 depicts an example of labor unit cost information.

As depicted in FIG. 38, the labor unit cost information is configured of working hour zone type, labor unit cost, and working hour zone.

In the example of FIG. 38, there are six working hour zones: four weekday time zones, Saturday and Sunday, and holiday. In the item of working hour zone type, the names of the six working hour zones are indicated.

In the item of labor unit cost, a labor cost of one employee per hour is indicated for each working hour zone type.

The labor unit cost information is stored in the master database 831.

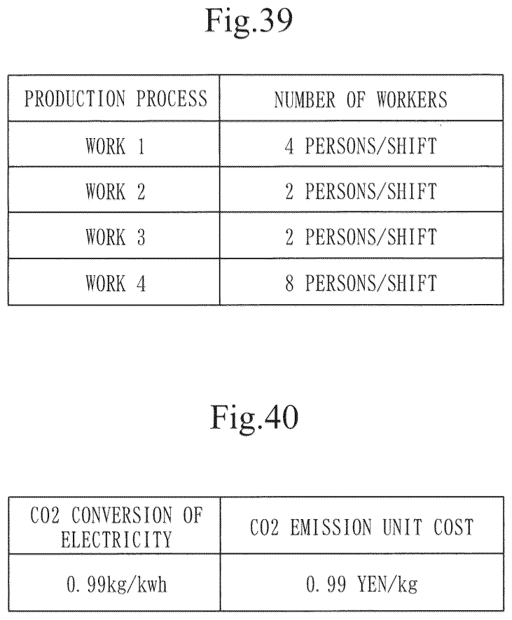

FIG. 39 depicts an example of information about the number of workers.

As depicted in FIG. 39, the information about the number of workers is configured of production process and number of workers.

In the item of production process, each of production processes from the work 1 to work 4 is indicated.

In the item of number of workers, the number of workers required in each production process is indicated.

The information about the number of workers is stored in the master database 831.

FIG. 40 depicts an example of CO2 emission unit cost information.

As depicted in FIG. 40, the CO2 emission unit cost information is configured of CO2 conversion of electricity and CO2 emission unit cost.

In the item of CO2 conversion of electricity, a value for converting the amount of power consumption to an amount of CO2 emission is indicated.

In the item of CO2 emission unit cost, a CO2 cost required per kilogram is indicated.

The CO2 emission unit cost information is stored in the master database 831.

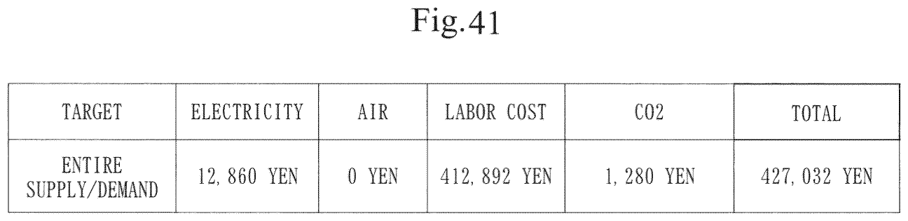

FIG. 41 depicts an example of production cost information.

As depicted in FIG. 41, the production cost information is configured of target, electricity, air, labor cost, CO2, and total.

In the example of FIG. 41, production cost of the entire supply/demand is indicated. The production cost of the entire supply/demand means a total cost incurred at the production facilities 1, the utility facility 3, and the supply facility operation plan generation device 7.

In the item of electricity, cost of electricity to be taken in the production facilities 1, the utility facility 3, and the supply facility operation plan generation device 7 is indicated.

In the item of air, cost of air to be taken in the production facilities 1, the utility facility 3, and the supply facility operation plan generation device 7 is indicated.

In the item of labor cost, cost of labor to be taken in the production facilities 1, the utility facility 3, and the supply facility operation plan generation device 7 is indicated.

In the item of CO2, cost of environmental load to be taken in the production facilities 1, the utility facility 3, and the supply facility operation plan generation device 7 is indicated.

In the item of total, a total of values of electricity, air, labor cost, and CO2 is indicated.

The production cost calculating unit 812 acquires a value of “electricity” based on the supply/demand power purchase cost information (FIG. 37).

The production cost calculating unit 812 acquires a value of “labor cost” based on the labor unit cost information (FIG. 38) and the information about the number of workers (FIG. 39).

The production cost calculating unit 812 acquires a value of “CO2” based on the environmental load information (FIG. 25), the supply/demand power purchase cost information (FIG. 37), and the CO2 emission unit cost information (FIG. 40).

The production evaluation index calculating unit 813 calculates a production evaluation index based on the production cost information (FIG. 41).

Specifically, the production evaluation index calculating unit 813 calculates a production evaluation index with the following procedure.

In the present embodiment, production evaluation indexes are classified into productivity, energy efficiency, and environmental load.

The production evaluation index of productivity is obtained from a total sum of values obtained by multiplying the labor cost in each production process by load time and dividing the multiplication value by the production quantity (expression 6).

The production evaluation index of energy efficiency is obtained from a total sum of values obtained by multiplying power consumption cost in each production process by load time and dividing the multiplication value by the production quantity (expression 7).

The production evaluation index of environmental load is obtained from a total sum of values obtained by multiplying environmental load cost in each production process by load time and dividing the multiplication value by the production quantity (expression 8).

Here, the load time is obtained by subtracting planned nonoperating time from factory operating time based on the current production plan, as represented in expression 9.

Note herein that only labor cost is used for calculation of a production evaluation index of productivity. For calculation of a production evaluation index of productivity, in addition to the labor cost, a consumption resource other than power consumption, such as material cost, may be used. Furthermore, a production evaluation index of a consumption resource other than power consumption, such as material cost, may be calculated.

(productivity)=Σ(labor cost)×(load time)/(production quantity) Expression 6:

(energy efficiency)=Σ(power consumption cost)×(load time)/(production quantity) Expression 7:

(environmental load)=Σ(environmental load cost)×(load time)/(production quantity) Expression 8:

(load time)=(operating time)−(planned nonoperating time) Expression 9:

Furthermore, from the production evaluation indexes of energy efficiency, productivity, and environmental load, the production evaluation index calculating unit 813 generates a final production evaluation index by following expression 10. Note that as the production plan is more appropriate, the value of the production evaluation index obtained in expression 10 is smaller.

$$( production evaluation index ) = w 1 \times ( productivity ) + w 2 \times ( energy efficiency ) + w 3 \times ( environmental load ) \qquad Expression 10$$

$$w 1 , w 2 , w 3 : weighting factor ( user setting ) ( w 1 + w 2 + w 3 = 1 )$$

The weighting factors w1, w2, and w3 can be set as appropriate by the user in accordance with a situation such as the production site environment, evaluation priority level, digit alignment of terms, and so forth. Note that all weighting factors add up to 1.

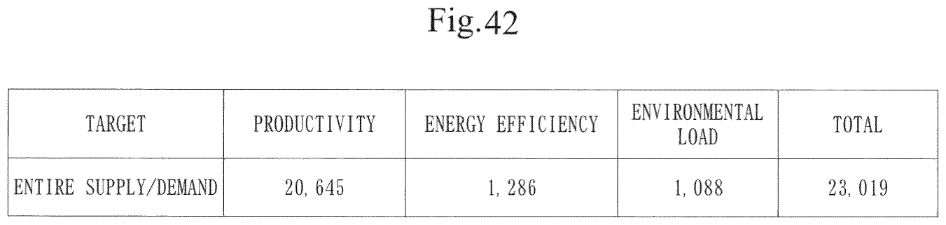

FIG. 42 depicts an example of production evaluation index information generated by the production evaluation index calculating unit 813.

As depicted in FIG. 42, the production evaluation index information is configured of target, productivity, energy efficiency, environmental load, and total.

Note that in the example of FIG. 42, a production evaluation index calculated with w1=0.1, w2=0.05, and w3=0.85 is indicated.

The determining unit 814 acquires target value information from the target value database 834.

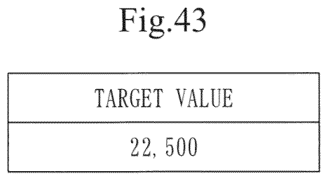

FIG. 43 depicts an example of target value information.

In the target value information, a target value of the production evaluation index is indicated.

The determining unit 814 compares the value of “target value” and the production evaluation index.

The determining unit 814 compares the production evaluation index (total) of the production evaluation index information (FIG. 42) and the target value information to determine whether correction of the production plan is required.

When the production evaluation index (total) of the production evaluation index information (FIG. 42) is equal to or smaller than the target value, the determining unit 814 determines that correction of the production plan is not required. On the other hand, when the production evaluation index (total) of the production evaluation index information (FIG. 42) is larger than the target value, the determining unit 814 determines that correction of the production plan is required.

Note that the target value can be set at any by the user of the optimization device 8.

When the determining unit 814 determines that correction of the production plan is required, as described above, the instructing unit 815 instructs the production plan generation device 4 to generate a proposal for correction of the production plan with the round-robin scheme.

FIG. 65 depicts an example of the production plan correction proposal information generated by the production plan generating unit 411.

As depicted in FIG. 65, the production plan correction proposal information is configured of correction proposal number, production process, target model, production start time, production end time, and production quantity. In FIG. 65, for simplification, a proposal for correction of the production plan targeting only the model B and the model D to be manufactured in the work 2 is indicated.

In the item of correction proposal number, a number corresponding to the number of correction proposals generated by the production plan generating unit 411 is indicated (FIG. 65 depicts that N correction proposals have been generated).

In the item of target model, a model as a correction target is indicated.

In the item of production process, a production process as a correction target is indicated. In the item of production process, any production process indicated in the item of production process of FIG. 8 is indicated.

In the item of production start time, a proposal for correction of the production start time is indicated. That is, in the item of production start time, a proposal for correction of the time when the production process indicated in the item of production process starts is indicated.

In the item of production end time, a proposal for correction of the production end time is indicated. That is, in the item of production end time, a proposal for correction of the time when the production process indicated in the item of production process ends is indicated.

In the item of production quantity, a proposal for correction of the production quantity is indicated. That is, in the item of production quantity, a proposal for correction of the production quantity of the model indicated in the item of target model is indicated.

The production plan generating unit 411 generates a correction proposal so that it corresponds to a change parameter specified by the correction proposal generation instruction. In the correction proposal generation instruction, at least any one of “production quantity”, “production sequence”, and “production start time” is specified as a change parameter.

Here, in the correction proposal generation instruction, it is assumed that “production quantity”, “production sequence”, and “production start time” are specified as change parameters.

Since “production quantity” is specified as a change parameter, the production plan generating unit 411 generates a correction proposal for changing the production quantity of the model B and the model D.

Also, since “production sequence” is specified as a change parameter, the production plan generating unit 411 generates a correction proposal for changing the production sequence of the model B and the model D.

Also, since “production start time” is specified as a change parameter, the production plan generating unit 411 generates a correction proposal for changing the production start time of the model B and the model D.

In the production plan of the production plan information of FIG. 13, it is planned that 800 pieces of the model B are produced in the work 2. Also, it is planned that 290 pieces of the model D are produced in the work 2.

The production plan generating unit 411 generates a correction proposal for changing the initial plan in which 800 pieces of the model B are produced and 290 pieces of the model D are produced in the work 2. That is, the production plan generating unit 411 changes the production quantity of the model B in a range of 0 to 799 and the production quantity of the model D in a range of 0 to 289. Then, the production plan generating unit 411 generates N correction proposals covering all combinations of the production quantity of the model B and the production quantity of the model D in the work 2.

In the correction proposal number: 1 of FIG. 65, the production quantity of the model B and the production quantity of the model D are both 0 piece. Also, in the correction proposal number: K, the production quantity of the model B and the production quantity of the model D are both 50 pieces. Also, in the correction proposal number: N, the production quantity of the model B is 799 pieces and the production quantity of the model D is 289 pieces.

Also, in the production plan of the production plan information of FIG. 13, it is planned that, in the work 2, the model D is produced after the model B is produced.

The production plan generating unit 411 generates a correction proposal for changing the initial plan in which the model D is produced after the model B is produced. That is, the production plan generating unit 411 generates a correction proposal for producing the model D first and then producing the model B.

In the correction proposal number: K of FIG. 65, a correction proposal is indicated in which the model D is produced first and, after completion of production of the model D, the model B is produced.

Also, in the production plan of the production plan information of FIG. 13, the production start time of the work 2 is “2021/04/05 09:00”.

The production plan generating unit 411 generates a correction proposal for changing the initial plan in which the work 2 starts at “2021/04/05 09:00”. That is, the production plan generating unit 411 generates a correction proposal in which the work 2 starts at a different time.

In the correction proposal number: N of FIG. 65, a correction proposal is indicated in which the work 2 starts at “2021/04/05 03:00”.

When generating a correction proposal for changing the production start time, the production plan generating unit 411 first calculates a margin allowing the production start time of the work 2 to be changed (production start time changeable margin).

The start time of the production start time changeable margin is an earliest producible time. The end time of the production start time changeable margin is a time obtained by subtracting the production time from the production delivery time. For example, if the delivery time of the model B and the model D is “2021/04/06 08:30” and a total production time of the model B and the model D is 20 hours, “2021/04/05 12:30” obtained by subtracting 20 hours from the delivery time “2021/04/06 08:30” is the end time of the production start time changeable margin.

Next, the production plan generating unit 411 refers to the production start time interval information. In the production start time interval information, a unit by which the production start time is changed by the production plan generating unit 411 is indicated. In the production start time interval information, specifically, the unit of time such as “1 hour” or “30 minutes” is indicated.

Here, for simplification of description, the production start time changeable margin of the work 2 is “2021/04/05 03:00” to “2021/04/05 09:00”. In this case, when “1 hour” is indicated in the production start time interval information, the production plan generating unit 411 generates a proposal for correction of the production start time of the work 2 in units of 1 hour, such as “2021/04/05 03:00”, “2021/04/05 04:00”, “2021/04/05 05:00” . . . “2021/04/05 08:00”. On the other hand, when “30 minutes” is indicated in the production start time interval information, the production plan generating unit 411 generates a proposal for correction of the production start time of the work 2 in units of 30 minutes, such as “2021/04/05 03:00”, “2021/04/05 03:30”, “2021/04/05 04:00”, “2021/04/05 04:30”, . . . “2021/04/05 08:00”, “2021/04/05 08:30”.

In this manner, the production plan generating unit 411 generates correction proposals so that all combinations of the change parameters specified in the correction proposal generation instruction are covered.

Then, the production plan generating unit 411 generates a new production plan for each correction proposal.

Here, for simplification of description, it is assumed that the model B and the model D can also be produced in all work processes other than the work 2 (work 1, work 3, and work 4). That is, in the producible line of the model B and the model D, the work 1, the work 3, and the work 4 are included.

For example, in the correction proposal number: 1 of FIG. 65, the number of the model B and the model D to be produced in the work 2 is 0 piece. Thus, the production plan generating unit 411 generates a new production plan in which 800 pieces of the model B are produced and 290 pieces of the model D are produced in a total of the work 1, the work 3, and the work 4. In the correction proposal number: K of FIG. 65, the number of pieces of the model B and the number of pieces of the model D to be produced in the work 2 are 50 pieces each. Thus, the production plan generating unit 411 generates a new production plan in which 750 pieces of the model B are produced and 240 pieces of the model D are produced in a total of the work 1, the work 3, and the work 4.

Thereafter, as described above, after all correction proposals have been tested, the instructing unit 815 selects a production plan from which the minimum production evaluation index is acquired.

### ***Comparison Between Sequential Scheme and Synchronous Scheme***

Next, a comparison is made between the production plan optimization scheme according to the technology of Patent Literature 1 and a production plan optimization scheme according to the present embodiment.

In the following, the production plan optimization scheme according to the technology of Patent Literature 1 is referred to as a sequential scheme. Meanwhile, the production plan optimization scheme according to the present embodiment is referred to as a synchronous scheme.

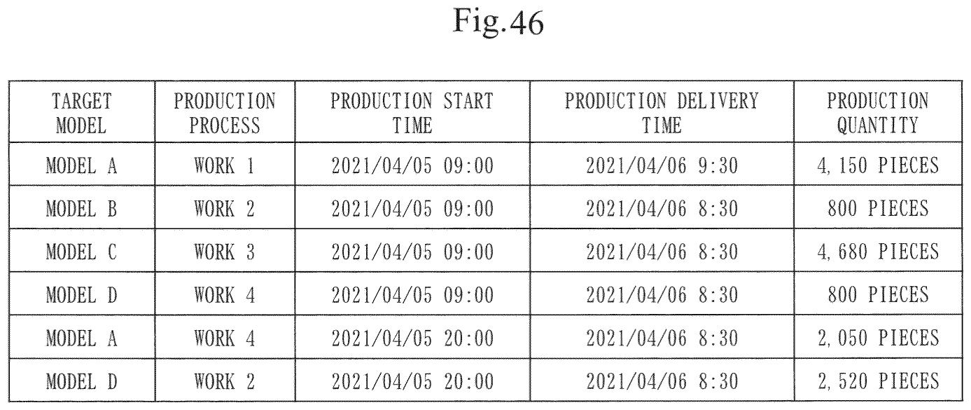

FIG. 46 depicts an example of production plan information after optimized by the sequential scheme. FIG. 46 corresponds to FIG. 13.

In the sequential scheme, all production processes are performed in a night time zone with a low electric power unit price in a range in which overtime cost of the labor cost does not occur when a production plan is made. Thus, in the sequential scheme, it is possible to make a production plan with inexpensive electric power cost while suppressing overtime cost.

However, in the sequential scheme, electric power supply of the renewable energy supply facility is not considered when a production plan is made.

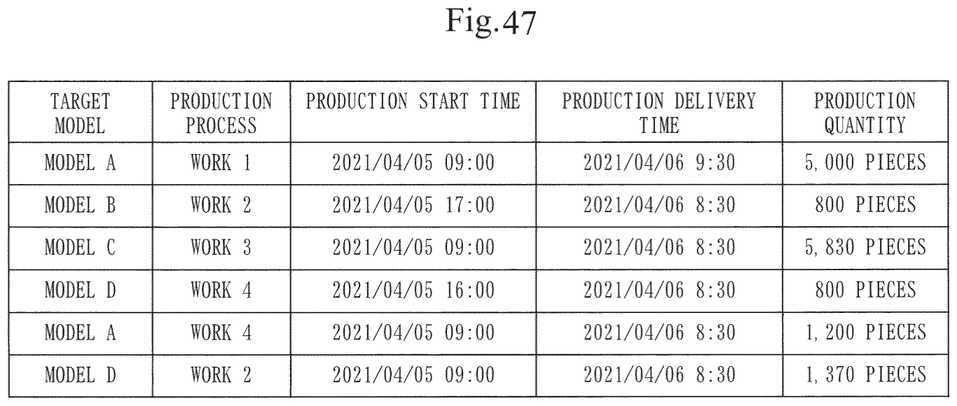

FIG. 47 depicts an example of production plan information after optimized by the synchronous scheme. FIG. 47 corresponds to FIG. 13.

That is, FIG. 47 depicts production plan information of a production plan from which a minimum production evaluation index is acquired after generation of a proposal for correction of the production plan with the round-robin scheme.

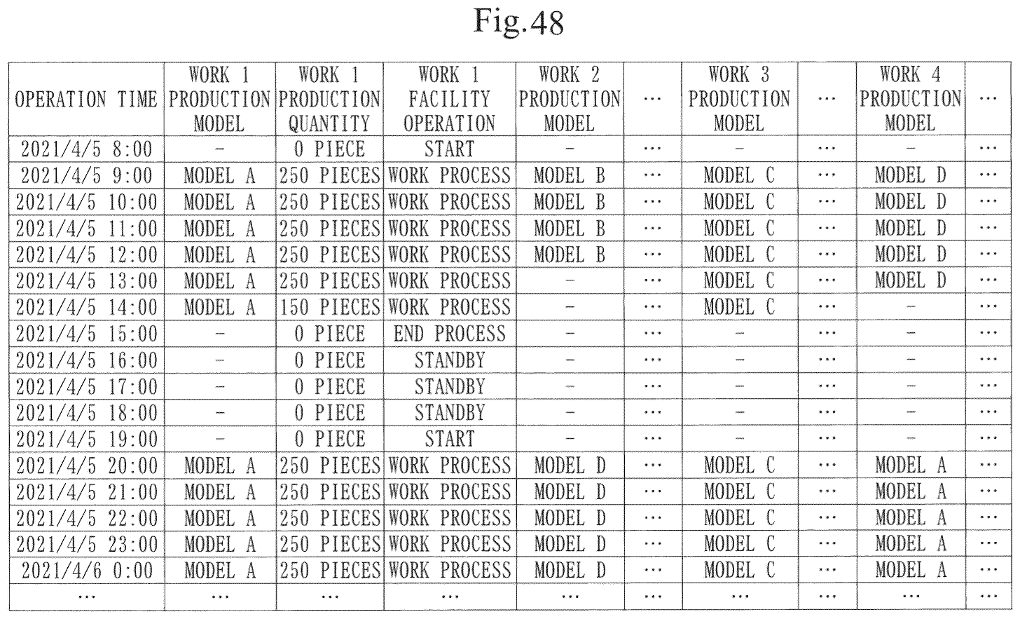

FIG. 48 depicts an example of production facility operation plan information generated based on the production plan information under the sequential scheme depicted in FIG. 46.

That is, FIG. 48 corresponds to FIG. 21.

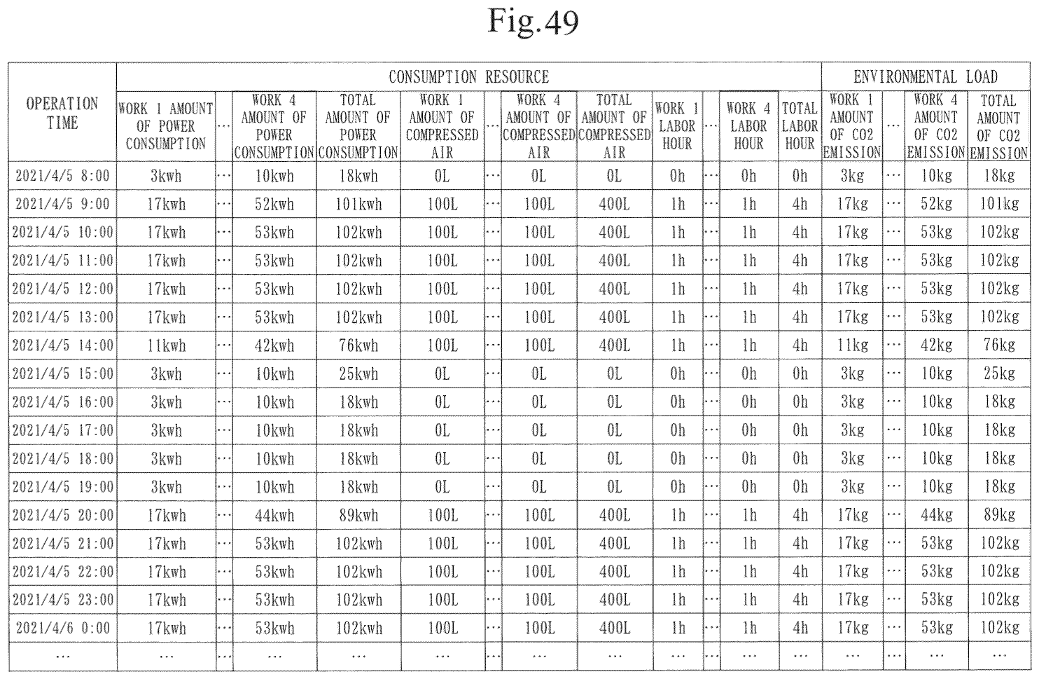

FIG. 49 depicts an example of consumption resource information and environmental load information generated based on the production plan information under the sequential scheme depicted in FIG. 46.

That is, FIG. 49 corresponds to FIG. 25.

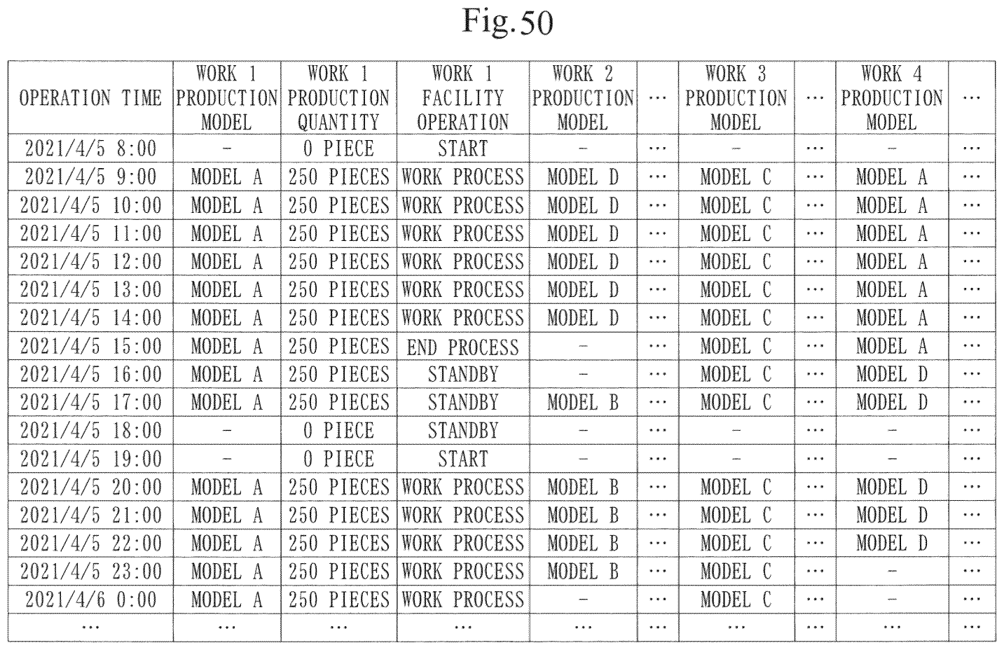

FIG. 50 depicts an example of production facility operation plan information generated based on the production plan information under the synchronous scheme depicted in FIG. 47.

That is, FIG. 50 corresponds to FIG. 21.

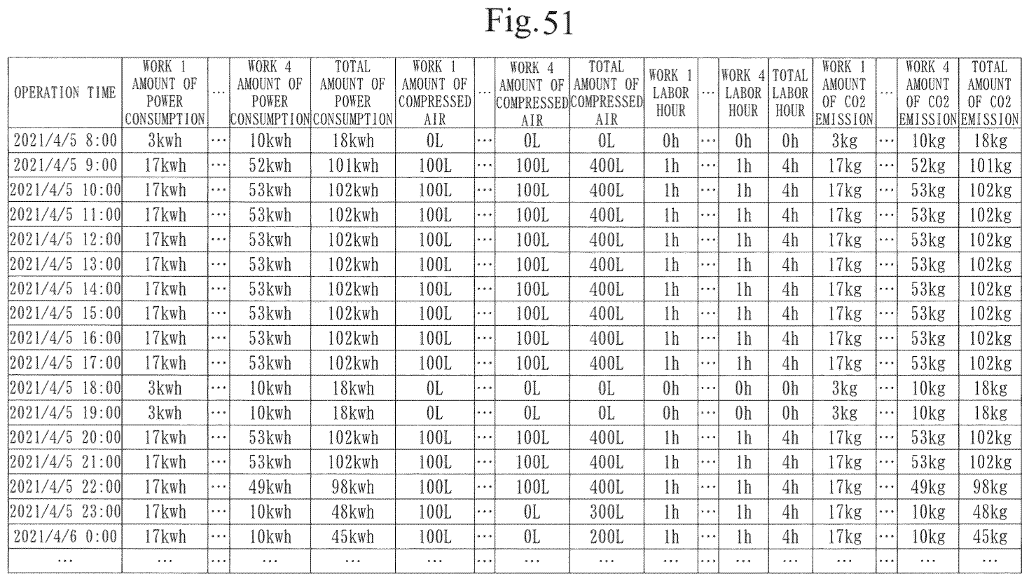

FIG. 51 depicts an example of consumption resource information and environmental load information generated based on the production plan information under the synchronous scheme depicted in FIG. 47.

That is, FIG. 51 corresponds to FIG. 25.

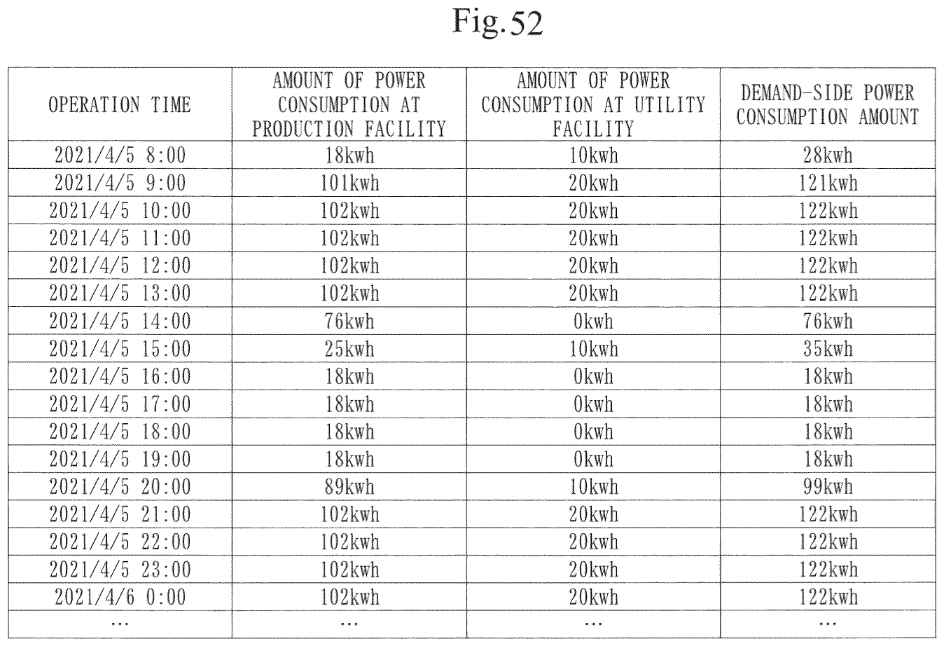

FIG. 52 depicts an example of demand-side power consumption amount information generated based on the production plan information under the sequential scheme depicted in FIG. 46.

That is, FIG. 52 corresponds to FIG. 33.

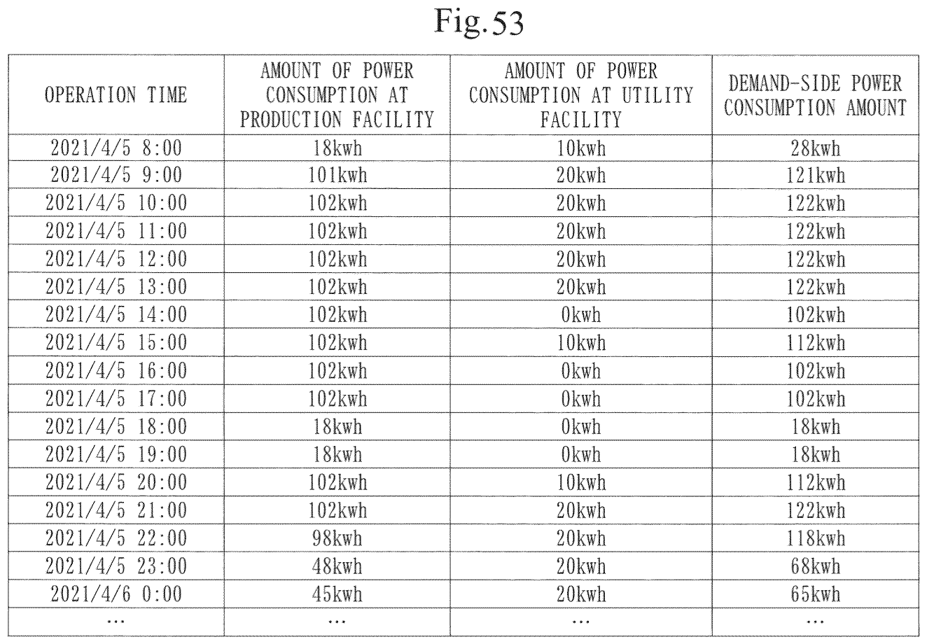

FIG. 53 depicts an example of demand-side power consumption amount information generated based on the production plan information under the synchronous scheme depicted in FIG. 47.

That is, FIG. 53 corresponds to FIG. 33.

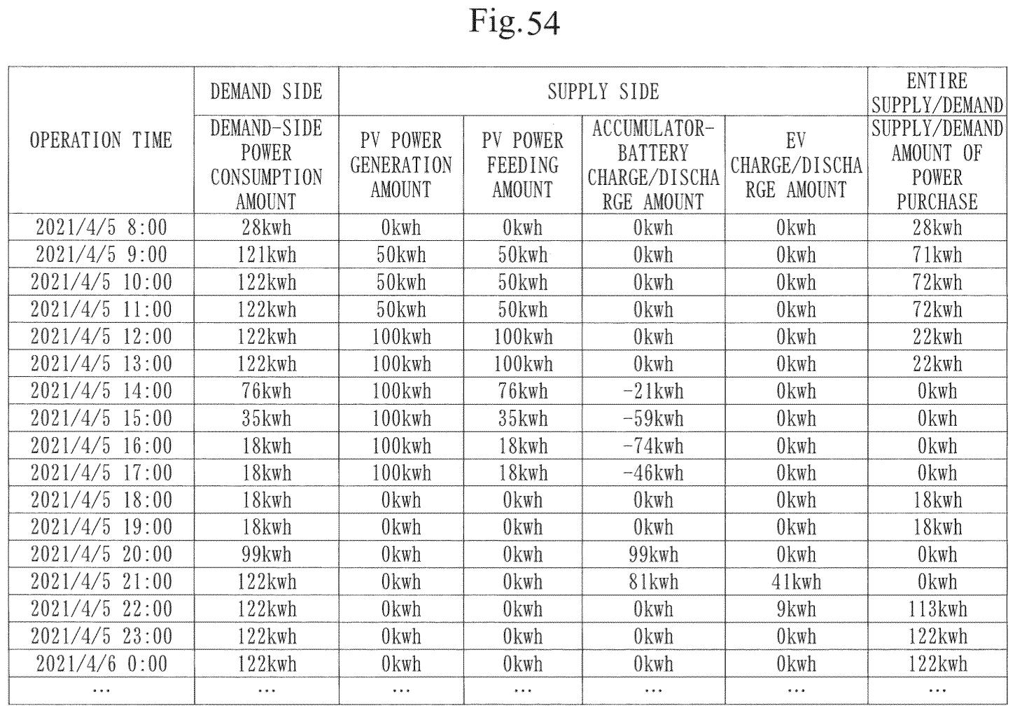

FIG. 54 depicts an example of supply facility operation plan information generated based on the production plan information under the sequential scheme depicted in FIG. 46.

That is, FIG. 54 corresponds to FIG. 35.

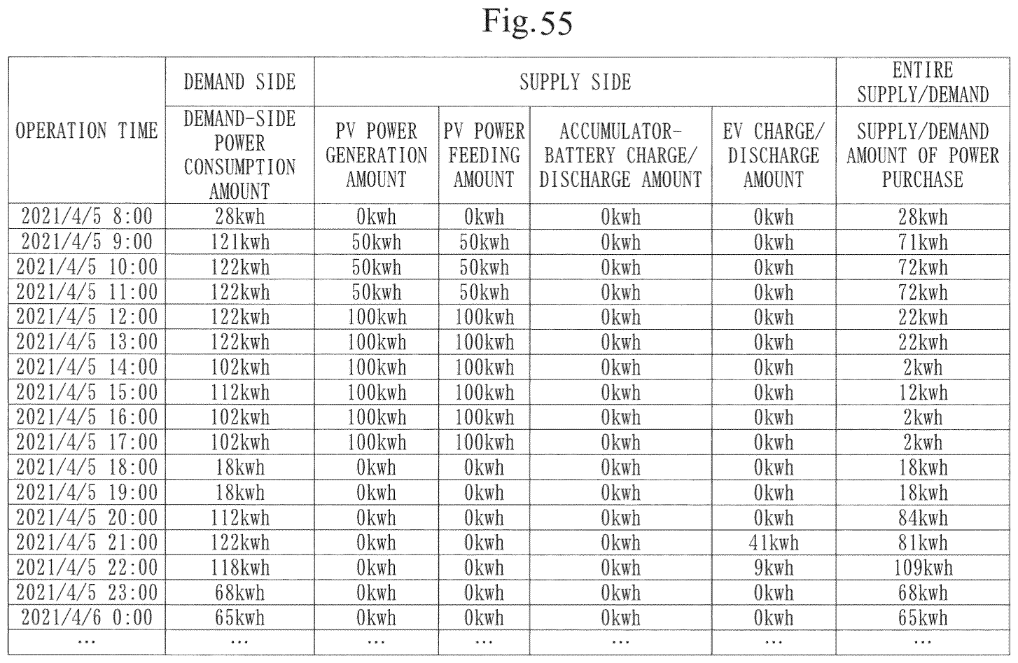

FIG. 55 depicts an example of supply facility operation plan information generated based on the production plan information under the synchronous scheme depicted in FIG. 47.

That is, FIG. 55 corresponds to FIG. 35.

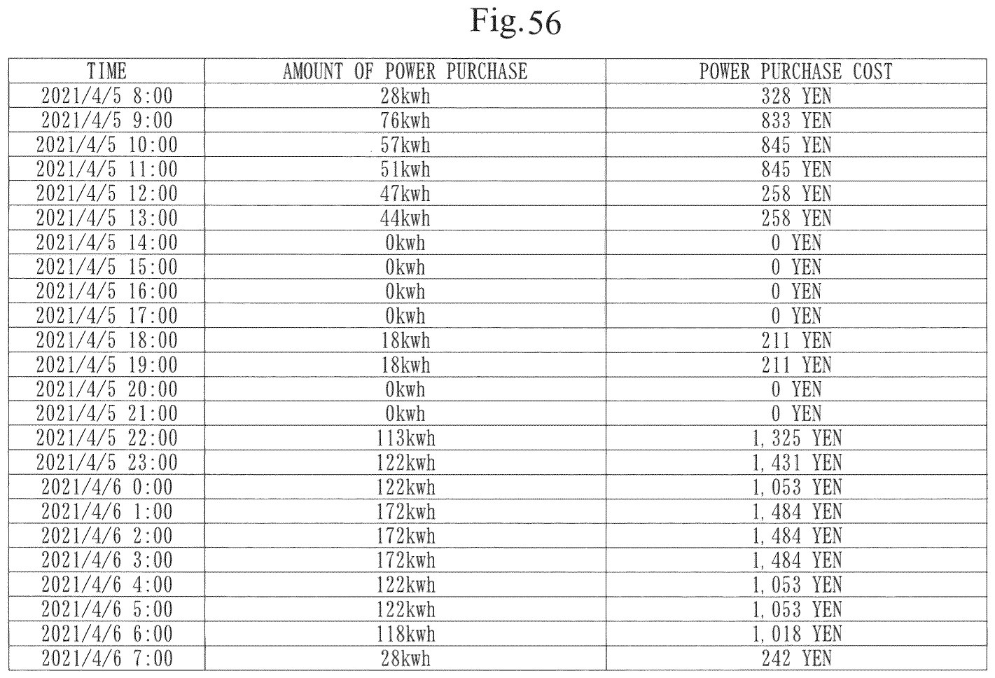

FIG. 56 depicts an example of supply/demand power purchase cost information generated based on the production plan information under the sequential scheme depicted in FIG. 46.

That is, FIG. 56 corresponds to FIG. 37.

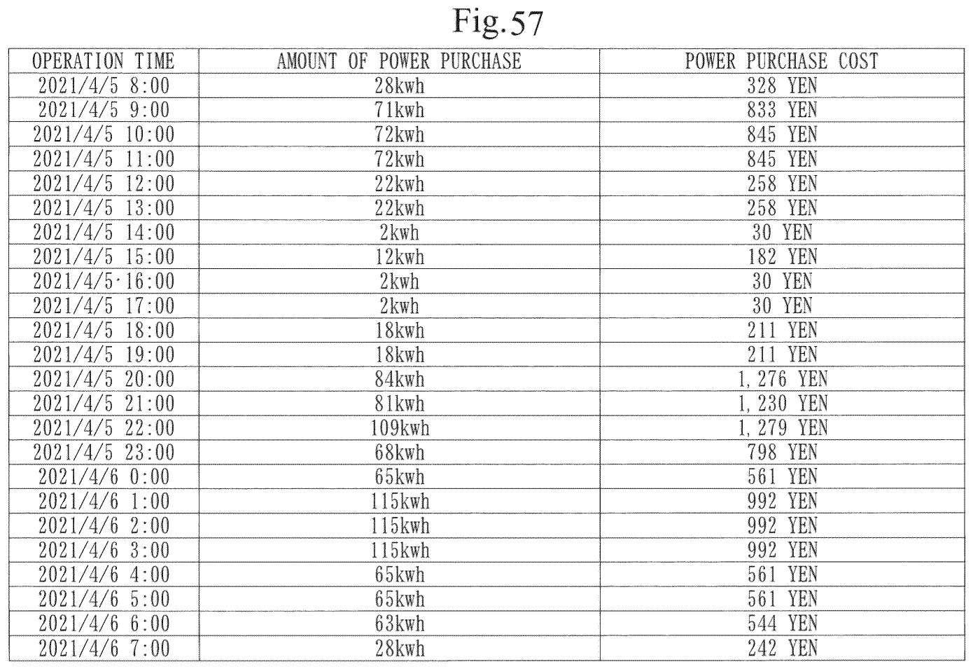

FIG. 57 depicts an example of supply/demand power purchase cost information generated based on the production plan information under the synchronous scheme depicted in FIG. 47.

That is, FIG. 57 corresponds to FIG. 37.

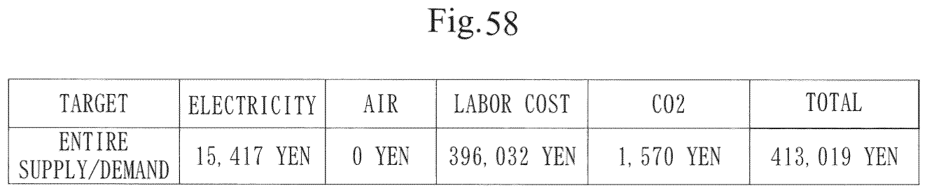

FIG. 58 depicts an example of production cost information generated based on the production plan information under the sequential scheme depicted in FIG. 46.

That is, FIG. 58 corresponds to FIG. 41.

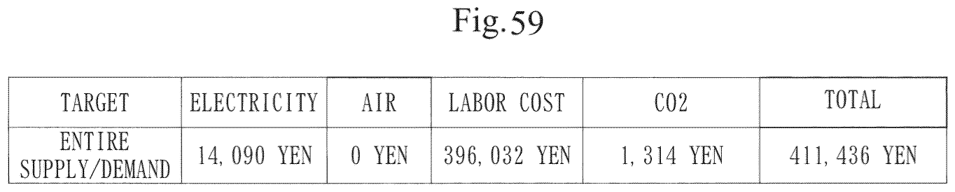

FIG. 59 depicts an example of production cost information generated based on the production plan information under the synchronous scheme depicted in FIG. 47.

That is, FIG. 59 corresponds to FIG. 41.

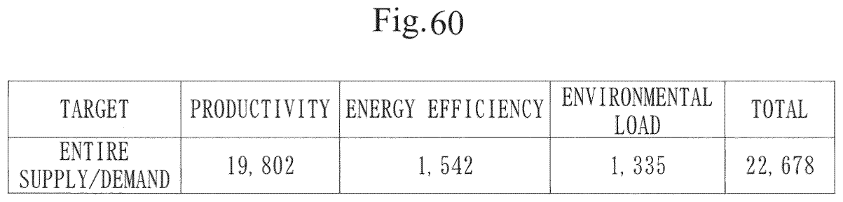

FIG. 60 depicts an example of production evaluation index information generated based on the production plan information under the sequential scheme depicted in FIG. 46.

That is, FIG. 60 corresponds to FIG. 42.

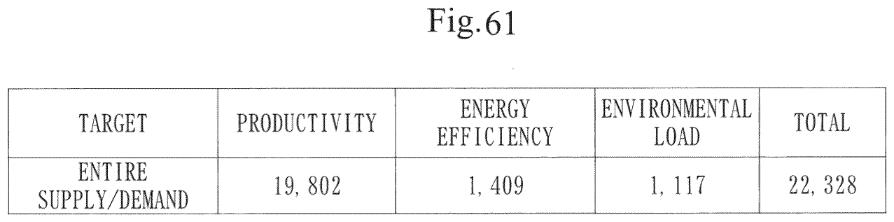

FIG. 61 depicts an example of production evaluation index information generated based on the production plan information under the synchronous scheme depicted in FIG. 47.

That is, FIG. 61 corresponds to FIG. 42.

In the sequential scheme, all work processes are performed in a time zone with a low electric power unit price without consideration of the amount of power supply of the renewable energy supply facility 5, and production in a time zone with a high electric power unit price is suppressed. Thus, as depicted in FIG. 52, the demand-side power consumption amount is low in a daytime time zone and high in a night time zone.

On the other hand, the PV power generation amount of the renewable energy supply facility 5 characteristically occurs more in the daytime time zone, as depicted in FIG. 54. Thus, during the daytime, there is a time zone in which the demand-side power consumption amount falls below the PV power generation amount. Specifically, the demand-side power consumption amount falls below the PV power generation amount from “2021/04/05 14:00” to “2021/04/05 15:00”.

In these time zones, an excessive amount of power generation of PV power generation amount exceeding the demand-side power consumption amount is accumulated in the accumulator battery. In the example of FIG. 54, the accumulated electric power is supplied to the demand side at “2021/04/05 20:00” and “2021/04/05 21:00”.

As depicted in FIG. 29, since the charge/discharge efficiency of the accumulator battery is 90%, when electric power is accumulated in the accumulator battery and then discharged, the amount of electric power that can be supplied becomes 81% of the amount of power generation, which is not efficient.

Resultantly, in the sequential scheme, the supply/demand power purchase cost increases and, as depicted in FIG. 56, supply/demand power purchase cost of 15,602 yen is incurred in total.

On the other hand, in the synchronous scheme, the production plan is optimized in consideration of the amount of power supply of the renewable energy supply facility 5. Thus, in the synchronous scheme, all work processes are performed in a time zone with a large amount of power supply of the renewable energy supply facility 5.

As depicted in FIG. 53, in the synchronous scheme, the demand-side power consumption amount is high in a daytime time zone and low in a night time zone.

As described above, the PV power generation amount of the renewable energy supply facility 5 characteristically occurs more in the daytime time zone. In the synchronous scheme, as depicted in FIG. 55, the demand-side power consumption amount is more than the PV power generation amount in the daytime.

Thus, in the synchronous scheme, power accumulation in the accumulator battery is not performed, and there is no influence of charge/discharge efficiency of the accumulator battery. Thus, in the synchronous scheme, it is possible to efficiently supply electric power from the renewable energy supply facility 5.

Resultantly, in the synchronous scheme, the supply/demand power purchase cost can be suppressed. Specifically, in the synchronous scheme, as depicted in FIG. 57, the supply/demand power purchase cost can be suppressed to 14,625 yen in total.

In the synchronous scheme, compared with the sequential scheme, the supply/demand power purchase cost can be reduced by approximately 6%.

Also, in the synchronous scheme, compared with the sequential scheme, cost regarding CO2 emission can be reduced by approximately 15%.

Here, the synchronous scheme and the sequential scheme are compared in cost regarding the supply/demand power purchase cost and CO2 emission. A similar comparison can be made for an environmental load substance such as Volatile Organic Compounds (VOC) gas.

From FIG. 60 and FIG. 61, also as for the production evaluation index, it is possible in the synchronous scheme to acquire a value more favorable than that in the sequential scheme in view of both of energy efficiency and environmental load.

### ***Description of Effects of Embodiment***

In the present embodiment, based on a proposal for correction of the production plan and a power generation plan based on prediction of a state transition of the external environment, a power accumulation plan, an electrical discharge plan, and an acquisition plan are generated. Then, based on the generated power accumulation plan, electrical discharge plan, and acquisition plan, a proposal for correction of the production plan to be adopted is selected.

Thus, according to the present embodiment, even when a power generation facility with its amount of power generation fluctuating in accordance with the state transition of the external environment is used as a power supply source, it is possible to select a production plan with the power accumulation plan, electrical discharge plan, and acquisition plan that can efficiently utilize fluctuations in the amount of power generation.

Also, in the present embodiment, from among a plurality of correction proposals, a correction proposal in which the production cost is minimum or an index value acquired from the production cost is minimum is selected. Thus, according to the present embodiment, the production cost can be suppressed.

Also, according to the present embodiment, it is possible to generate a production plan that addresses environmental legal regulations regarding the amount of emission of carbon dioxide, the amount of emission of VOC gas, restrictions on the use of electric power, and so forth, without decreasing production efficiency.

### Embodiment 2

In Embodiment 1, an example has been described in which a proposal for correction of a production plan is generated with the round-robin scheme.

In the present embodiment, an example is described in which the number of generation of proposals for correction of the production plan is suppressed.

In the present embodiment, differences from Embodiment 1 are mainly described.

Note that matters not described below are similar to those of Embodiment 1.

### ***Description of Structure***

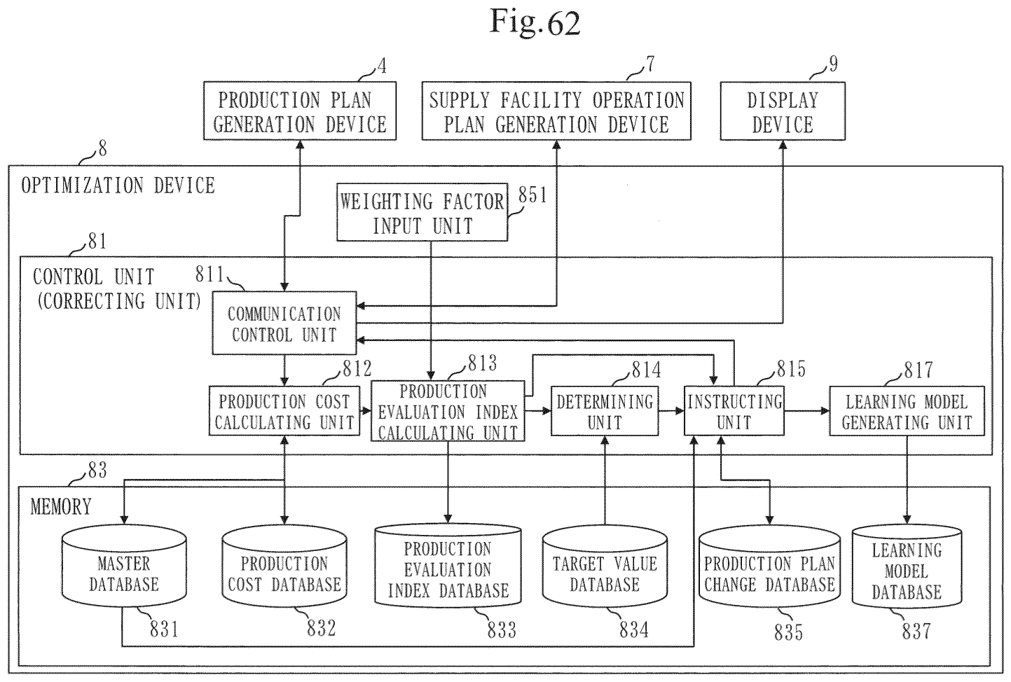

FIG. 62 depicts an example of functional structure of the optimization device 8 according to the present embodiment.

In FIG. 62, compared with FIG. 7, a learning model generating unit 817 and a learning model database 837 are added.

The components other than the learning model generating unit 817 and the learning model database 837 are identical to those depicted in FIG. 7.

As with the instructing unit 815 and so forth, the learning model generating unit 817 is included in the optimization program 821.

The learning model generating unit 817 learns previously-corrected production plans and generates a learning model on which the learning results are reflected.

The learning model generating unit 817 causes the generated learning model to be stored in the learning model database 837.

In the present embodiment, production plan correction log information is stored in the production plan change database 835 for the previously-corrected production plans. The production plan correction log information is configured of pre-correction production plan information, post-correction production plan information, pre-correction order data, and post-correction order data.

The pre-correction production plan information is production plan information in which a production plan before correction is made (pre-correction production plan) is indicated.

The post-correction production plan information is production plan information in which a production plan after correction is made by following the correction proposal selected by the instructing unit 815 (post-correction production plan) is indicated.

The pre-correction order data is order data used for generation of the pre-correction production plan.

The post-correction order data is order data used for generation of the post-correction production plan.

The learning model generating unit 817 acquires the production plan correction log information from the production plan change database 835. By using the acquired production plan correction log information, the learning model generating unit 817 performs machine learning such as reinforcement learning to generate a learning model. The learning model generating unit 817 learns a relation between a difference between the pre-correction order data and the post-correction order data and a difference between the pre-correction production plan information and the post-correction production plan information. That is, the learning model generating unit 817 learns how the production plan changes if which parameter of the order data is changed in which way.

The learning model is a model serving as a guide for correction of the production plan.

Note that the learning model generating unit 817 may regularly update the learning model. Also, the learning model database 837 is regularly copied to the storage 82.

In the present embodiment, before a learning model is generated by the learning model generating unit 817, as with Embodiment 1, the instructing unit 815 causes the production plan generation device 4 to generate a proposal for correction of the production plan with the round-robin scheme.

Every time a correction proposal to be adopted for the production plan is selected, the instructing unit 815 causes the pre-correction production plan information, the post-correction production plan information, the pre-correction order data, and the post-correction order data to be stored in the production plan change database 835 as production plan correction log information.

After the learning model is generated by the learning model generating unit 817, by using the learning model, the instructing unit 815 generates a new production plan as a proposal for correction of the production plan. Then, the instructing unit 815 transmits new production plan information in which the new production plan is indicated to the production plan generation device 4 via the communication control unit 811.

In the production plan generation device 4, based on the new production plan, a new production facility operation plan is generated.

### ***Description of Operation***

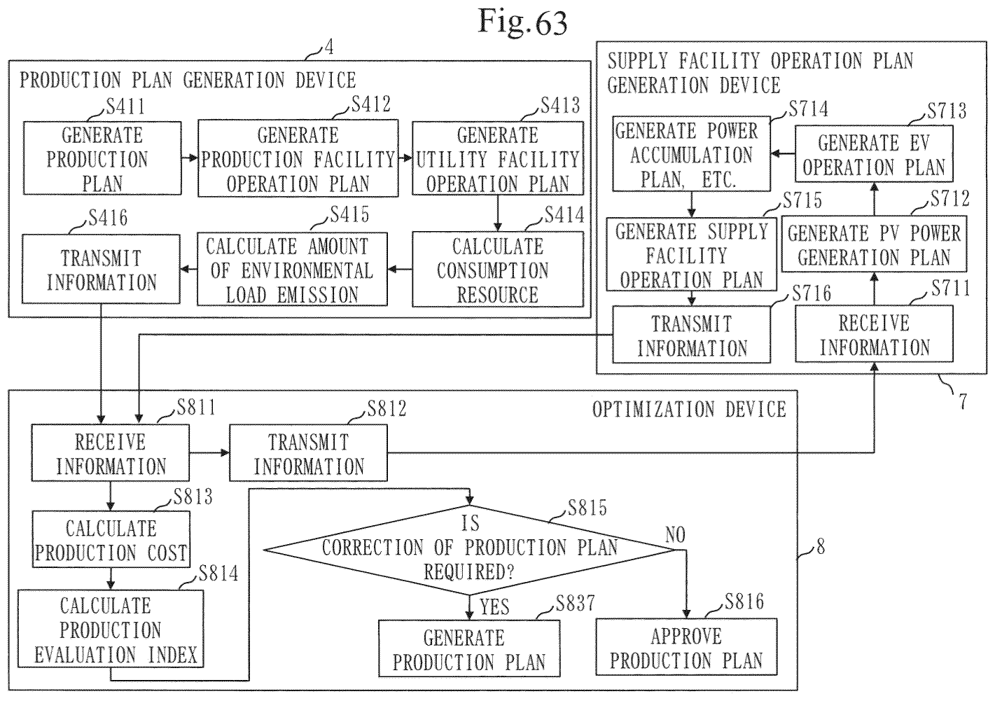

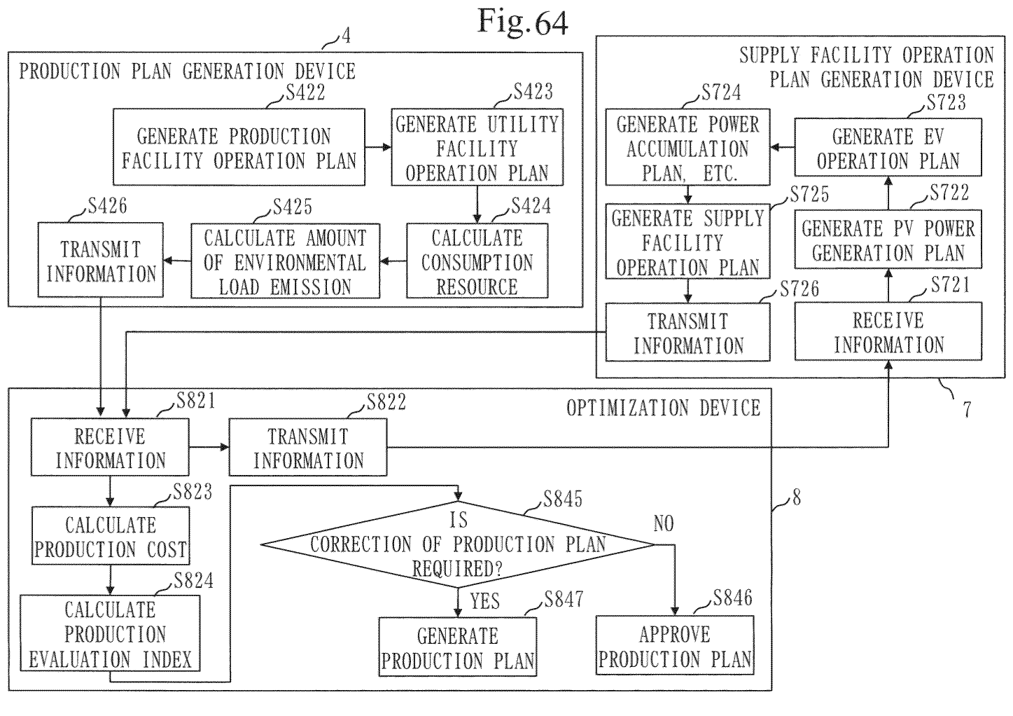

FIG. 63 and FIG. 64 each depict an example of operation of the production plan generation device 4, the supply facility operation plan generation device 7, and the optimization device 8 according to the present embodiment.

FIG. 63 corresponds to FIG. 44. FIG. 64 corresponds to FIG. 45.

In FIG. 63, steps S411 to S416 as the operation of the production plan generation device 4 are identical to those of FIG. 44. Also, steps S711 to S716 as the operation of the supply facility operation plan generation device 7 are also identical to those of FIG. 44.

Also, in the operation of the optimization device 8, steps S811 to S816 are also identical to those of FIG. 44.

In the present embodiment, at step S837, the instructing unit 815 generates a new production plan by using the learning model. Then, the communication control unit 811 transmits new production plan information in which the new production plan is indicated to the production plan generation device 4.

In FIG. 64, unlike FIG. 45, step S420 and step S421 are omitted. That is, with the production plan generating unit 411 producing neither a correction proposal nor a new production plan, at step S422, the production facility operation plan generating unit 412 generates a new production facility operation plan based on the new production plan information transmitted from the optimization device 8.

Since the operation at step S423 onward in the production plan generation device 4 is identical to that depicted in FIG. 45, description is omitted.

Also, since the operation in the supply facility operation plan generation device 7 is also identical to that depicted in FIG. 45, description is omitted.

In the optimization device 8, since steps S821 to S824 are identical to those depicted in FIG. 45, description is omitted.

At step S845, the instructing unit 815 determines whether generation of a new production plan is required, that is, whether the production evaluation index matches the target value. When generation of a new production plan is not required, that is, when the production evaluation index matches the target value, at step S846, the instructing unit 815 approves a new production plan. Also, the instructing unit 815 causes production plan correction log information to be stored in the production plan change database 835.

On the other hand, when the production evaluation index does not match the target value and correction of the production plan is required, at step S847, the instructing unit 815 further generates a new generation plan by using the learning model. Then, the communication control unit 811 transmits new production plan information in which the new production plan is indicated to the production plan generation device 4.

Then, the processes at step S422 onward are repeated.

Note that in the above, before a learning model is generated, the instructing unit 815 causes the production plan generation device 4 to generate a proposal for correction of the production plan with the round-robin scheme. In place of this, by using a solution search method such as a genetic algorithm or a Lagrangian relaxation scheme, the instructing unit 815 may generate a new production plan. With this, the instructing unit 815 can generate production plan information with a minimum production evaluation index in a finite duration.

### ***Description of Effects of Embodiment***

As described above, in the present embodiment, new production plan information is generated by using the learning model acquired by machine learning or reinforcement learning. Thus, according to the present embodiment, it is possible to generate a production plan with a smaller production evaluation index with a small time and process amount.

While Embodiment 1 and Embodiment 2 have been described above, these two embodiments may be combined for implementation.

Alternatively, of these two embodiments, one may be partially implemented.

Alternatively, these two embodiments may be partially combined for implementation.

Also, the structures and procedures described in these two embodiments may be changed as required.

### ***Supplemental Description of Hardware Structure***

Lastly, supplemental description is made on the hardware structure of the production plan generation device 4, the supply facility operation plan generation device 7, and the optimization device 8.

In the production plan generation device 4, when the control unit 41 is a processor, an OS (Operating System) is also stored in the storage 42.

And, at least part of the OS is executed by the control unit 41 as a processor.

While executing at least part of the OS, the control unit 41 executes the production plan generation program 421.

With the control unit 41 executing the OS, task management, memory management, file management, communication control, and so forth are performed.

Also, the production plan generation program 421 may be stored in a portable recording medium, such as a magnetic disc, flexible disc, optical disc, compact disc, Blu-ray (registered trademark) disc, or DVD. And, the portable recording medium having the production plan generation program 421 stored therein may be distributed.

Also, the “unit” of the production plan generating unit 411, the production facility operation plan generating unit 412, the communication control unit 413, the utility facility operation plan generating unit 414, and the resource load calculating unit 415 may be read as “circuit”, “step”, “procedure”, or “process”.

Similarly, in the supply facility operation plan generation device 7, when the control unit 71 is a processor, an OS is also stored in the storage 72.

And, at least part of the OS is executed by the control unit 71 as a processor.

While executing at least part of the OS, the control unit 71 executes the supply facility operation plan generation program 721.

With the control unit 71 executing the OS, task management, memory management, file management, communication control, and so forth are performed.

Also, the supply facility operation plan generation program 721 may be stored in a portable recording medium, such as a magnetic disc, flexible disc, optical disc, compact disc, Blu-ray (registered trademark) disc, or DVD. And, the portable recording medium having the supply facility operation plan generation program 721 stored therein may be distributed.

Also, the “unit” of the power generation plan generating unit 711, the EV operation plan generating unit 712, the supply facility operation plan generating unit 713, and the communication control unit 714 may be read as “circuit”, “step”, “procedure”, or “process”.

Similarly, in the optimization device 8, when the control unit 81 is a processor, an OS is also stored in the storage 82.

And, at least part of the OS is executed by the control unit 81 as a processor.

While executing at least part of the OS, the control unit 81 executes the optimization program 821.

With the control unit 81 executing the OS, task management, memory management, file management, communication control, and so forth are performed.

Also, the optimization program 821 may be stored in a portable recording medium, such as a magnetic disc, flexible disc, optical disc, compact disc, Blu-ray (registered trademark) disc, or DVD. And, the portable recording medium having the optimization program 821 stored therein may be distributed.

Also, the “unit” of the communication control unit 811, the production cost calculating unit 812, the production evaluation index calculating unit 813, determining unit 814, the instructing unit 815, and the learning model generating unit 817 may be read as “circuit”, “step”, “procedure”, or “process”.

### REFERENCE SIGNS LIST

1: production facility; 2: production control device; 3: utility facility; 4: production plan generation device; 5: renewable energy supply facility; 6: supply control device; 7: supply facility operation plan generation device; 8: optimization device; 9: display device; 10: network; 41: control unit; 42: storage; 43: memory; 44: communication unit; 45: input unit; 71: control unit; 72: storage; 73: memory; 74: communication unit; 75: input unit; 81: control unit; 82: storage; 83: memory; 84: communication unit; 85: input unit; 100: production plan optimization system; 411: production plan generating unit; 412: production facility operation plan generating unit; 413: communication control unit; 414: utility facility operation plan generating unit; 415: resource load calculating unit; 421: production plan generation program; 431: master database; 432: production facility operation plan database; 433: utility facility operation plan database; 434: resource load database; 451: information input unit; 500: information processing system; 711: power generation plan generating unit; 712: EV operation plan generating unit; 713: supply facility operation plan generating unit; 714: communication control unit; 721: supply facility operation plan generation program; 730: master database; 731: power generation plan database; 732: EV operation plan database; 733: supply facility operation plan database; 751: weather forecast information input unit; 811: communication control unit; 812: production cost calculating unit; 813: production evaluation index calculating unit; 814: determining unit; 815: instructing unit; 817: learning model generating unit; 821: optimization program; 831: master database; 832: production cost database; 833: production evaluation index database; 834: target value database; 835: production plan change database; 837: learning model database

1. An information processing system (500) comprising:
processing circuitry:
to determine whether correction is required for a production plan of a production facility that performs production by receiving electric power supply from a power generation facility in which an amount of power generation fluctuates in accordance with a state transition of an external environment; and
to generate a plurality of proposals for correction of the production plan when it is determined that correction of the production plan is required; to generate, for each proposal for correction, a power accumulation plan, an electrical discharge plan, and an acquisition plan based on the generated proposal for correction of the production plan and a power generation plan of the power generation facility based on a prediction of the state transition of the external environment, the power accumulation plan being a plan about power accumulation of an excess amount of electric power when the amount of power generation at the power generation facility exceeds a demanded amount of electric power, which is an amount of electric power for production at the production facility, the electrical discharge plan being a plan about electrical discharge of the accumulated excess amount of electric power to the production facility, and the acquisition plan being a plan about acquisition of a shortfall of the amount of electric power from a power supply facility other than the power generation facility when a total amount of electric power of the amount of power generation of the power generation facility and the accumulated amount of electric power is insufficient for the demanded amount of electric power; to select any proposal for correction from among the plurality of proposals for correction of the production plan based on the power accumulation plans, the electrical discharge plans, and the acquisition plans of the plurality of proposals for correction of the production plan, and to correct the production plan by following the selected proposal for correction.

2. The information processing system according to claim 1, wherein
the processing circuitry
estimates, for each proposal for correction, based on the power accumulation plan, the electrical discharge plan, and the acquisition plan, production cost required for production at the production facility in which electric power acquisition cost required for acquisition of the shortfall of the amount of electric power from a power supply facility other than the power generation facility is included, and
selects any proposal for correction from among the plurality of proposals for correction of the production plan based on the estimated production cost.

3. The information processing system according to claim 2, wherein
the processing circuitry selects a proposal for correction in which the production cost is minimum or an index value of the production cost is minimum from among the plurality of proposals for correction of the production plan.

4. The information processing system according to claim 1, wherein
the production at the production facility is administrated for each unit time by following the production plan, and
the processing circuitry generates each of the power accumulation plan, the electrical discharge plan, and the acquisition plan for each said unit time.

5. The information processing system according to claim 1, wherein
the processing circuitry
generates the power accumulation plan by reflecting power accumulation efficiency at power accumulation, and
generates the electrical discharge plan by reflecting discharge efficiency at discharge.

6. The information processing system according to claim 1, wherein
the processing circuitry generates the power accumulation plan and the acquisition plan by using, as the demanded amount of electric power, a total amount of electric power of an amount of electric power required at the production facility and an amount of electric power required at a utility facility that supplies a resource for use in the production at the production facility to the production facility.

7. The information processing system according to claim 2, wherein
the processing circuitry estimates, for each proposal for correction, production cost including the electric power acquisition cost, a labor cost, and an environmental load reduction cost.

8. The information processing system according to claim 1, wherein
the processing circuitry generates the power accumulation plan, the electrical discharge plan, and the acquisition plan based on the proposal for correction of the production plan, the power generation plan of the power generation facility, and an operation plan of an EV (Electric Vehicle) that operates between a utility facility and the production facility, the utility facility supplying a resource for use in the production at the production facility to the production facility.

9. The information processing system according to claim 1, wherein
the processing circuitry generates the proposal for correction of the production plan by using a learning model acquired by learning the production plan previously corrected.

10. The information processing system according to claim 1, wherein
the power generation facility is a power generation facility including a power generation device by renewable energy.

11. An information processing method comprising:
determining whether correction is required for a production plan of a production facility that performs production by receiving electric power supply from a power generation facility in which an amount of power generation fluctuates in accordance with a state transition of an external environment; and
generating a plurality of proposals for correction of the production plan when it is determined that correction of the production plan is required; generating, for each proposal for correction, a power accumulation plan, an electrical discharge plan, and an acquisition plan based on the generated proposal for correction of the production plan and a power generation plan of the power generation facility based on a prediction of the state transition of the external environment, the power accumulation plan being a plan about power accumulation of an excess amount of electric power when the amount of power generation at the power generation facility exceeds a demanded amount of electric power, which is an amount of electric power for production at the production facility, the electrical discharge plan being a plan about electrical discharge of the accumulated excess amount of electric power to the production facility, and the acquisition plan being a plan about acquisition of a shortfall of the amount of electric power from a power supply facility other than the power generation facility when a total amount of electric power of the amount of power generation of the power generation facility and the accumulated amount of electric power is insufficient for the demanded amount of electric power; selecting any proposal for correction from among the plurality of proposals for correction of the production plan based on the power accumulation plans, the electrical discharge plans, and the acquisition plans of the plurality of proposals for correction of the production plan, and correcting the production plan by following the selected proposal for correction.

12. A non-transitory computer readable medium storing an information processing program that causes a computer to execute:
a determining process of determining whether correction is required for a production plan of a production facility that performs production by receiving electric power supply from a power generation facility in which an amount of power generation fluctuates in accordance with a state transition of an external environment; and
a correcting process of generating a plurality of proposals for correction of the production plan when it is determined by the determining process that correction of the production plan is required; generating, for each proposal for correction, a power accumulation plan, an electrical discharge plan, and an acquisition plan based on the generated proposal for correction of the production plan and a power generation plan of the power generation facility based on a prediction of the state transition of the external environment, the power accumulation plan being a plan about power accumulation of an excess amount of electric power when the amount of power generation at the power generation facility exceeds a demanded amount of electric power, which is an amount of electric power for production at the production facility, the electrical discharge plan being a plan about electrical discharge of the accumulated excess amount of electric power to the production facility, and the acquisition plan being a plan about acquisition of a shortfall of the amount of electric power from a power supply facility other than the power generation facility when a total amount of electric power of the amount of power generation of the power generation facility and the accumulated amount of electric power is insufficient for the demanded amount of electric power; selecting any proposal for correction from among the plurality of proposals for correction of the production plan based on the power accumulation plans, the electrical discharge plans, and the acquisition plans of the plurality of proposals for correction of the production plan, and correcting the production plan by following the selected proposal for correction.
